(19) United States
(12) Patent Application Publication
(10) Pub. No.: US 2025/0109513 A1
(43) Pub. Date: Apr. 3, 2025

(54) ELECTROCHEMICAL COX REDUCTION AND HYDROGEN OXIDATION REACTOR

(71) Applicant: Twelve Benefit Corporation, Berkeley, CA (US)

(72) Inventors: Ziyang Huo, Moraga, CA (US); Yueshen Wu, Berkeley, CA (US); Zixu Tao, Richmond, CA (US); Etosha R. Cave, Berkeley, CA (US); Nicholas H. Flanders, San Francisico, CA (US); Joshua Alexander Wicks, Halifax (CA); David Frank, Oakland, CA (US)

(21) Appl. No.: 18/900,442

(22) Filed: Sep. 27, 2024

Related U.S. Application Data
(60) Provisional application No. 63/586,623, filed on Sep. 29, 2023.

(51) Int. Cl. C25B 3/26; C25B 1/044; C25B 1/23; C25B 3/03; C25B 3/07

(52) U.S. Cl. CPC C25B 3/26; C25B 1/23; C25B 3/03; C25B 3/07; C25B 1/044

(57) ABSTRACT

Provided herein are systems and methods for electrochemical COₓ reduction and hydrogen oxidation reactions to promote the reduction of carbon oxides (COₓ). Embodiments of the systems and methods may be used to produce carbon monoxide (CO) and water. In various embodiments, a reaction between carbon dioxide (CO₂) and hydrogen gas (H₂) occurs at the anode of a CO₂ reduction electrolyzer, promoting the production of reduction products (e.g., CO). In some embodiments, the methods may utilize a feed stream of H₂ gas from various sources. In some embodiments, a water electrolyzer upstream of the COₓ reduction electrolyzer is a source of H₂ gas. In some embodiments, the systems and methods include downstream integration processes and related apparatus. In some embodiments, the downstream integration processes include Fischer-Tropsch processes.

### RELATED APPLICATION(S)

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

The present disclosure generally relates to the field of electrochemical reactions, and more, particularly to devices, systems, and methods for electrochemically reducing carbon oxides into carbon-containing chemical compounds.

Greenhouse gas emissions such as CO₂ can have a potential impact on the climatic environment if left uncontrolled. The conversion of fossil fuels such as coal or natural gas into energy is a major source of greenhouse gas emissions. There is an urgent need for a system for more effective management of these carbon dioxide emissions. Improvements in carbon capture technology whereby a stream of low-quality and/or low-concentration gas is purified to obtain a stream of higher quality and/or higher concentration of gas are of great interest to manufacturing and energy industries where the gases are generated. Techniques which transform carbon dioxide into useful products are much sought-after.

The background description provided herein is for the purpose of generally presenting the context of the disclosure. Work of the presently named inventors, to the extent it is described in this background section, as well as aspects of the description that may not otherwise qualify as art at the time of filing, are neither expressly or impliedly admitted as prior art against the present disclosure.

### SUMMARY

Provided herein are systems and methods for electrochemical carbon oxide reduction and hydrogen oxidation reactions to promote the reduction of carbon oxides (COₓ).

One general aspect of the disclosure relates to a method of producing a carbon-containing product. The method comprises providing a carbon oxide (COₓ) electrolyzer, the COₓ electrolyzer comprising an anode, a cathode, and a membrane disposed between and conductively connecting the anode and the cathode; feeding water to a water electrolyzer to produce hydrogen (H₂); feeding at least a portion of the H₂ produced by the water electrolyzer to the anode of the COₓ electrolyzer to undergo hydrogen oxidation reaction at the anode; feeding a carbon oxide to the cathode of the COₓ electrolyzer to undergo a reduction reaction, thereby producing the carbon-containing product; and outletting the carbon-containing product from the COₓ electrolyzer.

Implementation may further include one or more of the following features. In some embodiments, at least a portion of the H₂ produced by the water electrolyzer is directed to a plurality of COₓ electrolyzers. In some embodiments, the hydrogen oxidation reaction produces hydrogen ions that migrate through the membrane to the cathode. In some embodiments, water is produced along with the carbon-containing product at the cathode of the CO₂ electrolyzer. In some embodiments, the carbon-containing product from the COₓ electrolyzer is part of a cathode output stream that contains no more than 10 wt % of H₂. In some embodiments, the carbon oxide comprises CO₂ and the COₓ electrolyzer is a CO₂ electrolyzer. In some embodiments, the carbon-containing product comprises one or more of carbon monoxide, a hydrocarbon, an alcohol, an aldehyde, a ketone, and/or a carboxylic acid. In some embodiments, the carbon-containing product comprises carbon monoxide. In some embodiments, the carbon-containing product comprises a hydrocarbon comprising methane, ethene, and/or ethane. In some embodiments, the carbon-containing product comprises an alcohol comprising methanol, ethanol, n-propanol, and/or ethylene glycol. In some embodiments, the carbon-containing product comprises an aldehyde comprising glycolaldehyde, acetaldehyde, glyoxal, and/or propionaldehyde. In some embodiments, the carbon-containing product comprises a carboxylic acid comprising formic acid and/or acetic acid. In some embodiments, a system for producing the carbon-containing product according to the method described above is disclosed herein.

One general aspect of the disclosure relates to a method for producing liquid hydrocarbons from carbon dioxide (CO₂). The method comprises providing a CO₂ electrolyzer, the CO₂ electrolyzer comprising an anode, a cathode, and a membrane disposed between and conductively connecting the anode and the cathode; feeding hydrogen (H₂) to the anode of the CO₂ electrolyzer to undergo hydrogen oxidation reaction at the anode; feeding CO₂ to the cathode of the CO₂ electrolyzer to undergo a reduction reaction, thereby producing carbon monoxide (CO) at the cathode; and reacting at least a portion of the CO produced by the CO₂ electrolyzer in one or more downstream systems to produce a chemical product.

Implementation may further include one or more of the following features. In some embodiments, the method comprises reacting at least a portion of the CO produced by the CO₂ electrolyzer and H₂ in a liquid hydrocarbon synthesis reactor, thereby producing a liquid hydrocarbon mixture. In some embodiments, at least a portion of the H₂ fed to the anode of the CO₂ electrolyzer is produced by one or more water electrolyzers. In some embodiments, at least a portion of the H₂ reacted in the liquid hydrocarbon synthesis reactor is produced by one or more water electrolyzers. In some embodiments, the method further comprises transporting at least a portion of the liquid hydrocarbon mixture from the liquid hydrocarbon synthesis reactor to a hydrocarbon cracking reactor. In some embodiments, the liquid hydrocarbon synthesis reactor is configured to perform a Fischer-Tropsch process. In some embodiments, the CO₂ fed to the cathode of the CO₂ electrolyzer is gaseous CO₂. In some embodiments, the gaseous CO₂ and/or the H₂ is humidified. In some embodiments, water is produced along with the CO at the cathode of the CO₂ electrolyzer. In some embodiments, unreacted CO₂ is separated from the CO and the unreacted CO₂ is recycled to the CO₂ electrolyzer. In some embodiments, the anode output stream outlet from the CO₂ electrolyzer is substantially free of liquid water. In some embodiments, the liquid hydrocarbon mixture comprises jet fuel. In some embodiments, the liquid hydrocarbon mixture comprises naphtha. In some embodiments, a system for producing the liquid hydrocarbon products according to the method described above is disclosed herein.

One general aspect of the disclosure relates to a method of producing carbon monoxide (CO) and water. The method involves providing a carbon dioxide (CO₂) electrolyzer where CO₂ electrolyzer contains an anode, a cathode, and a membrane disposed between and conductively connecting the anode and cathode; feeding hydrogen (H₂) to the anode of the CO₂ electrolyzer to undergo hydrogen oxidation reaction at the anode, producing hydrogen ions that migrate through the membrane to the cathode to react; feeding CO₂ to the cathode of the CO₂ electrolyzer to undergo a reduction reaction, producing CO and water (H₂O) at the cathode, and outletting the CO and H₂O from the CO₂ electrolyzer.

Implementations may include one or more of the following features. In some embodiments, the CO₂ electrolyzer is free of iridium and/or a catalyst of the CO₂ electrolyzer is substantially free of iridium. In some embodiments, the anode of the CO₂ electrolyzer comprises a noble metal and/or a transition metal. In some embodiments, the anode of the CO₂ electrolyzer comprises a carbon-supported platinum catalyst. In some embodiments, the carbon-supported platinum catalyst has a loading of less than 10 mg/cm². In some embodiments, the CO₂ electrolyzer comprises a membrane electrode assembly (MEA). In some embodiments, the MEA of the CO₂ electrolyzer comprises a cathode layer, an anion-exchange membrane (AEM), a proton-exchange membrane, and an anode layer. In some embodiments, the cathode of the CO₂ electrolyzer comprises a carbon-supported copper, silver, and/or gold catalyst and a polyarylene polymer. In some embodiments, the AEM of the CO₂ electrolyzer comprises a polyarylene polymer. In some embodiments, the AEM of the CO₂ electrolyzer comprises a polytetrafluroethylene (PTFE). In some embodiments, the CO₂ electrolyzer further comprises a cathode flow field plate having an inlet and an outlet, and a cathode gas diffusion layer disposed between, and in contact with, the cathode flow field plate and the cathode layer of the MEA. In some embodiments, the cathode gas diffusion layer comprises a plurality of gas diffusion layers. In some embodiments, the CO₂ electrolyzer further comprises an anode flow field plate having an inlet and an outlet, and an anode gas diffusion layer disposed between, and in contact with, the anode flow field plate and the anode layer of the MEA. In some embodiments, the cathode of the CO₂ electrolyzer is operated at a gas pressure between 15 and 400 psig. In some embodiments, a single pass conversion rate of the CO₂ electrolyzer is at least 20%. In some embodiments, the CO₂ electrolyzer is operated at a temperature of less than 100° C. In some embodiments, the water electrolyzer comprises an anode, a cathode, and an anion-exchange membrane (AEM) disposed between and conductively connecting the anode and cathode. In some embodiments, the anode and and/or cathode of the water electrolyzer comprise a metal selected from the group consisting of nickel, molybdenum, titanium, and iron. In some embodiments, the anode and/or cathode of the water electrolyzer is a nickel mesh. In some embodiments, AEM in the water electrolyzer comprises a polyarylene polymer. In some embodiments, the feed to the water electrolyzer further comprises an electrolyte, where the electrolyte is an aqueous solution comprising less than or equal to 1 M of potassium hydroxide. In some embodiments, the water electrolyzer is substantially free of iridium.

Another general aspect of the disclosure includes a system for generating carbon monoxide (CO) and water. The system includes one or more carbon dioxide (CO₂) electrolyzers. Each CO₂ electrolyzer may include an anode that oxidizes hydrogen (H₂), a cathode that reduces the CO₂, a membrane disposed between and conductively connecting the anode and the cathode. The system may further include at least one inlet for feeding H₂ to one or more anodes of the CO₂ electrolyzers, where the CO₂ electrolyzers undergo a hydrogen oxidation reaction at the anode, producing hydrogen ions that migrate through the membrane to the cathode to react, and undergo CO₂ reduction reaction producing CO and water at the cathode.

Another general aspect of the disclosure includes a system for producing a carbon-containing product. The system comprises one or more water electrolyzers configured to produce H₂ from water; and one or more carbon oxide (COₓ) electrolyzers fluidically coupled to the one or more water electrolyzers, at least one of the one or more COₓ electrolyzers comprising an anode, a cathode, and a membrane disposed between and conductively connecting the anode and the cathode, the at least one of the one or more COₓ electrolyzers being configured to (i) feed at least a portion of the H₂ produced by the one or more water electrolyzers to the anode to undergo a hydrogen oxidation reaction at the anode, and (ii) feed a carbon oxide to the cathode to undergo a COₓ reduction reaction producing the carbon-containing product.

Implementations may include one or more of the following features. In some embodiments, the system further comprises a controller configured to control electrochemical potential, flow rate, current density, voltage, and temperature of the one or more COₓ electrolyzers (e.g., CO₂ electrolyzers) and/or water electrolyzers. In some embodiments, the controller comprises machine-readable instructions for feeding hydrogen (H₂) to the anode of the COₓ electrolyzer to undergo the hydrogen oxidation reaction at the anode, thereby producing the hydrogen ions that migrate through the membrane to the cathode to react, and feeding the carbon oxide to the cathode of the COₓ electrolyzer to undergo the reduction reaction producing a carbon-containing product at the cathode.

Another general aspect of the disclosure includes a system for producing a carbon-containing product. The system comprises one or more carbon dioxide (CO₂) electrolyzers, at least one of the one or more CO₂ electrolyzers comprising an anode, a cathode, and a membrane disposed between and conductively connecting the anode and the cathode, the at least one of the CO₂ electrolyzers being configured to (i) feed H₂ to the anode to undergo a hydrogen oxidation reaction at the anode, and (ii) feed CO₂ to the cathode to undergo a CO₂ reduction reaction at the cathode to produce carbon monoxide (CO); and one or more downstream systems being configured to receive at least a portion of the CO produced by the at least one of the CO₂ electrolyzers and to produce a chemical product by reacting the CO.

Implementations may include one or more of the following features. In some embodiments, the one or more downstream systems comprises a liquid hydrocarbon synthesis reactor being configured to receive H₂ and at least a portion of the CO produced by the at least one of the CO₂ electrolyzers and to produce a liquid hydrocarbon mixture. In some embodiments, the system further comprises one or more water electrolyzers fluidically coupled to the one or more CO₂ electrolyzers. In some embodiments, the one or more CO₂ electrolyzers comprise at least one inlet for feeding at least a portion of the H₂ produced by the one or more water electrolyzers to one or more anodes of the CO₂ electrolyzers. In some embodiments, the liquid hydrocarbon synthesis reactor is configured to receive at least a portion of the H₂ produced by the one or more water electrolyzers. In some embodiments, the system comprises a gas separation device downstream the one or more CO₂ electrolyzers, the gas separation device configured to separate unreacted CO₂ from the CO in the cathode output stream of the CO₂ electrolyzer and to recycle at least a portion of the unreacted CO₂ to the cathode of the one or more CO₂ electrolyzer via a CO₂ recycle loop.

These and other aspects of the disclosure are described below with reference to the Drawings.

### BRIEF DESCRIPTION OF DRAWINGS

FIG. 1A is an illustrative example of a CO₂ reduction and hydrogen oxidation reactor for generating carbon monoxide (CO) and configured to receive H₂ produced by a water electrolyzer, according to some embodiments.

FIG. 1B is an illustrative example of a COₓ reduction and hydrogen oxidation reactor for generating one or more carbon-containing products (CCPs) and configured to receive hydrogen (H₂) produced by a water electrolyzer, according to some embodiments.

FIG. 2 shows a simplified block diagram illustration of an AEM water electrolyzer, according to some embodiments.

FIG. 3 is an illustrative example of a COₓ electrolyzer undergoing hydrogen oxidation reaction (HOR) at its anode, and associated layers (flow field, gas diffusion layer, membrane, etc.), according to some embodiments.

FIG. 4 is a schematic illustration of a membrane electrode assembly (MEA) for use in a COₓ reduction and hydrogen oxidation reactor, according to various embodiments.

FIG. 5A is a schematic illustration of a carbon dioxide (CO₂) electrolyzer configured to receive water and CO₂ (e.g., humidified or dry gaseous CO₂) as reactant at a cathode and expel CO as a product, according to some embodiments.

FIG. 5B is a schematic illustration of a COₓ reduction MEA having a cathode catalyst layer, an anode catalyst layer, and an anion-conducting PEM, according to some embodiments.

FIG. 5C is a schematic illustration of a CO reduction MEA having a cathode catalyst layer, an anode catalyst layer, and an anion-conducting PEM, according to some embodiments.

FIG. 6 depicts an example system for a carbon oxide electrolyzer (e.g., carbon dioxide electrolyzer), according to some embodiments.

FIG. 7A depicts an example integration system of a carbon oxide electrolyzer fluidically coupled to a water electrolyzer, according to some embodiments.

FIG. 7B depicts an example integration system of a carbon oxide electrolyzer fluidically coupled to a hydrogen source, according to some embodiments.

FIG. 8A depicts a Fischer-Tropsch system configured to produce liquid hydrocarbons in which a source of carbon is a carbon oxide feedstock such as one containing carbon dioxide and/or carbon monoxide, according to some embodiments.

FIG. 8B depicts a Fischer-Tropsch system configured to produce liquid hydrocarbons in which a source of carbon is a carbon oxide feedstock and tail gas from the system reformed to produce additional carbon monoxide and hydrogen, according to some embodiments.

FIG. 8C depicts a Fischer-Tropsch system configured to produce liquid hydrocarbons in which a source of carbon is a carbon oxide feedstock such as one containing carbon dioxide, according to some embodiments.

### DETAILED DESCRIPTION

Provided herein are systems and methods for electrochemical carbon oxide (COₓ) reduction and hydrogen oxidation reactions to promote the reduction of one or more carbon oxides (COₓ). Various embodiments of the systems and methods may be used to produce carbon-containing products (e.g., carbon monoxide (CO)) and one or more byproducts (e.g., water), where the carbon-containing product is a reduction product of the carbon oxide(s). In some cases, the electrochemical COₓ reduction and hydrogen oxidation reactions may be carried out using one or more COₓ reduction reactors (i.e., COₓ reduction electrolyzers). In various embodiments, within the one or more reactors, an electrochemical reaction between a cathode side feed of gaseous carbon oxide (COₓ) (e.g., carbon dioxide (CO₂)) and an anode side feed of hydrogen gas (H₂) may be carried out to promote the production of a carbon-containing product (e.g., CO) and one or more byproducts (e.g., water). The reactors may utilize a feed stream of hydrogen gas from various sources. For example, in some embodiments, the systems and methods may utilize a water electrolyzer upstream of a COₓ reduction electrolyzer to produce hydrogen gas from water. In some embodiments, the hydrogen gas (H₂) produced by the water electrolyzer is fed to a downstream COₓ reduction electrolyzer and thereupon subjected to a hydrogen oxidation reaction at the anode of the COₓ reduction electrolyzer. In some embodiments, a single water electrolyzer may provide H₂ to a plurality of COₓ reduction electrolyzers.

Converting carbon dioxide (CO₂) and H₂ to CO and water can be traditionally accomplished by reverse water gas phase shift (RWGS) via thermal catalytic conversion. However, such processes often require a relatively high temperature, a substantial amount of energy, and a precious metal catalyst to facilitate the thermal catalytic conversion of CO₂.

The systems and methods of electrochemical COₓ reduction and hydrogen oxidation reactions described herein can offer several advantages over thermal catalytic RWGS. For example, the electrochemical reactors (e.g., COₓ reduction electrolyzers) described herein may be operated at a relatively low to moderate temperature, under a relatively low anode potential, and/or with the use of little to no precious metal catalyst in the anode and/or cathode. In various embodiments, the COₓ reduction reactors described herein may have improved single-pass conversion rates and improved energy efficiency compared to RWGS reactors. For example, a single-pass conversion rate of the COₓ reduction reactors described herein may be over 20%, over 30%, over 40%, or over 50%, compared to a single-pass conversion rate of less than 5% for a typical RWGS reactor.

In some embodiments, the water electrolyzer associated with the COₓ reduction reactor is an anion-exchange membrane (AEM) electrolyzer. In other embodiments, the water electrolyzer associated with the COₓ reduction reactor may be a class of polymer-electrolyte membrane (PEM) or alkaline water electrolyzer.

In some embodiments, a single water electrolyzer may provide H₂ to a plurality of COₓ reduction electrolyzers, such as at least 2, at least 4, at least 6, at least 10, and/or up to 20, up to 25, or up to 40. In alternative embodiments, a plurality of water electrolyzers (e.g., at least 2, at least 4, at least 6, at least 10, and/or up to 20, up to 25, or up to 40) may provide H₂ to a single COₓ reduction electrolyzer.

In some implementations, a COₓ reduction electrolyzer described herein may be connected to a downstream process. In some embodiments, the products of the COₓ reduction electrolyzer may subsequently be used in other applications such as liquid hydrocarbon production via Fischer-Tropsch process, chemical synthesis process, and/or gas (e.g., syngas) fermentation processes (e.g., bioreactors). The details of the downstream application of the COₓ reduction reactor are provided herein.

### Carbon Oxide Reduction and Hydrogen Oxidation Reaction System

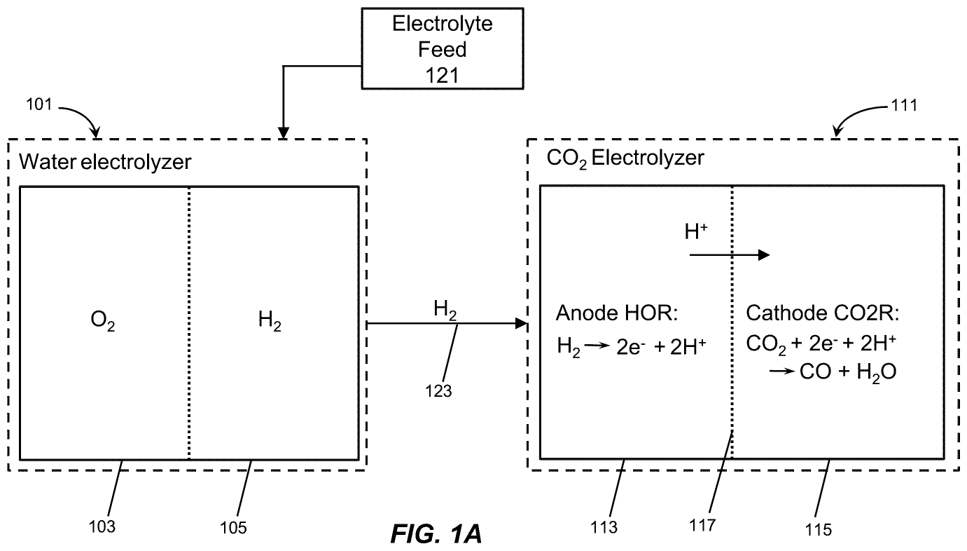

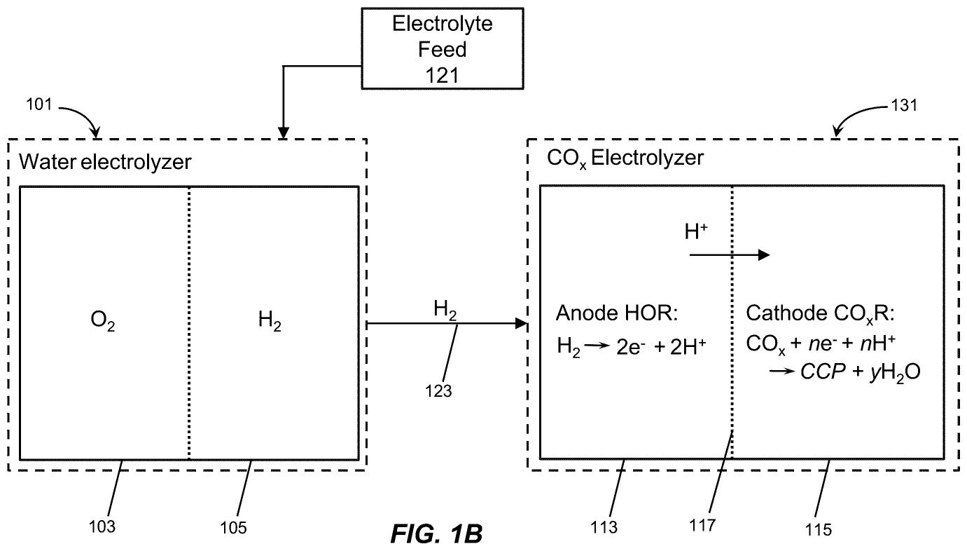

FIG. 1A depicts an illustrative example of a CO₂ reduction and hydrogen oxidation reaction system and related method and an apparatus for generating carbon monoxide (CO) and water. In the example of FIG. 1A, the system includes a water electrolyzer 101 having an anode 103 that produces oxygen (O₂) and a cathode 105 that produces H₂, and a carbon dioxide (CO₂) reduction electrolyzer 111 having an anode 113, a cathode 115, and a membrane 117 disposed between and conductively connecting the anode 113 and cathode 115. The water electrolyzer 101 may contain liquid electrolytes (not shown) and/or may comprise an inlet configured to receive the liquid electrolyte. For example, as shown, the electrolyte feed 121 may provide liquid electrolytes to the cathode 105 of the water electrolyzer 101. While FIG. 1A illustrates an embodiment in which liquid electrolyte or water is fed to the cathode 105, it should be understood that the disclosure is not so limited and that in certain embodiments, liquid electrolyte or water may be fed to the anode of a water electrolyzer (e.g., a water electrolyzer comprising a proton exchange membrane). In some embodiments, the CO₂ reduction electrolyzer does not contain a liquid electrolyte and/or does not have a liquid electrolyte inlet configured to receive a liquid electrolyte. The CO₂ reduction electrolyzer, according to some embodiments, comprises gaseous inlets, e.g., an anode side gaseous inlet configured to receive H₂ (e.g., dry or humidified H₂) and a cathode side gaseous inlet configured to receive gaseous CO₂ (e.g., dry or humidified CO₂). Alternatively, in some embodiments, water and/or anolyte in the form of a liquid or vapor may be introduced into the anode of the CO₂ reduction electrolyzer.

In some embodiments, the system illustrated in FIG. 1A may be employed to produce a carbon-containing product (e.g., CO) using a method described herein. For example, water may be fed to the water electrolyzer 101 to produce hydrogen gas (H₂). In some cases, at least a portion (at least 10%, at least 25%, at least 50%, at least 70%, at least 90%, or all) of the H₂ produced in the water electrolyzer 101 can be fed to the anode 113 of the CO₂ electrolyzer 111 to undergo a hydrogen oxidation reaction (HOR) at the anode 113 according to the half-reaction H₂→2H⁺+2e⁻. The HOR produces hydrogen ions (H⁺) that are transported through the membrane 117 to the cathode 115 of the CO₂ reduction electrolyzer 111 to react. In some embodiments, a gaseous feed of CO₂ (e.g., dry or humidified CO₂) is fed to the cathode 115 of the CO₂ electrolyzer 111 to undergo a reduction half-reaction according to CO₂+2e⁻+2H⁺→CO+H₂O, thereby producing CO and H₂O at the cathode 115. The CO and H₂O that are produced may be removed from the CO₂ electrolyzer 111 via a cathode outlet as a cathode outlet stream. In some embodiments, unreacted species (when present) may be removed from electrolyzer 111 via the one or more anode/cathode outlets. For example, unreacted CO₂ may be removed from the cathode outlet as a part of the cathode outlet stream and unreacted H₂ may be removed via the anode outlet as a part of the anode outlet stream. In some embodiments, the H₂O produced by the CO₂ electrolyzer 111 may be recycled to the water electrolyzer 101 as a part of the feed sent to the water electrolyzer 101.

While FIG. 1A illustrates an embodiment in which the system comprises a single water electrolyzer and a single CO₂ electrolyzer, it should be understood that the disclosure is not so limited that the system may comprise any appropriate number of water electrolyzers and/or any CO₂ electrolyzers described elsewhere herein. For example, the system described herein may include one or more water electrolyzers 101 producing hydrogen (H₂) from water, one or more carbon dioxide (CO₂) electrolyzers 111 fluidically coupled to the one or more water electrolyzers, at least one (or each) of the CO₂ electrolyzers including an anode 113 that oxidizes H₂, a cathode 115 that reduces the CO₂, and a membrane 117 disposed between (and in contact with) the anode 113 and cathode 115. The membrane 117 may conductively connect the anode 113 and cathode 115. The water electrolyzer(s) 101 may be coupled to one or more anodes 113 of the CO₂ electrolyzer(s) 111 by at least one CO₂ electrolyzer inlet 123. The CO₂ electrolyzer inlet 123, according to some embodiments, is configured to feed at least a portion of the H₂ produced by the water electrolyzer(s) 101 to the anode 113 of the CO₂ electrolyzer(s) 111 to undergo hydrogen oxidation reaction (HOR). As depicted in FIG. 1A, the anode 113 of the CO₂ electrolyzer(s) 111 may be configured to produce hydrogen ions from the H₂ via the hydrogen oxidation reaction. Therein, hydrogen ions migrate from the anode 113 to the cathode 115 through the membrane 117 to react with CO₂, producing a carbon-containing product (e.g., CO) and water at the cathode 115 via the CO₂ reduction reaction. The system may also contain a controller (not shown) configured to control various parameters including electrochemical potential, flow rate, current density, voltage, and/or temperature associated with the electrolyzer(s) (e.g., CO₂ reduction electrolyzer(s) and/or the water electrolyzer(s)) as well as the input and output streams (e.g., H₂ and/or CO₂ feed streams), according to some embodiments. The controller, in some cases, is electrically coupled to the CO₂ reduction electrolyzer(s) and/or the water electrolyzer(s).

While FIG. 1A illustrates an embodiment in which hydrogen gas produced by the water electrolyzer(s) is introduced into the CO₂ electrolyzer(s), it should be understood that the disclosure is not so limited and that in certain embodiments, a different source of hydrogen gas (other than from the water electrolyzer(s)) or a combination of hydrogen gas sources (e.g., water electrolyzer(s) and another hydrogen gas source) may be employed.

Furthermore, while FIG. 1A illustrates an embodiment in which the CO₂ undergoes reduction reaction to specifically form CO as the carbon-containing product (CCP), it should be understood that the disclosure is not so limited and that in certain embodiments, other types of CO₂ reduction reactions may be carried out to produce other carbon-containing product(s) (CCP(s)) by following the reduction half-reaction according to xCO₂+ne⁻+nH⁺→CCP+yH₂O. Specific examples include but are not limited to one or more of carbon monoxide, methanol, methane, oxalic acid, acetic acid, formic acid, acetaldehyde, ethanol, ethylene, ethane, propionaldehyde, and/or propanol. Additional carbon-containing products (CCP(s)) are described in more detail elsewhere herein.

It should also be noted that while FIG. 1A illustrates an embodiment in which a CO₂ electrolyzer is configured to receive and electrochemically reduce a CO₂ feed, the disclosure is not so limited and that in certain embodiments, other types of carbon oxide (COₓ) electrolyzers may be employed to receive and electrochemically reduce other COₓ feed (e.g., CO, CO/CO₂ mixtures) in a similar fashion as described above. For example, the system as shown in FIG. 1A may be generalized to any appropriate COₓ electrolyzer (such as the system shown in FIG. 1B) instead of being limited to a CO₂ electrolyzer. The system shown in FIG. 1B is identical to that shown in FIG. 1A, except that instead of the CO₂ electrolyzer 111, the system in FIG. 1B is generalized to a COₓ electrolyzer 131. The system described in FIG. 1B may comprise identical components (e.g., water electrolyzer 101, electrolyzer feed 123 (e.g., hydrogen gas feed, etc.), electrolyzer configurations, and methods of operation as described above with respect to FIG. 1A.

As shown in FIG. 1B, the COₓ electrolyzer may be configured to reduce any appropriate COₓ feed to a carbon-containing product (CCP), according to the reduction half-reaction of COₓ+ne⁻+nH⁺→CCP+yH₂O. As a non-limiting example, the COₓ electrolyzer described in FIG. 1B may be a carbon monoxide (CO) electrolyzer configured to reduce a CO feed into one or more carbon-containing products described elsewhere herein. Non-limiting examples include methane, ethanol, and/or ethylene.

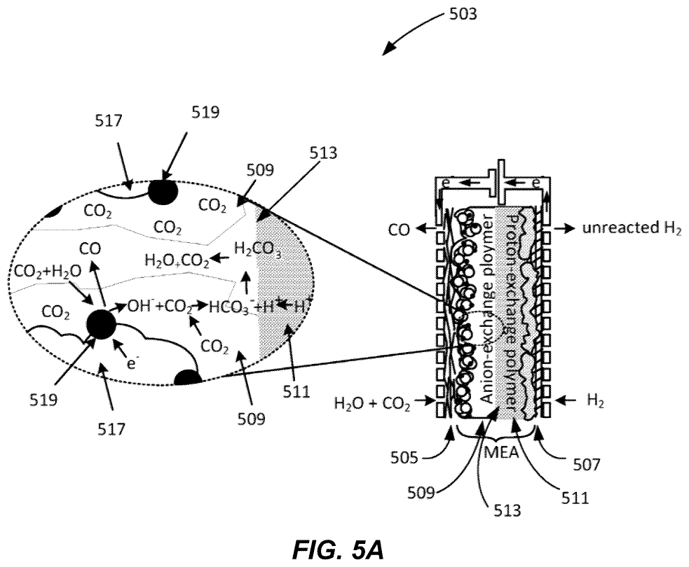

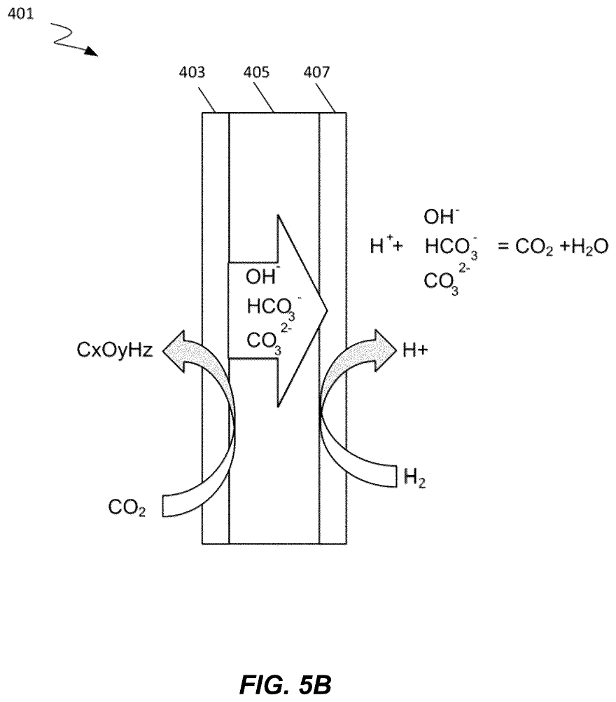

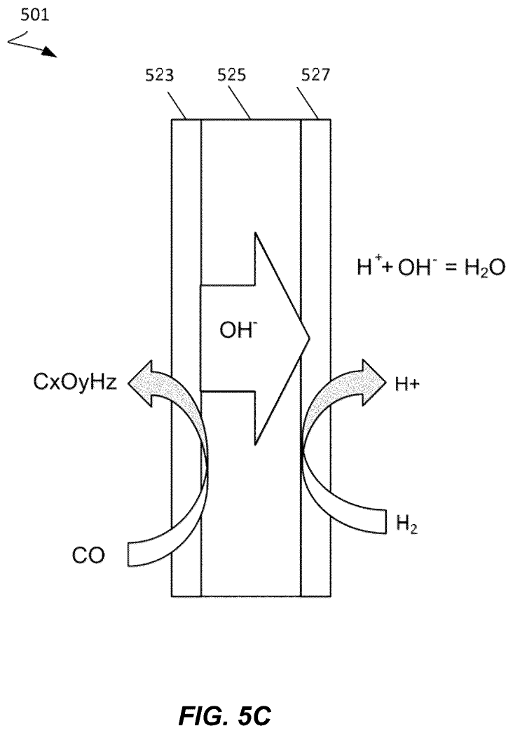

It should be understood that while FIGS. 1A-1B illustrate an embodiment in which the hydrogen ions migrate across the membrane to the cathode to react and form the carbon-containing product at the cathode, the disclosure is not so limited and that in certain embodiments, depending on the desired carbon-containing product, the specific reaction, and/or type of membrane, reaction between the hydrogen ions and the carbon oxide (or intermediates thereof) may instead occur at the anode to form the carbon-containing product at the anode. For example, in some embodiments, intermediate anions formed from carbon oxide at the cathode may migrate across the membrane to the anode to react with the hydrogen ions to form the carbon-containing product, as described in more detail in FIG. 5B.

Further details on the water electrolyzer(s) 101 and the COₓ electrolyzer(s) (e.g., CO₂ electrolyzer(s) 111) are provided below.

### Water Electrolyzer

While the systems and methods for the COₓ reduction reactor may utilize a feed stream of H₂ from other sources, in some embodiments, the COₓ reduction reactor may exploit a water electrolyzer configured to produce H₂ via water electrolysis, upstream of a COₓ electrolyzer. Examples according to various embodiments are described below, however, any other appropriate water electrolyzer may be used.

Water electrolysis refers to a chemical reaction in which a water molecule dissociates into hydrogen and oxygen. A water electrolyzer may include a cathode, an anode, and an electrolyte. The cathode of the water electrolyzer promotes the reduction of water (H₂O) and may produce hydrogen (H₂) and hydroxide (OH⁻) ions according to the half-reaction: 4H₂O+4e⁻→2H₂+4OH⁻. The anode of the water electrolyzer promotes the oxidation of hydroxide ions and may produce oxygen (O₂) and water according to the following half-reaction: 4OH⁻→O₂+2H₂O+4e⁻. Additional outputs of the water electrolyzer may include unreacted H₂O (e.g., present as aqueous potassium hydroxide (KOH) or other aqueous solution), unreacted OH⁻ ions, and/or unreacted hydrogen ions (H⁺). Depending on the pH environment, the water electrolyzer may produce O₂ and water according to other half-reactions. Alternatively, the water electrolyzer may comprise a proton exchange membrane and operate under acidic conditions, with its cathode operating according to the following half-reaction: 2H⁺+2e⁻→H₂, and with its anode operating according to the following half-reaction: H₂O→½O₂+2H⁺+2e⁻.

The electrolyte for water electrolysis may be a liquid electrolyte such as an aqueous electrolyte. In some embodiments, a liquid electrolyte may be used to raise the conductivity of the water. The liquid electrolyte may be an aqueous solution, such as potassium KOH, which provides ions to facilitate charge transportation. In various embodiments, the electrolyte may be aqueous solutions of hydroxides, carbonates, and/or phosphate. For example, the electrolyte may be aqueous solutions of sodium hydroxide (NaOH), rubidium hydroxide (RbOH), cesium hydroxide (CsOH), sodium carbonate (Na₂CO₃), potassium carbonate (K₂CO₃), sodium phosphate (Na₃PO₄), or potassium phosphate (K₃PO₄). In some embodiments, the concentration of aqueous electrolyte may be at least 0.001 M, at least 0.01 M, at least 0.1 M, at least 0.5 M, at least 1 M, at least 5 M, or more, and/or no more than 10 M, no more than 5 M, no more than 1 M, no more than 0.5 M, no more than 0.1 M, no more than 0.01 M, or less. Combinations of the above-referenced ranges are possible (e.g., between about 0.001M and about 10M, between about 0.1 M and about 5 M, or between about 0.001 M and about 1 M). For example, in one set of embodiments, greater than or equal to 0.001 M and less than or equal to 1M concentration of potassium hydroxide may be used as the liquid electrolyte.

In some embodiments, the aqueous electrolyte may serve as a water source in the water electrolyzer. During operation, electrolysis depletes water in the electrolyte to produce H₂ and O₂ and the concentration of the aqueous electrolyte may increase. To maintain the concentration of the electrolyte, water may be fed into the electrolyte solution. For example, when 1M aqueous KOH is used as the electrolyte, the concentration of the KOH may be raised as the electrolysis progresses. The water feed stream may replenish depleted water in the KOH solution, maintaining the proper concentration of the electrolyte. In some embodiments, the water source may be purified water fed to the aqueous electrolyte. In certain embodiments, a water feed stream may be coupled with an H₂O purifier. In some embodiments, the water electrolyzer may be an integrated H₂O purifier and water electrolyzer system.

Water electrolysis may be performed at basic or acidic pH conditions, depending on the choice of electrolyte. In some embodiments described herein, water electrolysis may be performed in an alkaline environment with a pH between about 9 and about 14. In some embodiments, water electrolysis may be performed in an environment with a pH below 9.

The water electrolyzer may be configured to produce H₂ at a rate between about 0.001 kg/hour and about 100 kg/hour, in some embodiments. In some embodiments, multiple water electrolyzers may be utilized to produce the desired H₂ output.

The water electrolyzer(s) of the disclosure may be directly connected (e.g., via the cathode flow field and/or gas diffusion layer) to a downstream system comprising, e.g., a reactor configured to chemically react with the output(s) of the water electrolyzer.

In certain embodiments, the water electrolyzer may be directly connected (e.g., fluidically connected) to a downstream carbon oxide electrolyzer. For example, output H₂ from the water electrolyzer may be fed into the anode of the carbon oxide electrolyzer, and then oxidized to produce H⁺ ions according to H₂→2H⁺+2e⁻. In some embodiments, the output H₂ from the water electrolyzer is humidified H₂ that can be directly fed into the anode of the carbon oxide electrolyzer without being subjected to drying. In some embodiments, a drier is not present between the water electrolyzer and the carbon oxide electrolyzer. In various embodiments, the H⁺ ions produced in the anode of the carbon oxide electrolyzer may be transported to the cathode to reduce carbon oxide and generate carbon monoxide and water.

In various embodiments, the water electrolyzer may be connected to a plurality of downstream carbon oxide electrolyzers, supplying output H₂ from the water electrolyzer to a plurality of carbon oxide electrolyzer anodes.

In some embodiments, the downstream system may include a purification system; a gas compression system; or both a purification system and a gas compression system, in either order; which may then optionally connect to an input of a downstream reactor and/or to one or more storage devices. In certain embodiments, a purification system may be a drier and/or a dehumidifier to remove excess water. The drier and/or dehumidifier may have a temperature control configured to maintain an operator-provided value. In some instances, the drier and/or dehumidifier may be configured to output a water electrolysis product with high purity, for example, about 99.99% for downstream integration of the products. In some embodiments, the drier and/or dehumidifier may output products with a purity of less than 99.99%. In various embodiments, the drier may be a commercially available unit.

Multiple purification systems and/or gas compression systems may be employed. In various embodiments, oxygen and/or hydrogen produced by the water electrolyzer is provided to a storage vessel for the oxygen and/or a storage vessel for the hydrogen.

The water electrolyzer and the integrated purifier described herein may be configured, designed, and/or controlled in a manner that allows the electrolyzer to produce one or more water electrolysis products in a quantity, concentration, and/or ratio suitable for any of various downstream processes such as for COₓ reduction.

Different water electrolyzers (e.g., including different layer stacks, catalysts and/or catalyst layers, polymer electrolyte membranes, flow fields, gas diffusion layers, cell compression configurations, and/or any other suitable aspects, etc.) can be used in the systems and method described herein to influence the type, amount, ratio, and rate of electrolysis product formation.

In some embodiments, the water electrolyzer is an anion-exchange membrane and/or cation-exchange membrane water electrolyzer, as further described below.

### Membrane Water Electrolyzers

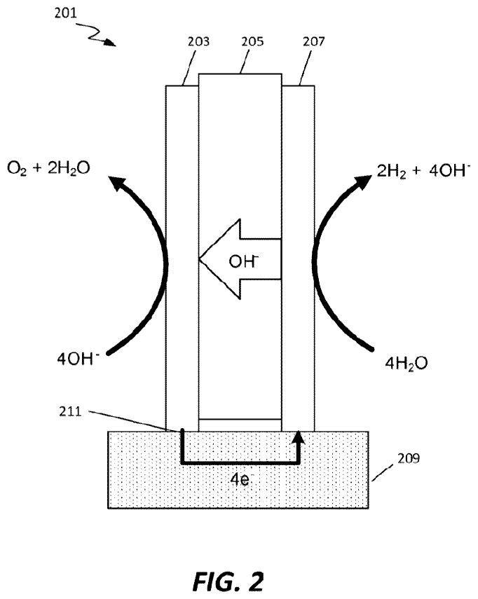

Electrolysis of water may be achieved using an anion-exchange membrane (AEM) and/or cation-exchange membrane electrolyzer. FIG. 2 is a simplified block diagram illustrating an AEM water electrolyzer 201 in accordance with certain embodiments. In the example of FIG. 2, the AEM water electrolyzer 201 includes an anode layer 203, a cathode layer 207, an AEM 205 disposed between and in contact with the anode layer 203 and cathode layer 207, a DC generator 209, an external electrical circuit 211, and an electrolyte within the AEM 205.

The AEM water electrolyzer 201 may optionally contain one or more other layers. The layers may be solids and/or gels. In certain instances, the layer may be porous and/or rough. Any one or more of the layers in the AEM 205 may include anion-conducting polymers.

In various embodiments, one or both of the electrodes of the AEM water electrolyzer 201 reactors may have a layered structure, including, for example, a flow field plate and gas diffusion layer. For example, a cathode layer may include a cathode flow field plate and a cathode gas diffusion layer. Similarly, an anode layer may include an anode flow field plate and an anode gas diffusion layer. In various embodiments, one or both of the electrodes of the AEM water electrolyzer 201 reactors may be metal electrodes, for example, it may be a porous metal.

In use, AEM water electrolyzer 201 decomposes water into O₂ and H₂ using electricity supplied by the DC generator 211. The cathode layer 207 of AEM water electrolyzer 201 promotes the electrochemical reduction of water by combining water and electrons and may produce H₂ and OH ions according to the half-reaction: 4H₂O+4e⁻→2H₂+4OH⁻. The OH⁻ ions produced in the cathode layer 207 migrate to the anode layer 203 through the AEM 205. In use, the anode layer 203 of AEM water electrolyzer 201 promotes the electrochemical oxidation of OH-ion and may produce water and O₂ according to half-reaction: 4OH⁻→O₂+2H₂O+4e⁻. The cathode layer 207 and anode layer 203 may each contain a catalyst to facilitate their respective reactions.

During the operation of AEM water electrolyzer 201, ions move through one or more polymer layers of AEM 205, while electrons flow from the anode layer 203 to cathode layer 207 through an external electrical circuit 211. In some embodiments, liquids and/or gas move through or permeate one or more layers of AEM 205. This process may be facilitated by pores in one or more layers of the AEM.

The composition and arrangement of layers in the AEM may be configured to promote a high yield of water electrolysis products. To this end, the AEM may facilitate any one or more of the following conditions: (a) minimal parasitic reaction (e.g., electrode corrosion and dioxygen reduction) at the cathode; (b) physical integrity of the AEM during the reaction (e.g., the AEM layers remain affixed to one another); (c) prevention of water electrolysis product crossover, with a notable exception of OH-ions; (d) a suitable environment at the cathode for the reduction reaction; (e) a suitable environment at the anode for the oxidation reaction; (f) a pathway for desired ions to travel between the cathode and anode while blocking undesired ions; and (h) low voltage operating conditions.

In addition to the considerations described above, other considerations for a water electrolyzer and its components include lifetime and size. For many applications, AEM and cation-exchange membrane electrolyzers have a lifetime on the order of several thousand hours, and about 50,000 hours, respectively. Desirable water electrolyzers may have lifetimes on the order of about 50,000 hours or longer (approximately five years of continuous operation), which is significantly longer than the expected lifespan of a fuel cell for automotive applications, which is often on the order of 5,000 hours. For various applications, water electrolyzers employ electrodes having a relatively large surface area in comparison to those used for fuel cells for automotive applications, for example, AEMs for water electrolysis may employ electrodes having a surface area (without considering pores and other nonplanar features) of at least about 500 cm².

As described above, a cell of an AEM water electrolyzer includes a cathode, an anode, and a polymer membrane between the anode and the cathode, as well as a liquid electrolyte. The water electrolyzer may contain multiple cells arranged in a stack.

The liquid electrolyte may be an aqueous solution of potassium hydroxide or sodium hydroxide. For example, a 1M concentration of aqueous potassium hydroxide may be used as the aqueous electrolyte. In other embodiments, the concentration of potassium hydroxide electrolyte may be between about 0.001M and about 10M. In various embodiments, the electrolyte solution for the cathode and anode layer may be identical such as 1M aqueous potassium hydroxide.

The AEM of the water electrolyzer is disposed between the anode and the cathode. The AEM provides ionic communication between the anode layer and the cathode layer while preventing electronic communication that would produce a short circuit.

### Cathode

The cathode includes a reduction catalyst and, optionally, an ion-conducting polymer. The cathode may also include an electron conductor and/or an additional ion conductor. The cathode catalyst is selected to facilitate the reduction of water, producing H₂ and OH ions.

The reduction catalyst may comprise a suitable precious metal such as platinum, palladium, ruthenium, and/or iridium. Alternatively or additionally, the water reduction catalyst may comprise a transition metal such as nickel, titanium, iron, and/or molybdenum. The reduction catalyst may be in any suitable form, e.g., a mesh. For example, a nickel mesh may be about 0.00073″ nickel wire, characterized by having a thickness of about 0.002″ with an open area of about 90% can be used. In other instances, the catalyst may be a mesh comprising other suitable transition metals and/or precious metals having a different thickness and a different open area. In other embodiments, the cathode catalysts may be metal nanoparticles.

Catalysts may be characterized by various parameters, for example, size, size distribution, uniformity of coverage on the support particles, shape, loading (characterized by the weight of the catalyst relative to the combined weights of the catalyst and support particles (e.g., carbon support), or, by the mass of particles per geometric area of catalyst layer), surface area (catalyst surface area per volume of catalyst layer), and purity, etc. The characteristics of the catalysts may affect the performance of water electrolysis.

In some embodiments, the catalyst particles comprise metals such as a noble metal (e.g. palladium, platinum, iridium) or a transition metal (e.g. nickel, molybdenum). In some embodiments, the catalyst particles comprise a single or mixed metal compound (e.g. iridium oxide, iron/nickel hydroxide). In some embodiments, the catalyst particles comprise an alloy (e.g. platinum/ruthenium, nickel/molybdenum). In some embodiments, the catalyst particles are a component of a catalyst layer of an MEA. In some embodiments, the catalyst particles are a component of a mixture that serves as a precursor to a catalyst layer. For example, the catalyst particles may be provided with an electronically conductive support material such as carbon particles.

The size of catalyst particles may be estimated by the diameter of a representative sphere of the particles. As used herein, a particle's diameter is a parameter that assumes that the particles are spherical, even when not all of them are in fact spherical. As an example, particle size can be determined by high-resolution imaging with, e.g., a transmission electron microscope (TEM). The resulting micrographs can be analyzed to determine particle size and distribution. Using the number of particles in a micrograph and the total area of all particles in the micrograph, an area per particle can be determined, and the diameter of a spherical particle can be back-calculated.

In various embodiments, catalysts may contain catalyst nanoparticles in combination with electronically conductive support particles such as carbon particles. The catalyst nanoparticles may be attached to the support particles. This combination may be characterized by a loading of catalyst particles. The loading may be a mass fraction of the catalyst in a combination that contains only the catalyst and the support material (e.g., carbon). It does not include other common components of a catalyst layer such as ionomers.

In certain embodiments, the catalysts have a loading of about 5% to about 80%. In some cases, such loadings are achieved with little or no metal particle agglomeration. The loading should be higher than a threshold value to ensure optimal performance is achieved. However, increasing the loading above a certain point may not be economically viable due to the increased cost.

In certain embodiments, catalyst particles may have a spherical or circular shape. For example, catalyst particles may approach the shape of a true sphere or circle. In certain embodiments, catalyst particles may have other shapes such as regular polyhedrons (e.g., cubes, octahedrons, dodecahedrons, etc.), ellipsoids, or wires. In certain embodiments, catalyst particles may be characterized by their sphericity or circularity, which is a measure of how spherical or circular an object is. The sphericity of a particle is defined as the ratio of the surface area of an equal-volume sphere to the actual surface area of the particle. In certain embodiments, at least about 50% of catalyst particles have a sphericity of at least 70%.

In certain embodiments, many or most catalyst particles in a catalyst are single crystal nanoparticles. Single crystal particles may not be polycrystalline. For example, they may not exhibit crystal twinning. In certain embodiments, many or most catalyst particles in a catalyst may be amorphous nanoparticles. Amorphous nanoparticles are characterized by the lack of sharp peaks in the powder X-ray diffraction diagram of the catalyst. For example, platinum nanoparticles supported on carbon may be single crystalline; iridium oxide nanoparticles may be amorphous. Under given conditions, crystalline catalyst particles may be more stable against dissolution and/or agglomeration, and amorphous catalyst particles may have better performance.

In certain embodiments, the catalyst nanoparticles may have little to no impurities. For example, platinum nanoparticles supported on carbon may contain 20 ppm or less gold. In some implementations, catalyst particles may be fabricated using an apparatus having few or no metal parts that contact the reactants that generate metal nanoparticles and/or the other components of a catalyst composition. The impurities may adversely affect the catalyst performance and should be avoided. However, in some embodiments, their impact may be determined negligible below a certain point, as to balance the cost of pursuing higher purity.

In certain embodiments, catalyst particles are provided on a substrate or support, which may be an electronically conductive substrate or support. In some cases, the conductive support is a particulate material. In some cases, catalyst particles are attached or bonded to the conductive support. In some cases, some or most of the conductive support particles have multiple catalyst particles attached. Conductive support particles having attached or bonded catalyst particles may be said to be decorated with the catalyst particles. In some embodiments, electronically conductive support particles are carbon particles. Such particles may be made from carbon having any of various bonding types, allotropes, and/or chemical characteristics. In general, a carbon support may be an amorphous carbon or a non-amorphous carbon. Examples of non-amorphous carbon include graphite or graphene-containing carbon, fullerenes, or any combination thereof. In certain embodiments, carbon black particles are used as a support. An example of a carbon black is Vulcan XC 72R (Cabot Corporation of Boston, MA). Any of these types of carbon particles may be decorated with platinum or other metal compound catalyst particles. The adoption of decorated catalyst particles may be beneficial for increasing the exposed catalyst surface area and mitigating catalyst particle agglomeration by physical separation.

Various parameters may be used to characterize carbon black or other carbon support particles. Examples of these parameters include the carbon particle size, specific surface area, fraction of carbon particles decorated with catalyst particles, bonding between carbon and catalyst particles, and porosity.

As with the catalyst particles, the size of support particles may be characterized in various ways. For example, the size of support particles may be characterized by the diameter of a presentative sphere of support particles. In some cases, the diameter of a support particle assumes that the particles are spherical, even if not all of them are in fact spherical. In certain embodiments, carbon support particles have a mean or other measure of central tendency (e.g., a medium value) diameter of about 10-200 nm. The size of support particles would impact the fabrication of the catalyst into the MEA. For example, if the support particle size is too large, the catalyst becomes incompatible with the spray deposition coating technology that is limited by the nozzle size.

In some embodiments, all or nearly all support particles in a catalyst composite have at least one catalyst particle attached. In some embodiments, the minimum fraction of a support particle having at least one attached catalyst particle is at least about 90%.

In some embodiments, bonding between the catalyst particles and support particles is facilitated during the fabrication of decorated particles by, e.g., using a ligand to change the surface energy of the catalyst particles to better adhere to the support particles. In some cases, decorated particles are prepared by mechanically affixing catalyst particles to carbon particles by mixing catalyst particles colloid with a suspension containing the support particles.

Support particles may be characterized by their specific surface area. Specific surface area is generated by evaluating the gas adsorption data in units of area per mass of sample (e.g., m²/g). For example, the Vulcan XC 72R (Cabot Corporation of Boston, MA) may have about 250 m²/g of specific surface area. Supported particles such as carbon particles may be characterized by their porosity. The specific area and porosity of support particles, and in turn a catalyst layer, can impact the ability of gaseous products to leave the catalyst layer. In certain embodiments, the porosity of the support particles is about 15% to 85%, In some embodiments, porosity is determined by a method such as mercury porosimetry or helium pycnometry.

The cathode may include a cathode flow plate having an inlet and an outlet that couples the cathode to an electrolyte reservoir, in some embodiments. The cathode flow plate may circulate the electrolyte solution between the cathode and the electrolyte reservoir via the inlet and outlet. The feed stream of electrolyte is provided to the cathode via the inlet while the output stream removes the water-depleted, product-containing electrolyte from the cathode.

The water electrolyzer may additionally include a cathode subsystem that interfaces with the cathode of the electrolyzer. The cathode subsystem may include an electrolyte reservoir connected to a water source, and various operational control features. In some embodiments, the water source may be a freshwater source such as a water reservoir. In other embodiments, the water source may be a feed stream of water product of an oxidation reaction at the anode. The water source may be configured to provide a feed stream of water to the electrolyte reservoir, then feed to the cathode of the electrolyzer via the inlet, which, during operation, may generate an output stream that includes the product(s) of a reduction reaction at the cathode. The product stream may also include unreacted water (present as the electrolyte).

The electrolyte feed stream may be coupled to a flow controller configured to control the volumetric or mass flow rate of the electrolyte from the electrolyte reservoir to the cathode. In some implementations, the flow controller may be a pump. The flow controller may be configured to maintain the flow rate at the cathode side of the cell within a defined range, e.g., between about 1 mL/min and about 100 L/min. In various implementations, the flow rate is about 60 mL/min.

During the operation, the output stream from the cathode flows via a conduit that connects to a backpressure controller configured to maintain pressure at the cathode side of the cell within a defined range (e.g., about 15 psig to about 1000 psig, about 30 psig to about 400 psig, or about 50 psig to about 90 psig, depending on the system configuration). The output stream may provide the reaction product to one or more components for separation and/or concentration.

In certain embodiments, the cathode subsystem may be configured to controllably recycle unreacted water from the output stream back to the cathode of the electrolyzer. In various implementations, the output stream is processed to remove reduction product(s) before recycling the electrolyte. In some embodiments, one or more components for separating the electrolyte from the product stream are disposed downstream from the cathode outlet. Examples of such components include a condenser configured to cool the product stream gas (H₂) and thereby provide a dry gas to a downstream process when needed, e.g., downstream COₓ electrolyzers.

In some implementations, the recycled electrolyte may mix with a freshwater source, e.g., a water reservoir, upstream of the cathode inlet to maintain the concentration of the electrolyte.

The water reservoir may be coupled to a water flow controller configured to control the volumetric or mass flow rate of the water to the electrolyte reservoir.

The cathode layer may also include a gas diffusion layer (GDL). When in use, the cathode GDL transports H₂ gas. In some embodiments, the GDL may be porous. In other embodiments, GDL may be with or without a microporous layer.

### Anode

The anode includes an oxidation catalyst and, optionally, an ion-conducting polymer. The anode layer may also include an electron conductor and/or an additional ion conductor. The anode catalyst is selected to facilitate the oxidation reaction of OH ions, producing O₂ and water.

The anode catalyst may comprise a suitable precious metal such as platinum, palladium, ruthenium, and/or iridium. Alternatively, the water reduction catalyst may be a transition metal such as nickel, titanium, iron, and/or molybdenum. In various embodiments, the oxidation catalyst may be nickel or nickel mesh. In certain embodiments, the nickel mesh may comprise about 0.00073″ nickel wire, characterized by having a thickness of about 0.002″ with an open area of about 90%. In other instances, the catalyst may be a mesh comprising other suitable transition metals and/or precious metals having a different thickness and a different open area. In some cases, the catalyst in the anode layer may be identical to the catalyst in the cathode layer.

In some embodiments, the water electrolyzer(s) and/or the associated catalyst (e.g., reduction and/or oxidation catalyst) is substantially free of iridium. For example, in some embodiments, the reduction and/or oxidation catalyst contains no more than 10 wt %, no more than 5 wt %, no more than 1 wt %, no more than 0.1 wt %, no more than 0.01 wt %, no more than 0.001 wt %, no more than 0.0001 wt %, and/or down to 0% of iridium. In some embodiments, the reduction and/or oxidation catalyst lacks iridium.

The water electrolyzer may comprise an anode flow plate having an inlet and an outlet that couples the anode to an electrolyte reservoir. The anode flow plate circulates the electrolyte solution between the anode and the electrolyte reservoir via the inlet and outlet. The feed stream of electrolyte is provided to the anode via the inlet while the output stream removes the water-rich, product-containing electrolyte from the anode.

The water electrolyzer may additionally include an anode subsystem that interfaces with the anode of the electrolyzer. The anode subsystem may include an electrolyte reservoir configured to provide a feed stream electrolyte to the anode of the electrolyzer via the inlet, which, during operation, may generate an output stream that includes the product(s), i.e., 02 and H₂O, of oxidation reaction at the anode. The product stream may also include unreacted hydroxide (present as the electrolyte).

The electrolyte feed stream may be coupled to a flow controller configured to control the volumetric or mass flow rate of the electrolyte from the electrolyte reservoir to the anode. In some implementations, the flow controller may be a pump. The flow controller may be configured to maintain the flow rate at the cathode side of the cell within a defined range, e.g., between about 1 mL/min and about 100 L/min. In various implementations, the flow rate is about 60 mL/min.

During the operation, the output stream from the anode flows via a conduit that connects to a backpressure controller configured to maintain pressure at the anode side of the cell within a defined range. (e.g., about 15 psig to about 1000 psig, about 30 psig to about 400 psig, or about 50 psig to about 90 psig, depending on the system configuration). The output stream may provide the reaction product to one or more components for separation and/or concentration.

In certain embodiments, the anode subsystem may be configured to controllably recycle water product(s) from the output stream back to the anode of the electrolyzer. In various implementations, the output stream is processed to remove oxidation product(s), namely O₂, before recycling the electrolyte. In some embodiments, one or more components for separating the electrolyte from the product stream are disposed downstream from the anode outlet. Examples of such component include a condenser configured to cool the product stream gas (O₂) and thereby provide a dry gas to a downstream process when needed.

In some embodiments, the water produced from the oxidation reaction may serve as the water source for the cathode subsystem.

In certain embodiments, the water electrolyzer may use a self-leveling reservoir. The self-leveling reservoir is an interconnected system wherein the downstream anode electrolyte reservoir and the downstream cathode electrolyte reservoir are connected through a central reservoir. In some embodiments, the self-leveling reservoir may incorporate one or more central reservoirs. During the operation, the O₂-removed, water-rich anode output stream and the H₂-removed, water-depleted cathode output stream are combined in the central electrolyte reservoir. The self-leveling reservoir is configured to recalibrate the concentration of the output stream of the electrolyte prior to recirculating it to the anode and the cathode via the anode inlet and the cathode inlet, respectively.

The central electrolyte reservoir in the self-leveling reservoir may be coupled to a flow controller configured to control the volumetric or mass flow rate of the electrolyte from the central reservoir to the anode and cathode. In some implementations, the flow controller may be a pump. The flow controller may be configured to maintain the flow rate at the anode and the cathode sides of the cell within a defined range, e.g., between about 1 mL/min and about 100 L/min. In various implementations, the flow rate is about 60 mL/min.

The water electrolyzer may also include an anode gas diffusion layer (GDL). When in use, the anode GDL transports O₂ gas. In some embodiments, the GDL may be porous. In other embodiments, GDL may be with or without a microporous layer. In some embodiments, the GDL in the anode layer may be identical to the GDL in the cathode layer.

Other control features may be included in the anode and cathode subsystems. For example, a temperature controller may be configured to heat and/or cool the water electrolyzer, and the cathode layers and/or the anode layer at appropriate points during its operation. In certain embodiments, a temperature controller is configured to heat and/or cool electrolytes downstream of the central electrolyte reservoir recirculation loop. The temperature controller may include or be coupled to a heater and/or cooler that may heat or cool electrolytes in the central reservoir and/or water reservoir. In some embodiments, the water electrolyzer may include a temperature controller configured to directly heat and/or cool a component other than the downstream electrolyte reservoir. Examples of such other components include the electrolyzer cell or stack, the cathode, and/or the anode.

In some embodiments, a temperature controller is configured to adjust the temperature of one or more components of the water electrolyzer based on phase operation. For example, the temperature of the electrolyzer may be increased or decreased during a break-in, a current pause in normal operation, and/or storage.

The water electrolyzer may also operate under the control of one or more electrical power sources and associated controllers. The electrical power source and the controller may be programmed or otherwise configured to control the current supplied to and/or to control voltage applied to the electrodes in the electrolyzer. The current and/or voltage may be controlled to execute the current schedules and/or current profiles. For example, the electrical power source and the controller may be configured to periodically pause the current applied to the anode and/or cathode of the electrolyzer.

In certain embodiments, the electric power source and controller perform some but not all of the operations necessary to implement desired current schedules and/or profiles in the electrolyzer. An operator or other responsible individual may act in conjunction with the electrical power source and controller to fully define the schedules and/or profiles of current applied to the electrolyzer. For example, an operator may institute one or more current pauses outside the set of current pauses programmed into the power source and controller.

In certain embodiments, the electrical power source and an optional, associated electrical power controller act in concert with one or more other controllers or control mechanisms associated with other components of the electrolyzer. For example, the electrical power source and the controller may act in concert with controllers for controlling the delivery of the electrolyte to the cathode and/or anode, the addition of pure water to the cathode subsystem, and any combinations of these features.

In some embodiments, a voltage monitoring system is employed to determine the voltage across an anode and cathode of the electrolyzers or across any two electrodes of an electrolyzer stack, e.g., determining the voltage across all cells in a multi-cell stack. In certain embodiments, voltage monitoring system is configured to work in concert with power supply to cause electrolyzer to remain within a specified voltage range.

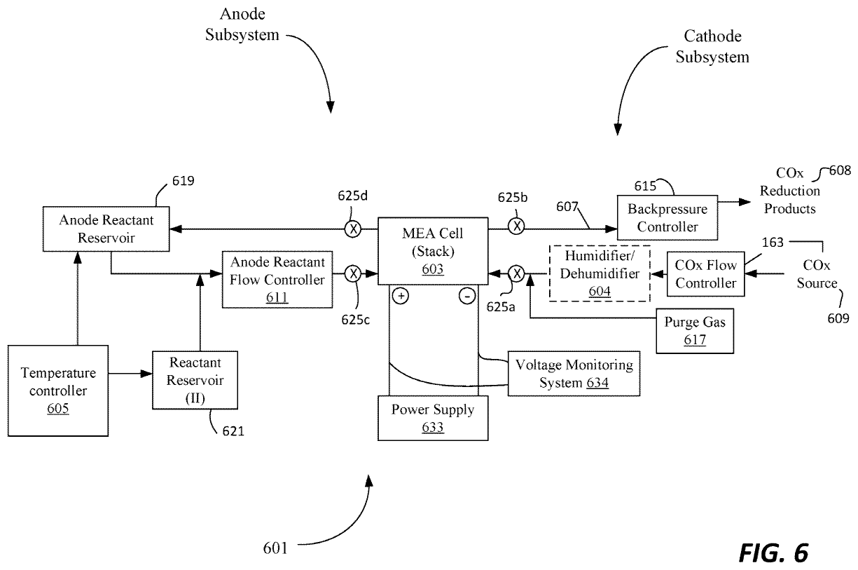

The water electrolyzer system may employ control elements or a control system that includes one or more controllers and one or more controllable components. Exemplary controllers and components are described herein with respect to the COₓ electrolyzer (see FIG. 6). It will be understood that such controllers and pumps, as well as associated systems, devices, hardware, and programs may also be implemented in the water electrolyzer system.

### AEM Polymer

Suitable materials for the AEM water electrolyzer may be chosen based on the ion transport properties and membrane stability of the resulting AEMs. In some embodiments, the suitable material is a polymer such as a class of poly(m-terphenyl) polymers.

The AEM used may possess ion transport properties such as high ion conductivity and high ion selectivity. The AEMs are highly efficacious in selectively transporting anions while successfully preventing cation crossover. Over the lifetime of the water electrolyzer, the back transport of cations could have a detrimental effect on the performance and lifetime, due to the build-up of salt in undesired places.

Salt build-up presents challenges in water management within the water electrolyzer devices. For example, salt build-up may act as a desiccant, contributing to a reduction of water, and may dry out the device in part or whole. In some embodiments, the AEM water electrolyzers described herein incorporate cations in the form of an aqueous electrolyte. However, in other embodiments, pure water absent of any cation is fed into the water electrolyzer to the anode side of the cell. This is advantageous because it reduces salt build-up.

In addition to ion transport properties, the material for the AEMs may be robust and have high mechanical stability, high chemical stability, and/or high thermal stability. The material should possess high mechanical stability to ensure that the membrane is not weak or brittle and can successfully withstand the pressure difference across the membrane. Moreover, high chemical stability is desirable since the water electrolyzers may be exposed to a relatively harsh chemical environment, for example, extreme pH and/or overpotential voltage. In some embodiments, a suitable material exposed to a harsh chemical environment may not experience cleavage of its backbone, chemical bonds, or attached ionic groups, and combinations thereof. Furthermore, the suitable materials are stable at moderately high operating temperatures, e.g., between 70° C. to 80° C.

In certain embodiments, suitable materials for the AEM-based water electrolyzer may have high alkaline stability.

In some embodiments, the polymer used in the anion-exchange membrane for water electrolysis may be selected from a family of poly(m-terphenyl) polymers. Examples include but are not limited to, poly(m-terphenyl trimethyl ammonium), poly(m-terphenyl methyl piperidinium), poly(m-terphenyl dipropyl methylamine), poly(m-terphenyl dimethyl hexylamine), poly(m-terphenyl dimethyl dodecylamine), poly(m-terphenyl methyl piperidinium)-random-poly(methyl m-terphenyl), poly(m-terphenyl trimethyl ammonium)-random-poly(methyl m-terphenyl), poly(m-terphenyl azoniaspiro [5,5]undecane), poly(m-terphenyl pyridium), poly(m-terphenyl dimethyl imidazolium), and combinations thereof.

In some embodiments, the polymer used in the anion-exchange membrane for water electrolysis may be selected from a family of poly(p-terphenyl) polymers. Examples include but are not limited to, poly(p-terphenyl trimethyl ammonium), poly(p-terphenyl methyl piperidinium), poly(p-terphenyl dipropyl methylamine), poly(p-terphenyl dimethyl hexylamine), poly(p-terphenyl dimethyl dodecylamine), poly(p-terphenyl methyl piperidinium)-random-poly(methyl p-terphenyl), poly(p-terphenyl trimethyl ammonium)-random-poly(methyl p-terphenyl), poly(p-terphenyl azoniaspiro [5,5]undecane), poly(p-terphenyl pyridium), poly(p-terphenyl dimethyl imidazolium), and combinations thereof.

In some embodiments, the polymer used in the anion-exchange membrane for water electrolysis may be selected from a family of poly(o-terphenyl) polymers. Examples include but are not limited to, poly(o-terphenyl trimethyl ammonium), poly(o-terphenyl methyl piperidinium), poly(o-terphenyl dipropyl methylamine), poly(o-terphenyl dimethyl hexylamine), poly(o-terphenyl dimethyl dodecylamine), poly(o-terphenyl methyl piperidinium)-random-poly(methyl o-terphenyl), poly(o-terphenyl trimethyl ammonium)-random-poly(methyl o-terphenyl), poly(o-terphenyl azoniaspiro [5,5]undecane), poly(o-terphenyl pyridium), poly(o-terphenyl dimethyl imidazolium), and combinations thereof.

In some embodiments, the polymer used in the anion-exchange membrane for water electrolysis may be selected from a family of poly(biphenyl) polymers. Examples include but are not limited to, poly(biphenyl trimethyl ammonium), poly(biphenyl methyl piperidinium), poly(biphenyl dipropyl methylamine), poly(biphenyl dimethyl hexylamine), poly(biphenyl dimethyl dodecylamine), poly(biphenyl methyl piperidinium)-random-poly(methyl biphenyl), poly(biphenyl trimethyl ammonium)-random-poly(methyl biphenyl), poly(biphenyl azoniaspiro [5,5]undecane), poly(biphenyl pyridium), poly(biphenyl dimethyl imidazolium), and combinations thereof.

In some embodiments, cross-linked polymers are used in the anion-exchange membrane for water electrolysis. Examples include but are not limited to, cross-linked poly(ethylene glycol), a poly(m-terphenyl), and combinations thereof. In various embodiments, poly(m-terphenyl) may necessarily contain a cross-linkable moiety to facilitate cross-linking of the poly(m-terphenyl). In various embodiments, the cross-linkable moiety may be any cross-linkable vinyl moiety, such as a styrene group. In another embodiment, the cross-linkable moiety may be acrylate and/or allyl. In alternative embodiments, combinations of two or more different poly(m-terphenyl) may be used. In some circumstances, all of the poly(m-terphenyl) may be cross-linked polymers, or at least one of the poly(m-terphenyl) is a cross-linked polymer.

In various embodiments, the polymer used in the anion-exchange membrane for water electrolysis may be functionalized. Examples of polar functional groups include thiols, primary amines or secondary amines, hydroxyls, carboxylic, and combinations thereof. In various embodiments, polar functional groups may attach to the polymer via an alkyl chain. In certain embodiments, the alkyl chain may be a 6-, 8-, or 12-carbon chain. An example of functionalized polymer includes but is not limited to, a poly(m-terphenyl) polymer that contains a thiol functional group, functionalized via a 6-carbon alkyl chain. In other embodiments, the functionalized polymer may be a poly(m-terphenyl) polymer that contains a thiol functional group, functionalized via a 12-carbon alkyl chain.

In some embodiments, the AEM layer may comprise 100 wt % polymer (1-100% ionomers). In some embodiments, the polymer is 7-bromo-1,1,1-triofluoroheptan-2-one/m-terphenyl copolymer trimethylamine. In certain embodiments, ionomers may be present in other layers of the AEM water electrolyzers. For instance, ionomers may be present in the catalyst layer of the cathode and/or anode and act as a binder for holding the layers. In other instances, an ionomer may be incorporated to stabilize a nanoparticle catalyst, preventing the nanoparticle catalyst from changing size or shape. In certain embodiments, ionomers may act as a binder as well as stabilize the nanoparticle catalyst. In some embodiments, the AEM layer of the water electrolyzer comprises one or more ion-conducting polymers (e.g., a polyarylene polymer) described in more detail below.

The thickness of the polymer layer in the AEM may impact the overall resistance and the mechanical stability of the membrane. For example, the thinner polymer layer may have lower resistance, but it may face more challenges toward stability. On the other hand, a thicker polymer layer may have higher resistance, hence higher voltage, but may be mechanically robust. In many cases, AEMs may be constructed to have a thickness between 20 μm to 50 μm. In other embodiments, the polymer layer is about 15 μm to 20 μm. In certain embodiments, where crosslinking polymers are used, the thickness of the AEM may be less than 20 μm.

The AEM may be characterized by its water uptake and ionic conductivity. In some embodiments, AEMs have high ionic conductivity and low water uptake properties.

### Operating Conditions

A water electrolyzer may be designed, and its operating conditions may be tuned to be specific for different applications. In certain implementations, the tunable operating conditions may include a flow rate of electrolyte, current density, voltage, temperature of reactants, and electrolyte concentration.

In certain embodiments, AEM-based water electrolyzers may be operated in a manner that produces any one or any combination of the following operating conditions:
a flow rate of the electrolyte between about 1 mL/min and about 100 L/min, or at 60 mL/min,
a current density between 12.5 A and 30 A, or between 500 mA/cm² and 5000 mA/cm² at 25 cm²,
a voltage between 1.5 V and 2.5 V, for example, between 1.8 V and 2.2 V,
a temperature of reactant about 60° C., or between 70° C. and 80° C.,
a water fed into the electrolyte during the operation to maintain the electrolyte concentration.

While AEM-based water electrolyzers are described above, the systems described herein may alternatively be implemented with other water electrolyzers. For examples, in some embodiments, the water electrolyzer is a proton exchange membrane electrolyzer.

### Water Electrolyzer and COₓ Electrolyzer Pairing

In some embodiments, H₂ from sources other than water electrolyzer may be supplied to the downstream COₓ electrolyzer(s) in addition to or instead of water electrolyzer. For example, other H₂ sources may include, but are not limited to, products and/or byproducts of other electrochemical processes (e.g., chloralkali), thermochemical processes (e.g., reformation), a byproduct of an upstream direct air capture process, and/or other industrial processes. In some embodiments, the H₂ may be supplied from one or more biogenic, geologic, or fossil fuel sources. However, in some embodiments, H₂ derived from fossil fuels is avoided. In some embodiments, H₂ from the water electrolyzer may be supplied to the downstream COₓ electrolyzer(s).

In certain embodiments, the water electrolyzer may be fluidically connected to a downstream COₓ electrolyzer, directly or indirectly. In some embodiments, the COₓ electrolyzer may be a CO₂ electrolyzer. The details of an exemplary CO₂ electrolyzer are provided herein. In various embodiments, output H₂ from the water electrolyzer may be fed into the anode of the COₓ electrolyzer.

In various embodiments, the water electrolyzer may be connected to a plurality of downstream COₓ electrolyzers, e.g., a plurality of downstream CO₂ electrolyzers, supplying output H₂ from the water electrolyzer to the anodes of a plurality of COₓ electrolyzers. In certain embodiments, one water electrolyzer may supply H₂ to at least one, at least two, at least three, at least four, at least five and/or up to four, up to six, up to eight, or up to ten COₓ electrolyzers. In a particular example, a water electrolyzer running at about or equal to 120 A can supply up to four COₓ electrolyzers operating at about or equal to 300 mA/cm².

In some embodiments, the output of the water electrolyzer, namely H₂, may be separated from the electrolyte solution before being introduced to downstream COₓ electrolyzer(s).

In some embodiments, separated H₂ product may be further purified and/or dried before it is provided to the downstream COₓ electrolyzer(s) (e.g., CO₂ electrolyzer(s)). The purification system may be a drier and/or a dehumidifier configured to remove excess water. The drier and/or dehumidifier may have a temperature control configured to maintain an operator-provided value. In some instances, the drier and/or dehumidifier may be configured to output a water electrolysis product (e.g., H₂ and/or O₂) with high purity, for example, at purity of at least 90%, at least 95%, at least 99%, or at least 99.9% (e.g., about 99.99%) for downstream integration into other unit(s). In some embodiments, the drier and/or dehumidifier may output products with a purity of less than 99.99%. In various embodiments, the drier may be a commercially available unit. In some embodiments, the H₂ provided to the COₓ electrolyzer may be a humidified H₂ stream having a relative humidity (RH) of at least about 5%, at least about 10%, at least about 25%, at least about 50%, up to about 75%, up to about 90%, or up to about 100%. Combinations of the above-referenced ranges are possible (e.g., about 5% to about 100%, or about 25% to about 75%). In some cases, the H₂ stream may have a relatively high RH, e.g., about 50% to about 100%, about 75% to about 100%, or about 90% to about 100%.

In another embodiment, separated and/or purified H₂ may be temporarily stored, prior to progressing to the COₓ electrolyzer (e.g., CO₂ electrolyzer), for some amount of time in a storage vessel for hydrogen. In other embodiments, a gas compression system may be employed in conjunction with storing H₂.

Multiple purification systems and/or gas compression systems may be employed. In various embodiments, oxygen and/or hydrogen produced by the water electrolyzer is provided to a storage vessel for the oxygen and/or a storage vessel for the hydrogen.

In certain embodiments, such as shown in FIGS. 1A-1B, the water electrolyzer may be directly connected to a downstream COₓ electrolyzer (e.g., CO₂ electrolyzer). In the COₓ electrolyzer, the output of the water electrolyzer may subsequently partake in a carbon oxide reduction reaction. For example, output H₂ from the water electrolyzer may be fed into the anode of the COₓ (e.g., CO₂) electrolyzer, which is then reduced to produce H⁺ ion according to H₂→2H⁺+2e⁻. In various embodiments, the H⁺ ion produced at the anode of the COₓ electrolyzer is transported to the cathode to reduce COₓ (e.g., CO₂) and generate at least one or more carbon-containing reduction products (CCPs) described elsewhere herein (e.g., CO). In some embodiments, at the cathode of the COₓ electrolyzer, water (e.g., a water vapor) is produced along with the carbon-containing product as a part of the cathode output stream. In some cases, a relatively small quantity of byproducts and/or impurities (e.g., H₂) may be produced as a part of the cathode output stream. In some cases, the cathode output stream may be substantially free of H₂, such as containing H₂ in an amount that is no more than 10 wt %, no more than 5 wt %, no more than 2 wt %, no more than 1 wt %, no more than 0.1 wt %, no more than 0.05 wt %, and/or down to 0.01 wt %, or down to 0 wt %. In some cases, H₂ is not produced at the cathode of the COₓ electrolyzer. In some embodiments, at the anode side of the COₓ electrolyzer, unreacted H₂ may be outlet from the anode of the COₓ electrolyzer as an anode output stream. The anode output stream, according to some embodiments, may be substantially free of water (in either vapor or liquid form), such as containing water in an amount that is no more than 10 wt %, no more than 5 wt %, no more than 2 wt %, no more than 1 wt %, no more than 0.1 wt %, no more than 0.05 wt %, and/or down to 0.01 wt %, or down to 0 wt %.

In alternative embodiments, depending on the carbon oxide electrolyzer configuration, one or more carbon-containing products may be produced in a downstream carbon oxide electrolyzer. Such carbon-containing reduction product(s) may include carbon monoxide, one or more hydrocarbons (e.g., alkanes and/or alkenes such as methane, ethene, and/or ethane), one or more alcohols (e.g., methanol, ethanol, n-propanol, allyl alcohol, and/or ethylene glycol), one or more aldehydes (e.g., formaldehyde, glycolaldehyde, acetaldehyde, glyoxal, and/or propionaldehyde), one or more ketones (e.g., acetone and/or hydroxyacetone), one or more carboxylic acids (e.g., formic acid and/or acetic acid), and any combination thereof.

In various embodiments, a plurality of water electrolyzers may be connected to a single downstream carbon oxide electrolyzer.

When pairing water electrolyzer(s) with COₓ (e.g., CO₂) electrolyzer(s), current density of each water electrolyzer(s) and CO electrolyzer(s) may be considered separately or in combination. Other considerations may include temperature and the H₂ gas pressure.

The current density consideration when pairing water electrolyzer(s) with COₓ (e.g., CO₂) electrolyzer(s) ensures that H₂ is balanced. That is, current densities of the water electrolyzer and COₓ electrolyzer(s) may be aligned such that the water electrolyzer may produce an appropriate amount of H₂ product for paired COₓ electrolyzer(s). Ideally, all or essentially all the H₂ produced in the water electrolyzer(s) is consumed in subsequent reactions at the (anode of) COₓ electrolyzer(s). To this extent, the current of each water electrolyzer may be equal to the total current of paired COₓ electrolyzer(s). For example, a water electrolyzer operating at about or equal to 120 A may supply H₂ to four COₓ electrolyzer(s) operating at about or equal to 300 mA/cm².

### COₓ Electrolyzers

In some embodiments, a water electrolyzer may be paired with a downstream COₓ electrolyzer (e.g., CO₂ electrolyzer). During the operation, H₂ produced in the water electrolyzer and/or other source of H₂ may be fed to an anode of the COₓ electrolyzer to undergo a hydrogen oxidation reaction, thereby producing protons that are utilized in a reduction reaction at the cathode to produce a carbon-containing product (e.g., CO) and water. As used herein, COₓ may be carbon dioxide (CO₂), carbon monoxide (CO), CO₃²⁻ (carbonate ion), HCO₃²⁻ (bicarbonate ion), or combinations thereof.

The COₓ electrolyzer(s) (e.g., CO₂ electrolyzer(s)) may comprise a membrane electrode assembly (MEA) containing an anode layer, a cathode layer, electrolyte, and optionally, one or more other layers. In some embodiments, the MEA comprises a polymer electrolyte membrane disposed between the anode layer and cathode layer. The layers may be solids and/or soft materials. In some embodiments, the COₓ electrolyzer(s) may comprise an AEM-based architecture. In various embodiments, the COₓ electrolyzer(s) may have a bipolar membrane (BPM) based architecture. In some embodiments, the BPM architecture may include a liquid anolyte feed stream passed to an additional chamber at the BPM interface.

When in use, the cathode of an MEA promotes electrochemical reduction of COₓ by combining three inputs: COₓ, ions (e.g., protons) that chemically react with COₓ, and electrons. The reduction reaction may produce CO, hydrocarbons, and/or oxygen and hydrogen-containing organic compounds such as water, methanol, ethanol, and acetic acid. In some embodiments, when in use, the anode of an MEA may promote an electrochemical oxidation reaction of hydrogen gas to produce protons. The cathode and anode may each contain catalysts to facilitate their respective reactions.

The compositions and arrangements of layers in the MEA for a COₓ electrolyzer (CO₂ electrolyzer) may promote a high yield of COₓ (e.g., CO₂) reduction products. To this end, the MEA may facilitate any one or more of the following conditions: (a) minimal parasitic reduction reactions (non-CO₂ reduction reactions) at the cathode; (b) low loss of reactants at the anode or elsewhere in the MEA; (c) maintain the physical integrity of the MEA during the reaction (e.g., prevent delamination of the MEA layers); (d) prevent CO₂ reduction product cross-over; (e) prevent oxidation production (e.g., CO₂ and/or O₂) cross-over; (f) maintain a suitable environment at the cathode/anode for oxidation/reduction as appropriate; (g) provide a pathway for desired ions to travel between cathode and anode while blocking undesired ions; and (h) minimize voltage losses.

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large geometric surface area by comparison to MEAs used for fuel cells in automotive applications. For example, MEAs for COₓ reduction may employ electrodes having geometric surface areas (without considering pores and other nonplanar features) of at least about 500 cm².

COₓ reduction reactions may be implemented in operating environments that facilitate mass transport of particular reactant and product species, as well as suppress parasitic reactions. Fuel cell and water electrolyzer MEAs often cannot produce such operating environments. For example, such MEAs may promote undesirable parasitic reactions such as gaseous hydrogen evolution at the cathode and/or gaseous COₓ (e.g., CO₂) production at the anode.

In various embodiments described herein, hydrogen oxidation reaction HOR is facilitated at the anode of the COₓ electrolyzer(s) (e.g., CO₂ electrolyzer). In some embodiments, when in use, the anode layer undergoes a hydrogen oxidation reaction (HOR) that promotes oxidation of H₂ and may produce hydrogen ions (H⁺), i.e., protons, according to the half-reaction: H₂→2H⁺+2e⁻. The cathode layer promotes the electrochemical reduction of COₓ (e.g., CO₂) by combining COₓ, protons, and electrons to produce a carbon-containing product. For example, in embodiments in which the COₓ feed is CO₂, the combination may produce CO and water according to the half-reaction: CO₂+2e⁻+2 H⁺→CO+H₂O. The anode and cathode may each contain catalysts to facilitate their respective reactions. During the operation, protons produced in the anode layer may be transported via a polymer electrolyte membrane disposed between the anode layer and cathode layer to the cathode catalyst layer. Subsequently, the proton may combine with CO₂ according to the cathode half-reaction mentioned earlier. In various implementations, H₂ gas is used as a reactant rather than water which may lead to reduced consumption of water and/or salt in the electrolyzer system as compared to a water-based oxygen evolution reaction (OER). In some instances, this in turn may provide MEA durability benefits.

An HOR reaction may be a thermochemical and/or electrochemical reaction. In some embodiments, operating the HOR reaction electrochemically offers several advantages, such as a higher conversion rate. For example, when HOR is driven thermochemically, the conversion of CO₂ to CO may not be complete and plateau at about 70% conversion (at high temperatures). In contrast, when HOR is driven electrochemically, the conversion of CO₂ to CO may be complete or nearly complete (e.g., above about 75%, above about 80%, above about 85%, above about 90%, or above about 95%. A non-limiting example of a thermochemical HOR reaction may be a reverse water-gas shift reaction. Embodiments of the systems and methods described herein use electrochemical HOR reactions.

In some cases, the use of H₂ as a feed for HOR reaction may allow for stable operation of COₓ electrolyzer at a relatively high operating temperature (and lower cell voltage) compared to other anode feeds. In some embodiments, the CO₂ electrolyzer may be operated at a temperature of less than about 100° C., less than or equal to about 80° C., less than or equal to about 70° C., less than or equal to about 60° C., less than or equal to about 50° C., less than or equal to about 40° C., less than or equal to about 30° C., and/or at least about 20° C., at least about 30° C., at least about 40° C., at least about 50° C., at least about 60° C., at least about 70° C., at least about 80° C. Combinations of the above-referenced ranges are possible (e.g., about 20° C. to about 80° C., about 30° C. to about 70° C., etc.). Other ranges are also possible.

In various embodiments, COₓ electrolyzers (e.g., CO₂ electrolyzers) incorporating HOR instead of OER may exhibit a reduction in thermodynamic and overpotential voltage. Thermodynamically, voltage is reduced by about 1.2 V. The reduction in voltage is a result of the thermodynamic difference between OER and HOR half-reactions. In addition, when the overpotential voltage differences between OER and HOR catalysts are considered, the voltage reduction is estimated to be about 1.5 V.

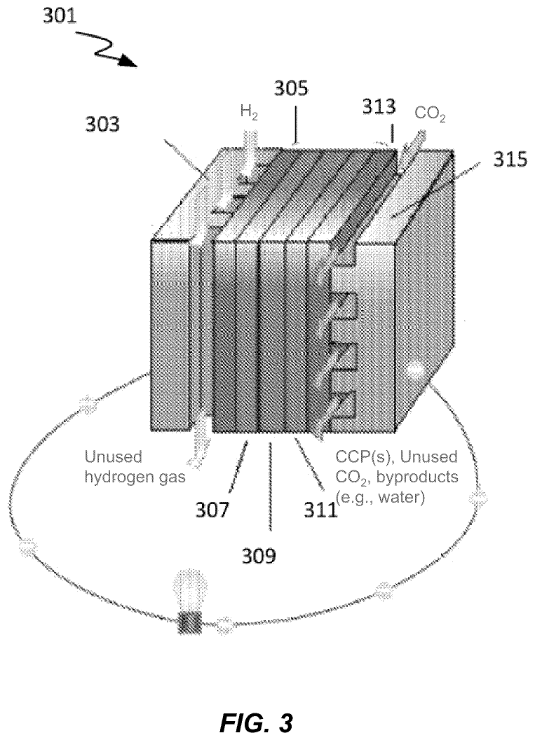

In various embodiments, COₓ electrolyzer (e.g., CO₂ electrolyzers) incorporating HOR at the anode may have cross-section of that is more symmetric than OER-based anode electrolyzers. FIG. 3 provides an illustrative example of the COₓ electrolyzer (e.g., CO₂ electrolyzer) incorporating HOR at its anode. In various embodiments, the COₓ electrolyzer (e.g., CO₂ electrolyzer) incorporating HOR 301 may be constructed to include following layers: an anode flow field 303 (i.e., hydrogen gas flow field) having an inlet providing H₂ and an outlet for removing anode output (e.g., unreacted H₂, a carbon-containing product, byproducts, etc.), an anode gas diffusion layer 305 delivering hydrogen gas to the catalyst/anode layer 307, an anode layer 307 containing an oxidation catalyst, a membrane 309 disposed between and conductively connecting (and in contact with) the anode layer 307 and cathode layer 311, a cathode layer 311 containing a reduction catalyst, a cathode gas diffusion layer 313 for delivering COₓ (e.g., CO₂) to the catalyst/cathode layer 311, and a cathode flow field 315 having an inlet for providing COₓ (e.g., CO₂) and outlet for removing cathode output including carbon-containing product (CCP) (e.g., CO), unreacted COₓ, and byproduct (e.g., a water byproduct). In some embodiments, the anode flow field 303, the anode gas diffusion layer 305, and the anode layer 307 together form the anode the of the electrolyzer, while the cathode flow field 315, the cathode gas diffusion layer 313, and the cathode layer 311 together form the cathode of the electrolyzer. In some cases, the anode layer 307, the cathode layer 311, and the membrane 309 interposed between the anode and cathode layers together form a membrane stack such as a membrane electrode assembly (MEA), according to some embodiments. In some cases, the anode layer 307 may be disposed between (and in contact with) the anode flow field 303 and the anode gas diffusion layer 305, while the cathode layer 311 may be disposed between (and in contact with) the cathode flow field 315 and the cathode gas diffusion layer 313. In some embodiments, depending on the catalyst, the type of membrane electrode assembly, and/or the reaction carried out within the carbon oxide electrolyzer, the carbon-containing product may be either produced either at the cathode or the anode of the electrolyzer.

In some embodiments, the cathode gas diffusion layer comprises a plurality of gas diffusion layers (GDLs) stacked together, such as between 2 to 10 GDLs, or between 11 GDLs and any number of suitable GDLs. In some cases, the cathode gas diffusion layer may have a relatively high overall thickness, such as between 350 μm and 3000 μm, between 350 and 550 μm, between 950 and 1250 μm, or between 1350 and 1750 μm. Without wishing to be bound by any particular theory, it is hypothesized that using a thicker GDL, e.g., 350 μm or thicker, may lead to more repeatable and higher performance than a thinner, e.g., 200 μm or less, GDL. Since commercially available GDLs having such thicknesses (e.g., 350 μm or thicker) were not available, multiple discrete GDLs may be arranged in a stacked configuration in order to obtain the desired thicknesses for the cathode GDL. In some embodiments, a cathode GDL comprising a plurality of GLDs and/or having a relatively high overall thickness as described above may exhibit enhanced water removal ability than a thinner cathode GLD, which in turns may allow for better electrolyzer performance. Specifically, the cathode GDL in a COₓ electrolyzer, in combination with the cathode flow field, plays a significant role in the removal of water from the COₓ electrolyzer cathode. GDLs that are selected or constructed so as to have particular characteristics may enhance the water ejection rates and/or capabilities of a COₓ electrolyzer. The ability of the MEA in a COₓ electrolyzer to react COₓ may be hampered by the presence of liquid water, which may be present in significant amounts during normal operation. If not adequately removed from the cathode, water degrades COₓ electrolyzer performance by influencing the mass transport of gaseous species and facilitating the production of side products such as H₂ through the electrolysis of water. A cathode GDL described herein may thus facilitate removal of water from the electrolyzer, increase mass transport of gaseous species, and reduce production of side products.

In various embodiments, any catalysts suitable for promoting oxidation of H₂ may be used in the COₓ (e.g., CO₂) electrolyzers. For example, platinum catalysts may be used in the COₓ electrolyzers, which may be more cost-effective than other catalyst materials, such as iridium.

In various embodiments, stack components or hardware (e.g., flow fields and other stack components) within the electrolyzer may comprise carbon-based materials (e.g., graphite) and/or stainless steel. In some embodiments, the COₓ electrolyzer(s) is substantially free of titanium components or hardware.

In some embodiments, the HOR reactor may be operated at a less oxidizing voltage/electrochemical environment and at a lower pressure compared to OER. Moreover, in various implementations, the thickness and/or size of the membrane may be reduced with HOR at the anode. For example, when incorporating HOR, a constant pressure of about 10 bar (or about 2 bar to about 20 bar, or about 5 bar to about 15 bar) and a constant temperature of about 60° C. (or about 40° C. to about 80° C., or about 50° C. to about 70° C.) may be used when current and/or voltage is modulated. In other instances, a constant pressure of about 10 bar and a constant current and/or voltage may be used when the temperature is modulated. For example, the HOR reactor may be operated at a voltage of about 0.5V to 2.5V, about 1V to 2V, or about 1.5V to 2.5V, or about 0.5V to 1V, etc.

### MEA Configuration for CO₂ Electrolyzer

In certain embodiments, the COₓ electrolyzer(s) may comprise a membrane electrode assembly (MEA) comprising an anode layer (i.e., anode catalyst layer), a cathode layer (i.e., cathode catalyst layer), and a polymer electrolyte membrane (PEM) disposed between the anode layer and cathode layer. In certain embodiments, the MEA may also include a cathode buffer layer between the cathode layer and the polymer electrolyte membrane.

In certain embodiments, the MEA includes a bipolar interface having an anion-conducting polymer on the cathode side of the MEA and an interfacing cation-conducting polymer on the anode side of the MEA.

The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM comprises an ion-conducting polymer. In certain embodiments, the MEA has a cathode buffer layer between the cathode layer and the polymer electrolyte membrane. The cathode buffer comprises an ion-conducting polymer.

The PEM includes an ion-conducting polymer, in some embodiments. The PEM may provide ionic communication between the anode layer and the cathode layer, while preventing electronic communication, which would result in a short circuit. In various embodiments, the PEM facilitates diffusion of proton produced at the anode layer to the cathode layer for CO₂ reduction. In some embodiments, the PEM contains a cation-conducting polymer. In certain embodiments, the PEM may comprise of sulfonated tetrafluoroethylene-based fluoropolymer-copolymer, e.g., Nafion®, but it may be any other suitable PEM comprising any other suitable polymer material. In certain embodiments, the PEM comprises solely of sulfonated tetrafluoroethylene-based fluoropolymer-copolymer, e.g., Nafion®.

The ion-conducting polymers in the PEM, the cathode, the anode, and the cathode buffer layer, if present, may each be different from one another in composition, conductivity, molecular weight, or other properties. In some cases, two or more of these polymers are identical or substantially identical. For example, the ion-conducting polymer in the cathode and cathode buffer layer may be identical.

In certain embodiments, the MEA has a cathode buffer layer between the cathode layer and the polymer electrolyte membrane. The cathode buffer may be an anion-conductive polymer.

In certain embodiments, the MEA has an anode buffer layer between the anode layer and the polymer electrolyte membrane. The anode buffer layer also comprises an ion-conducting polymer, which may have the same properties as any of the other ion-conducting polymers (e.g., the ion-conducting polymer in the anode). Alternatively, the ion-conducting layer of the anode buffer layer may be different from every other ion-conducting layer in the MEA.

In connection with certain MEA designs, the polymers in the layers may be chosen from among three available classes of ion-conducting polymers: anion-conductors, cation-conductors, and mixed cation-and-anion-conductors. In certain embodiments, at least two of the ion-conducting polymers are from different classes of ion-conducting polymers.

In certain embodiments, an MEA has a bipolar interface, which means that it has one layer of anion-conducting polymer in contact with a layer of cation-conducting polymer. One example of an MEA with a bipolar interface is an anion-conducting cathode buffer layer adjacent to (and in contact with) a cation-conducting PEM. In certain embodiments, an MEA contains only anion-conducting polymer between the anode and the cathode. Such MEAs are sometimes referred to as “AEM only” MEAs. Such MEAs may contain one or more layers of anion-conducting polymer between the anode and the cathode.

The term “ion-conducting polymer” is used herein to describe a polymer electrolyte having greater than about 1 mS/cm specific conductivity for anions and/or cations. The term “anion-conductor” describes an ion-conducting polymer that conducts anions primarily (although there will still be some small amount of cation conduction) and has a transference number for anions greater than about 0.85 at around 100 micron thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at around 100 micron thickness. For an ion-conducting polymer that is described as conducting both anions and cations (a “cation-and-anion-conductor”), neither the anions nor the cations have a transference number greater than approximately 0.85 or less than approximately 0.15 at around 100 micron thickness. To say a material conducts ions (anions and/or cations) is to say that the material is an ion-conducting material or ionomer. Examples of ion-conducting polymers of each class are provided in the below Table.

Ion-Conducting Polymers

| | | Common | |
|---|---|---|---|
| Class | Description | Features | Examples |
| A. Anion- | Greater than | Positively | aminated tetramethyl |
| conducting | approximately 1 | charged | polyphenylene; |
| | mS/cm specific | functional | poly(ethylene-co- |
| | conductivity for | groups are | tetrafluoroethylene)- |
| | anions, which | covalently | based quaternary |
| | have a | bound to the | ammonium polymer; |
| | transference number | polymer | quaternized |
| | greater than | backbone | polysulfone |
| | approximately | | |
| | 0.85 at around 100 | | |
| | micron thickness | | |
| B. Conducts | Greater than | Salt is | polyethylene oxide; |
| both anions | approximately 1 | soluble in | polyethylene glycol; |
| and cations | mS/cm conductivity | the polymer | poly(vinylidene |
| | for ions (including | and the salt | fluoride); |
| | both cations and | ions can | polyurethane |
| | anions), which | move | |
| | have a | through | |
| | transference | the polymer | |
| | number | material | |
| | between | | |
| | approximately | | |
| | 0.15 and 0.85 at | | |
| | around 100 micron | | |
| | thickness | | |
| C. Cation- | Greater than | Negatively | perfluorosulfonic acid |
| conducting | approximately 1 | charged | polytetrafluoroethylene |
| | mS/cm specific | functional | co-polymer; |
| | conductivity for | groups are | sulfonated poly(ether |
| | cations, which | covalently | ether ketone); |
| | have a | bound | poly(styrene sulfonic |
| | transference number | to the | acid- co-maleic acid) |
| | greater than | polymer | |
| | approximately | backbone | |
| | 0.85 at around 100 | | |
| | micron thickness | | |

Class A ion-conducting polymers are known by tradenames such as 2259-60 (Pall RAI), AHA by Tokuyama Co, Fumasep® FAA—(fumatech GbbH), Sustanion®, Morgane ADP by Solvay, or Tosflex® SF-17 by Tosoh anion exchange membrane material. Further class A ion-conducting polymers include HNN5/HNN8 by Ionomr, FumaSep by Fumatech, TM1 by Orion, and PAP-TP by W7energy. Some Class C ion-conducting polymers are known by tradenames such as various formulations of Nafion® (DuPont™), GORE-SELECT® (Gore), Fumapem® (fumatech GmbH), and Aquivion® PFSA (Solvay).

In some embodiments, the polymer used in the MEAs may be selected from a family of poly(m-terphenyl) polymers. Examples include but are not limited to, poly(m-terphenyl trimethyl ammonium), poly(m-terphenyl methyl piperidinium), poly(m-terphenyl dipropyl methylamine), poly(m-terphenyl dimethyl hexylamine), poly(m-terphenyl dimethyl dodecylamine), poly(m-terphenyl methyl piperidinium)-random-poly(methyl m-terphenyl), poly(m-terphenyl trimethyl ammonium)-random-poly(methyl m-terphenyl), poly(m-terphenyl azoniaspiro [5,5]undecane), poly(m-terphenyl pyridium), poly(m-terphenyl dimethyl imidazolium), and combinations thereof.

In some embodiments, the polymer used in the MEAs may be selected from a family of poly(p-terphenyl) polymers. Examples include but are not limited to, poly(p-terphenyl trimethyl ammonium), poly(p-terphenyl methyl piperidinium), poly(p-terphenyl dipropyl methylamine), poly(p-terphenyl dimethyl hexylamine), poly(p-terphenyl dimethyl dodecylamine), poly(p-terphenyl methyl piperidinium)-random-poly(methyl p-terphenyl), poly(p-terphenyl trimethyl ammonium)-random-poly(methyl p-terphenyl), poly(p-terphenyl azoniaspiro [5,5]undecane), poly(p-terphenyl pyridium), poly(p-terphenyl dimethyl imidazolium), and combinations thereof.

In some embodiments, the polymer used in the MEAs may be selected from a family of poly(o-terphenyl) polymers. Examples include but are not limited to, poly(o-terphenyl trimethyl ammonium), poly(o-terphenyl methyl piperidinium), poly(o-terphenyl dipropyl methylamine), poly(o-terphenyl dimethyl hexylamine), poly(o-terphenyl dimethyl dodecylamine), poly(o-terphenyl methyl piperidinium)-random-poly(methyl o-terphenyl), poly(o-terphenyl trimethyl ammonium)-random-poly(methyl o-terphenyl), poly(o-terphenyl azoniaspiro [5,5]undecane), poly(o-terphenyl pyridium), poly(o-terphenyl dimethyl imidazolium), and combinations thereof.

In some embodiments, the polymer used in the MEAs may be selected from a family of poly(biphenyl) polymers. Examples include but are not limited to, poly(biphenyl trimethyl ammonium), poly(biphenyl methyl piperidinium), poly(biphenyl dipropyl methylamine), poly(biphenyl dimethyl hexylamine), poly(biphenyl dimethyl dodecylamine), poly(biphenyl methyl piperidinium)-random-poly(methyl biphenyl), poly(biphenyl trimethyl ammonium)-random-poly (methyl biphenyl), poly(biphenyl azoniaspiro [5,5]undecane), poly(biphenyl pyridium), poly(biphenyl dimethyl imidazolium), and combinations thereof.

In some embodiments, cross-linked polymers are used in the MEAs. Examples include but are not limited to, cross-linked poly(ethylene glycol), a poly(m-terphenyl), and combinations thereof. In various embodiments, poly(m-terphenyl) may necessarily contain a cross-linkable moiety to facilitate cross-linking of the poly(m-terphenyl). In various embodiments, the cross-linkable moiety may be any cross-linkable vinyl moiety, such as a styrene group. In another embodiment, the cross-linkable moiety may be acrylate and/or allyl. In alternative embodiments, combinations of two or more different poly(m-terphenyl) may be used. In some circumstances, all of the poly(m-terphenyl) may be cross-linked polymers, or at least one of the poly(m-terphenyl) is a cross-linked polymer.

In various embodiments, the polymer used in the MEAs may be functionalized. Examples of polar functional groups include thiols, primary amines or secondary amines, hydroxyls, carboxylic, and combinations thereof. In various embodiments, polar functional groups may attach to the polymer via an alkyl chain. In certain embodiments, the alkyl chain may be a 6-, 8-, or 12-carbon chain. An example of functionalized polymer includes but is not limited to, a poly(m-terphenyl) polymer that contains a thiol functional group, functionalized via a 6-carbon alkyl chain. In other embodiments, the functionalized polymer may be a poly(m-terphenyl) polymer that contains a thiol functional group, functionalized via a 12-carbon alkyl chain.

### Bipolar MEA

In certain embodiments, the MEA includes a bipolar interface with an anion-conducting polymer on the cathode side of the MEA and an interfacing cation-conducting polymer on the anode side of the MEA. In some implementations, the cathode layer contains a first catalyst and an anion-conducting polymer. In certain embodiments, the anode layer contains a second catalyst and a cation-conducting polymer. In some implementations, a cathode buffer layer, located between the cathode layer and PEM, contains an anion-conducting polymer. In some embodiments, an anode buffer layer, located between the anode layer and PEM, contains a cation-conducting polymer. In some embodiments, the MEA comprises a bipolar membrane positioned between the cathode layer and the anode layer, where the bipolar membrane comprises an anion-exchange membrane adjacent the cathode layer and a cation-exchange membrane (e.g., proton-exchange membrane) adjacent the anode layer, as described in more detail below.

During operation, an MEA with a bipolar interface moves ions through a polymer-electrolyte, moves electrons through metal and/or carbon in the cathode and anode layers, and moves liquids and gas through pores in the layers.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas generation is decreased and the rate of CO or other product production and the overall efficiency of the process are increased.

Another process that may be avoided is transport of carbonate or bicarbonate ions to the anode, effectively removing CO₂ from the cathode. Aqueous carbonate or bicarbonate ions may be produced from CO₂ at the cathode. If such ions reach the anode, they may decompose and release gaseous CO₂. The result is net movement of CO₂ from the cathode to the anode, where it does not get reduced and is lost with oxidation products. To prevent the carbonate and bicarbonate ion produced at the cathode from reaching the anode, the polymer-electrolyte membrane and/or an anode buffer layer may include a cation-conducting polymer, which at least partially blocks the transport of negative ions such as bicarbonate or carbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂, negative ions (e.g. bicarbonate, carbonate), hydrogen, and CO₂ reduction products (e.g., CO, methane, ethylene, alcohols) to the anode side of the cell.

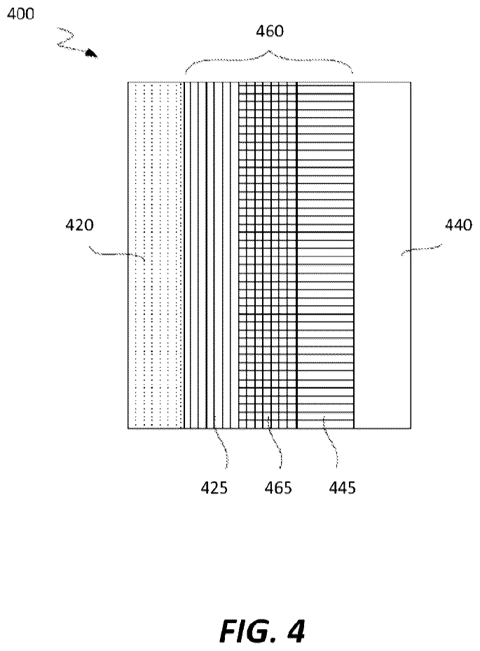

An example MEA 200 for use in COₓ reduction is shown in FIG. 4. The MEA 400 has a cathode layer 420 and an anode layer 440 separated by an ion-conducting polymer layer 460 that provides a path for ions to travel between the cathode layer 420 and the anode layer 440. In certain embodiments, the cathode layer 420 includes an anion-conducting polymer and/or the anode layer 440 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 460 may include two or three sublayers: a polymer electrolyte membrane (PEM) 465, an optional cathode buffer layer 425, and/or an optional anode buffer layer 445. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 465 is nonporous. Example characteristics of anode buffer layers and cathode buffer layers are provided elsewhere herein.

FIG. 5A shows CO₂ electrolyzer 503 configured to receive water and CO₂ (e.g., humidified or dry gaseous CO₂) as a reactant at a cathode 505 and expel CO as a product. In some embodiments, the CO₂ electrolyzer 503 is configured to receive gaseous CO₂ (humidified or dried gaseous CO₂) as a reactant at the cathode 505 and expel CO and water as a product. In some embodiments, the CO₂ reactant may have any appropriate relative humidity (RH), such as at least about 5%, at least about 10%, at least about 25%, at least about 50%, up to about 75%, up to about 90%, or up to about 100%. Combinations of the above-referenced ranges are possible (e.g., about 5% to about 100%, or about 25% to about 75%). In some cases, the CO₂ reactant stream may have a relatively high RH, e.g., about 50% to about 100%, about 75% to about 100%, or about 90% to about 100%. In certain embodiments, the CO₂ electrolyzer 503 is configured to receive gaseous hydrogen (H₂) as a reactant at the anode 507 and expel unreacted hydrogen. In some embodiments, the gaseous hydrogen may be either dry or humidified hydrogen, such as having a RH level described above for the CO₂ feed. Electrolyzer 503 includes bipolar layers having an anion-conducting polymer 509 adjacent to cathode 505 and a cation-conducting polymer 511 (illustrated as a proton-exchange membrane) adjacent to anode 507.

As illustrated in the magnification inset of a bipolar interface 513 in electrolyzer 503, the cathode 505 includes an anion exchange polymer (which in this example is the same anion-conducting polymer 509 that is in the bipolar layers) electronically conducting carbon support particles 517, and metal nanoparticles 519 supported on the support particles. In some embodiments, CO₂ and water are transported via pores such as pore 521 and reach metal nanoparticles 519 where they react, in this case with hydroxide ions, to produce bicarbonate ions and reduction reaction products (not shown). CO₂ may also reach metal nanoparticles 519 by transport within anion exchange polymer 515. In other embodiments, CO₂ and proton (not shown) are transported via pores such as pore 521 and reach metal nanoparticles 519 where they react to produce CO and water reduction products (not shown).

Hydrogen ions are transported from anode 507, and through the cation-conducting polymer 511, until they reach bipolar interface 513, where they are hindered from further transport toward the cathode by anion exchange polymer 509. At bipolar interface 513, the hydrogen ions may react with bicarbonate or carbonate ions to produce carbonic acid (H₂CO₃), which may decompose to produce CO₂ and water. As explained herein, the resulting CO₂ may be provided in gas phase and should be provided with a route in the MEA back to the cathode 505 where it can be reduced. The cation-conducting polymer 511 hinders transport of anions such as bicarbonate ions to the anode where they could react with protons and release CO₂, which would be unavailable to participate in a reduction reaction at the cathode. In other embodiments, the hydrogen ions may react with CO₂ to produce CO and water.

As illustrated, a cathode buffer layer having an anion-conducting polymer may work in concert with the cathode and its anion-conductive polymer to block transport of protons to the cathode. While MEAs employing ion conducting polymers of appropriate conductivity types in the cathode, the anode, cathode buffer layer, and if present, an anode buffer layer may hinder transport of cations to the cathode and anions to the anode, cations and anions may still come in contact in the MEA's interior regions, such as in the membrane layer.

As illustrated in FIG. 5A, bicarbonate and/or carbonate ions combine with hydrogen ions between the cathode layer and the anode layer to form carbonic acid, which may decompose to form gaseous CO₂. It has been observed that MEAs sometime delaminate, possibly due to this production of gaseous CO₂, which does not have an easy egress path.

The delamination problem can be addressed by employing a cathode buffer layer having pores. One possible explanation of its effectiveness is that the pores create paths for the gaseous carbon dioxide to escape back to the cathode where it can be reduced. In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode. The porosity of various layers in an MEA is described further at other locations herein.

The CO₂ electrolyzer is not limited to those having bipolar membranes. An MEA with only a cation exchange membrane or an anion exchange membrane between the cathode catalyst layer and the anode catalyst layer may be used.

While FIG. 5A illustrate a non-limiting example of a CO₂ electrolyzer configured to receive CO₂ as the cathode side feed, it should be understood that the disclosure is not so limited and that in certain embodiments, the setup and operation described with respect to the CO₂ electrolyzer in FIG. 5A may be applicable to COₓ electrolyzer(s) in general for other COₓ feeds described elsewhere herein.

### AEM-Only MEA

In some embodiments, an MEA does not contain a cation-conducting polymer layer. In such embodiments, the electrolyte is not a cation-conducting polymer and the anode, if it includes an ion-conducting polymer, does not contain a cation-conducting polymer. Examples are provided herein.

An anion-exchange membrane (AEM)-only (AEM-only) MEA allows conduction of anions across the MEA. In embodiments in which none of the MEA layers has significant conductivity for cations, hydrogen ions have limited mobility in the MEA. In some implementations, an AEM-only membrane provides a high pH environment (e.g., at least about pH 7) and may facilitate CO₂ and/or CO reduction by suppressing the hydrogen evolution parasitic reaction at the cathode. As with other MEA designs, the AEM-only MEA allows ions, notably anions such as hydroxide ions, to move through polymer-electrolyte. The pH may be lower in some embodiments; a pH of 4 or greater may be high enough to suppress hydrogen evolution. The AEM-only MEA also permits electrons to move to and through metal and carbon in catalyst layers. In embodiments, having pores in the anode layer and/or the cathode layer, the AEM-only MEA permits liquids and gas to move through pores.

In certain embodiments, the AEM-only MEA comprises an anion-exchange polymer electrolyte membrane with an electrocatalyst layer on either side: a cathode and an anode. In some embodiments, one or both electrocatalyst layers also contain anion-exchange polymer-electrolyte.

In certain embodiments, an AEM-only MEA is formed by depositing cathode and anode electrocatalyst layers onto porous conductive supports such as gas diffusion layers to form gas diffusion electrodes (GDEs) and sandwiching an anion-exchange membrane between the gas diffusion electrodes.

In certain embodiments, an AEM-only MEA is used for CO₂ reduction. The use of an anion-exchange polymer electrolyte avoids a low pH environment that disfavors CO₂ reduction. Further, water is transported away from the cathode catalyst layer when an AEM is used, thereby preventing water build up (flooding) which can block reactant gas transport in the cathode of the cell.

Water transport in the MEA occurs through a variety of mechanisms, including diffusion and electro-osmotic drag. In some embodiments, at current densities of the CO₂ electrolyzers described herein, electro-osmotic drag is the dominant mechanism. Water is dragged along with ions as they move through the polymer electrolyte. For a cation-exchange membrane such as Nafion membrane, the amount of water transport is well characterized and understood to rely on the pre-treatment/hydration of the membrane. Protons move from positive to negative potential (anode to cathode) with each carrying 2-4 water molecules with it, depending on pretreatment. In anion-exchange polymers, the same type of effect occurs. Hydroxide, bicarbonate, or carbonate ions moving through the polymer electrolyte will ‘drag’ water molecules with them. In the anion-exchange MEAs, the ions travel from negative to positive voltage, so from cathode to anode, and they carry water molecules with them, moving water from the cathode to the anode in the process.

In certain embodiments, an AEM-only MEA is employed in CO reduction reactions. Unlike the CO₂ reduction reaction, CO reduction does not produce carbonate or bicarbonate anions that could transport to the anode and release valuable reactant.

FIG. 5B illustrates an example construction of a COₓ reduction MEA 401 having a cathode catalyst layer 403, an anode catalyst layer 407, and an anion-conducting PEM 405. In certain embodiments, cathode catalyst layer 403 includes metal catalyst particles (e.g., nanoparticles) that are unsupported or supported on a conductive substrate such as carbon particles. In some implementations, cathode catalyst layer 403 additionally includes an anion-conducting polymer. The metal catalyst particles may catalyze COₓ reduction, particularly at pH greater than a threshold pH, which may be pH 4-7, for example, depending on the catalyst. In certain embodiments, anode catalyst layer 405 includes metal oxide catalyst particles (e.g., nanoparticles) that are unsupported or supported on a conductive substrate such as carbon particles. In some implementations, anode catalyst layer 403 additionally includes an anion-conducting polymer. Examples of metal oxide catalyst particles for anode catalyst layer 405 include iridium oxide, nickel oxide, nickel iron oxide, iridium ruthenium oxide, platinum oxide, and the like. Anion-conducting PEM 405 may comprise any of various anion-conducting polymers such as, for example, HNN5/HNN8 by Ionomr, FumaSep by Fumatech, TM1 by Orion, PAP-TP by W7energy, Sustainion by Dioxide Materials, and the like. These and other anion-conducting polymer that have an ion exchange capacity (IEC) ranging from 1.1 to 2.6 mmol/g, working pH ranges from 0-14, bearable solubility in some organic solvents, reasonable thermal stability and mechanical stability, good ionic conductivity/ASR and acceptable water uptake/swelling ratio may be used. The polymers may be chemically exchanged to certain anions instead of halogen anions prior to use. In some embodiments, the anion-conducting polymer may have an IEC of 1 to 3.5 mmol/g.

As illustrated in FIG. 5B, COₓ such as CO₂ gas may be provided to cathode catalyst layer 403. In certain embodiments, the CO₂ may be provided via a gas diffusion electrode. At the cathode catalyst layer 403, the CO₂ reacts to produce reduction product indicated generically as CₓO_{y}H_{z}. Anions produced at the cathode catalyst layer 403 may include hydroxide, carbonate, and/or bicarbonate. In some embodiments, water may be produced at the cathode catalyst layer 403. These may diffuse, migrate, or otherwise move to the anode catalyst layer 405. In embodiments herein, in which hydrogen gas is used as the anode feed, the hydrogen gas may undergo hydrogen oxidation reaction (HOR) at the anode catalyst layer 405 to produce hydrogen ions. In some applications, the hydrogen ions may react with hydroxide, carbonate, and/or bicarbonate to produce water, carbonic acid, and/or CO₂. Fewer interfaces give lower resistance. In some embodiments, a highly basic environment is maintained for C2 and C3 hydrocarbon synthesis.

FIG. 5C illustrates an example construction of a CO reduction MEA 501 having a cathode catalyst layer 523, an anode catalyst layer 527, and an anion-conducting PEM 525. Overall, the constructions of MEA 501 may be similar to that of MEA 401 in FIG. 5B. However, the cathode catalyst may be chosen to promote a CO reduction reaction, which means that different reduction catalysts would be used in CO and CO₂ reduction embodiments.

In some embodiments, an AEM-only MEA may be advantageous for CO reduction. The water uptake number of the AEM material can be selected to help regulate moisture at the catalyst interface, thereby improving CO availability to the catalyst. AEM-only membranes can be favorable for CO reduction due to this reason. Bipolar membranes can be more favorable for CO₂ reduction due to better resistance to CO₂ dissolving and crossover in basic anolyte media.

In various embodiments, cathode catalyst layer 523 includes metal catalyst particles (e.g., nanoparticles) that are unsupported or supported on a conductive substrate such as carbon particles. In some implementations, cathode catalyst layer 523 additionally includes an anion-conducting polymer. In certain embodiments, anode catalyst layer 527 includes metal oxide catalyst particles (e.g., nanoparticles) that are unsupported or supported on a conductive substrate such as carbon particles. In some implementations, anode catalyst layer 527 additionally includes an anion-conducting polymer. Examples of metal oxide catalyst particles for anode catalyst layer 527 may include those identified for the anode catalyst layer 407 of FIG. 5B. Anion-conducting PEM 525 may comprise any of various anion-conducting polymer such as, for example, those identified for the PEM 405 of FIG. 5B.

As illustrated in FIG. 5C, CO gas may be provided to cathode catalyst layer 523. In certain embodiments, the CO may be provided via a gas diffusion electrode. At the cathode catalyst layer 523, the CO reacts to produce reduction product indicated generically as CₓO_{y}H_{z}.

Anions produced at the cathode catalyst layer 523 may include hydroxide ions. These may diffuse, migrate, or otherwise move to the anode catalyst layer 527. In embodiments herein, in which hydrogen gas is used as the anode feed, a hydrogen oxidation reaction (HOR) may occur at the anode catalyst layer 527 to produce hydrogen ions. In some applications, the hydrogen ions may react with hydroxide ions to produce water.

While the general configuration of the MEA 501 is similar to that of MEA 401, there are certain differences in the MEAs. First, MEAs may be wetter for CO reduction, helping keep the polymer electrolyte hydrated. Also, for CO₂ reduction, a significant amount of CO₂ may be transferred to the anode for an AEM-only MEA such as shown in FIG. 5B. For CO reduction, there is less likely to be significant CO gas crossover. In this case, the reaction environment could be very basic. MEA materials, including the catalyst, may be selected to have good stability in high pH environment. In some embodiments, a thinner membrane may be used for CO reduction than for CO₂ reduction.

### Cathode Catalyst Layer

As indicated above, the cathode of the MEA, which is also referred to as the cathode layer or cathode catalyst layer, facilitates COₓ conversion. It is a porous layer containing catalysts for COₓ reduction reactions, according to some embodiments.

In some embodiments, the cathode catalyst layer contains a blend of reduction catalyst particles, electronically-conductive support particles that provide support for the reduction catalyst particles, and a cathode ion-conducting polymer. In some embodiments, the reduction catalyst particles are blended with the cathode ion-conducting polymer without a support.

Examples of materials that can be used for the reduction catalyst particles include, but are not limited, to transition metals such as V, Cr, Mn, Fe, Co, Ni, Cu, Zn, Zr, Nb, Mo, Au, Ru, Rh, Pd, Ag, Cd, Hf, Ta, W, Re, Ir, Pt, and Hg, and combinations thereof, and/or any other suitable materials. Other catalyst materials can include alkali metals, alkaline earth metals, lanthanides, actinides, and post transition metals, such as Sn, Si, Ga, Pb, Al, TI, Sb, Te, Bi, Sm, Tb, Ce, Nd and In or combinations thereof, and/or any other suitable catalyst materials. The choice of catalyst depends on the particular reaction performed at the cathode of the COₓ reduction reactor (CRR) (e.g., COₓ reduction electrolyzer).

Catalysts can be in the form of nanoparticles that range in size from approximately 1 to 100 nm or particles that range in size from approximately 0.2 to 10 nm or particles in the size range of approximately 1-1000 nm or any other suitable range. In addition to nanoparticles and larger particles, films and nanostructured surfaces may be used.

If used, the electronically-conductive support particles in the cathode can be carbon particles in various forms. Other possible conductive support particles include boron-doped diamond or fluorine-doped tin oxide. In one arrangement, the conductive support particles are Vulcan carbon. The conductive support particles can be nanoparticles. The size range of the conductive support particles is between approximately 20 nm and 1000 nm or any other suitable range. It is especially useful if the conductive support particles are compatible with the chemicals that are present in the cathode when the CRR is operating, are reductively stable, and have a high hydrogen production overpotential so that they do not participate in any electrochemical reactions.

For composite catalysts such as Au/C, example metal nanoparticle sizes may range from about 1-100 nm, e.g., 2 nm-20 nm and the carbon size may be from about 20-200 nm as supporting materials. For pure metal catalyst such as Ag or Cu, the particles have a broad range from 2 nm to 500 nm in term of crystal grain size. The agglomeration could be even larger to micrometer range.

In general, such conductive support particles are larger than the reduction catalyst particles, and each conductive support particle can support many reduction catalyst particles. In some embodiments, two different kinds of catalysts are supported on a support particle, such as a carbon particle. Catalyst particles of a first type and second catalyst particle of a second type may be attached to the catalyst support particle. In various arrangements, there is only one type of catalyst particle or there are more than two types of catalyst particles attached to the catalyst support particle.

Using two types of catalysts may be useful in certain embodiments. For example, one catalyst may be good at one reaction (e.g., CO₂→CO) and the second good at another reaction (e.g., CO→CH₄). Overall, the catalyst layer would perform the transformation of CO₂ to CH₄, but different steps in the reaction would take place on different catalysts.

The electronically-conductive support may also be in forms other than particles, including tubes (e.g., carbon nanotubes) and sheets (e.g., graphene). Structures having high surface area to volume are useful to provide sites for catalyst particles to attach.

In addition to reduction catalyst particles and electronically-conductive support particles, the cathode catalyst layer may include an ion conducting polymer. There are tradeoffs in choosing the amount of cathode ion-conducting polymer in the cathode. It can be important to include enough cathode ion-conducting polymer to provide sufficient ionic conductivity. But it is also important for the cathode to be porous so that reactants and products can move through it easily and to maximize the amount of catalyst surface area that is available for reaction. In various arrangements, the cathode ion-conducting polymer makes up somewhere in the range between 30 and 70 wt %, between 20 and 80 wt %, or between 10 and 90 wt %, of the material in the cathode layer, or any other suitable range. The wt % of ion-conducting polymer in the cathode is selected to result in the cathode layer porosity and ion-conductivity that gives the highest current density for COₓ reduction. In some embodiments, it may be between 20 and 60 wt. % or between 20 and 50 wt. %. Example thicknesses of the cathode catalyst layer range from about 80 nm-300 μm.

In addition to the reduction catalyst particles, cathode ion conducting polymer, and if present, the electronically-conductive support, the cathode catalyst layer may include other additives such as PTFE.

In addition to polymer:catalyst mass ratios, the catalyst layer may be characterized by mass loading (mg/cm²), and porosity. Porosity may be determined by a various manners. In one method, the loading of each component (e.g., catalyst, support, and polymer) is multiplied by its respective density. These are added together to determine the thickness the components take up in the material. This is then divided by the total known thickness to obtain the percentage of the layer that is filled in by the material. The resulting percentage is then subtracted from 1 to obtain the percentage of the layer assumed to be void space (e.g., filled with air or other gas or a vacuum), which is the porosity. Methods such as mercury porosimetry or image processing on TEM images may be used as well.

The catalyst layer may also be characterized by its roughness. The surface characteristics of the catalyst layer can impact the resistances across the membrane electrode assembly. Excessively rough catalyst layers can potentially lead to interfacial gaps between the catalyst and the microporous layer. These gaps hinder the continuous pathway for electron transfer from the current collector to the catalytic area, thus, increasing contact resistances. Interfacial gaps may also serve as locations for water accumulation that is detrimental to mass transport of reactants and products. On the other hand, extremely smooth surfaces may suffer from poor adhesion between layers. Catalyst layer roughness may influence electrical contact resistances and concentration polarization losses. Surface roughness can be measured using different techniques (e.g. mechanical stylus method, optical profilometry, or atomic force microscopy) and is defined as the high-frequency, short wavelength component of a real surface. Arithmetic mean height, Sa, is a parameter that is commonly used to evaluate the surface roughness. Numerically, it is calculated by integrating the absolute height of valleys and peaks on the surface relative to the mean plane over the entire geometric area of the sample. Catalyst layer Sa values between 0.50-1.10 μm or 0.70-0.90 μm may be used in some embodiments.

In some embodiments, the COₓ electrolyzer may comprise catalysts (e.g., reduction and/or oxidation catalysts) that are substantially free of iridium. In some embodiments, the reduction and/or oxidation catalyst contains no more than 10 wt %, no more than 5 wt %, no more than 1 wt %, no more than 0.1 wt %, no more than 0.01 wt %, no more than 0.001 wt %, no more than 0.0001 wt %, and/or down to 0% of iridium. In some embodiments, the reduction and/or oxidation catalyst lacks iridium.

The functions, materials, and structures of the components of the cathode catalyst layer are described further below.

A primary function of the cathode catalyst layer is to provide a catalyst for COₓ reduction. An example reaction is:

CO₂+2H⁺+2e−→CO+H₂O.

The cathode catalyst layer also has a number of other functions that facilitate COₓ conversion. These include water management, gas transport, reactant delivery to the metal catalyst, product removal, stabilizing the particulate structure of the metal catalyst, electronic and ionic conduction to the metal catalyst, and mechanical stability within the MEA.

Certain functions and challenges are particular to CRRs and are not found in MEA assemblies for other applications such as fuel cells or water electrolyzers. These challenges include that the cathode catalyst layer of the MEA transports gas (e.g., CO₂ or CO) in and gas (e.g., ethylene, methane, CO) or liquid (e.g., ethanol or water) out. The cathode catalyst layer also prevents accumulation of water that can block gas transport. Further, catalysts for COₓ reduction are not as developed as catalysts like platinum that can be used in hydrogen fuel cells. As a result, the COₓ reduction catalysts are generally less stable. These functions, their particular challenges, and how they can be addressed are described below.

The cathode catalyst layer is structured for gas transport. Specifically, COₓ is transported to the catalyst and gas phase reaction products (e.g., CO, ethylene, methane, etc.) is transported out of the catalyst layer.

Certain challenges associated with gas transport are unique to CRRs. Gas is transported both in and out of the cathode catalyst layer-COₓ in and products such as CO, ethylene, water, and methane out. In a PEM fuel cell, gas (O₂ or H₂) is transported in but nothing or product water comes out. And in a PEM water electrolyzer, water is the reactant with O₂ and H₂ gas products.

Operating conditions including pressures, temperature, and flow rate through the reactor affect the gas transport. Properties of the cathode catalyst layer that affect gas transport include porosity; pore size and distribution; layer thickness; and ionomer distribution.

In some embodiments, the ionomer-catalyst contact is minimized. For example, in embodiments that use a carbon support, the ionomer may form a continuous network along the surface of the carbon with minimal contact with the catalyst. The ionomer, support, and catalyst may be designed such that the ionomer has a higher affinity for the support surface than the catalyst surface. This can facilitate gas transport to and from the catalyst without being blocked by the ionomer, while allowing the ionomer to conduct ions to and from the catalyst.

The ionomer may have several functions including holding particles of the catalyst layer together and allowing movement of ions through the cathode catalyst layer. In some cases, the interaction of the ionomer and the catalyst surface may create an environment favorable for COₓ reduction, increasing selectivity to a desired product and/or decreasing the voltage required for the reaction. Importantly, the ionomer is an ion-conducting polymer to allow for the movement of ions through the cathode catalyst layer. Hydroxide, bicarbonate, and carbonate ions, for example, are moved away from the catalyst surface where the COₓ reduction occurs. In the description below, the ionomer in the cathode catalyst layer can be referred to as a first ion-conducting polymer.

The first ion-conducting polymer can comprise at least one ion-conducting polymer that is an anion-conductor. This can be advantageous because it raises the pH compared to a proton conductor.

In some embodiments, the first ion-conducting polymer can comprise one or more covalently-bound, positively-charged functional groups configured to transport mobile negatively-charged ions. The first ion-conducting polymer can be selected from the group consisting of aminated tetramethyl polyphenylene; poly(ethylene-co-tetrafluoroethylene)-based quaternary ammonium polymer; quaternized polysulfone), blends thereof, and/or any other suitable ion-conducting polymers. The first ion-conducting polymer can be configured to solubilize salts of bicarbonate or hydroxide.

In some embodiments, the first ion-conducting polymer can comprise at least one ion-conducting polymer that is a cation-and-anion-conductor. The first ion-conducting polymer can be selected from the group consisting of polyethers that can transport cations and anions and polyesters that can transport cations and anions. The first ion-conducting polymer can be selected from the group consisting of polyethylene oxide, polyethylene glycol, polyvinylidene fluoride, and polyurethane.

A cation-and-anion conductor will raise pH (compared to a pure cation conductor.) Further, in some embodiments, it may be advantageous to use a cation-and-anion conductor to promote acid base recombination in a larger volume instead of at a 2D interface of anion-conducting polymer and cation conducting polymer. This can spread out water and CO₂ formation, heat generation, and potentially lower the resistance of the membrane by decreasing the barrier to the acid-base reaction. All of these may be advantageous in helping avoid the buildup of products, heat, and lowering resistive losses in the MEA leading to a lower cell voltage.

A typical anion-conducting polymer has a polymer backbone with covalently bound positively charged functional groups appended. These may include positively charged nitrogen groups in some embodiments. In some embodiments, the polymer backbone is non-polar, as described above. The polymer may be any appropriate molecular weight, e.g., 25,000 g/mol-150,000 g/mol, though it will be understood that polymers outside this range may be used.

Particular challenges for ion-conducting polymers in CRR's include that CO₂ can dissolve or solubilize polymer electrolytes, making them less mechanically stable, prone to swelling, and allowing the polymer to move more freely. This makes the entire catalyst layer and polymer-electrolyte membrane less mechanically stable. In some embodiments, polymers that are not as susceptible to CO₂ plasticization are used. Also, unlike for water electrolyzers and fuel cells, conducting carbonate and bicarbonate ions is a key parameter for CO₂ reduction.

The introduction of polar functional groups, such as hydroxyl and carboxyl groups which can form hydrogen bonds, leads to pseudo-crosslinked network formation. Cross-linkers like ethylene glycol and aluminum acetylacetonate can be added to reinforce the anion exchange polymer layer and suppress polymer CO₂ plasticization. Additives like polydimethylsiloxane copolymer can also help mitigate CO₂ plasticization.

According to various embodiments, the ion-conducting polymer may have a bicarbonate ionic conductivity of at least 6 mS/cm, or in some embodiments at least 12 mS/cm, is chemically and mechanically stable at temperatures 80° C. and lower, and soluble in organic solvents used during fabrication such as methanol, ethanol, and isopropanol. The ion-conducting polymer is stable (chemically and has stable solubility) in the presence of the COₓ reduction products. The ion-conducting polymer may also be characterized by its ion exchange capacity, the total of active sites or functional groups responsible for ion exchange, which may range from 2.1 mmol/g-2.6 mmol/g in some embodiments. In some embodiments, ion-conducting polymers having lower IECs such as greater than 1 or 1.5 mmol/g may be used.

Examples of anion-conducting polymers are given above as Class A ion-conducting polymers. A particular example of an anion-conducting polymer is Orion mTPN1 (also referred to herein as Orion TM1), which has m-triphenyl fluori-alkylene as backbone and trimethylamonium (TMA+) as cation group. The chemical structure is shown below.

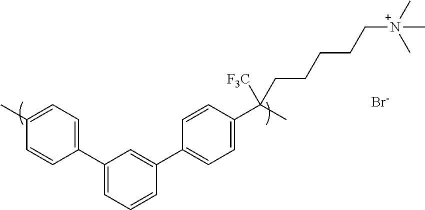

Additional examples include anion exchange membranes produced by Fumatech and Ionomr. Fumatech FumaSep FAA-3 ionomers come in Br-form. Anion exchange polymer/membrane based on polybenzimidazole produced by Ionomr comes in I-form as AF-1-HNN8-50-X.

The as-received polymer may be prepared by exchanging the anion (e.g., I⁻, Br⁻, etc.) with bicarbonate.

Also, as indicated above, in certain embodiments the ionomer may be a cation-and-anion-conducting polymer. Examples are given in the above table as Class B ion-conducting polymers.

The metal catalyst catalyzes the COₓ reduction reaction(s). The metal catalyst is typically nanoparticles, but larger particles, films, and nanostructured surfaces may be used in some embodiments. The specific morphology of the nanoparticles may expose and stabilize active sites that have greater activity.

The metal catalyst is often composed of pure metals (e.g., Cu, Au, Ag), but specific alloys or other bimetallic systems may have high activity and be used for certain reactions. The choice of catalyst may be guided by the desired reaction. For example, for CO production, Au may be used; for methane and ethylene production, Cu may be used. Other metals including Ag, alloys, and bimetallic systems may be used.

Metal catalyst properties that affect the cathode catalyst layer performance include size, size distribution, uniformity of coverage on the support particles, shape, loading (characterized as weight of metal/weight of metal+weight of carbon or as mass of particles per geometric area of catalyst layer), surface area (actual metal catalyst surface area per volume of catalyst layer), purity, and the presence of poisoning surface ligands from synthesis.

Nanoparticles may be synthesized by any appropriate method, such as for example, described in Phan et al., “Role of Capping Agent in Wet Synthesis of Nanoparticles,” J. Phys. Chem. A 2018, 121, 17, 3213-3219; Bakshi “How Surfactants Control Crystal Growth of Nanomaterials,” Cryst. Growth Des. 2016, 16, 2, 1104-1133; and Morsy “Role of Surfactants in Nanotechnology and Their Applications,” Int. J. Curr. Microbiol. App. Sci. 2014, 3, 5, 237-260, which are incorporated by reference herein.

In some embodiments, metal nanoparticles are provided without the presence of poisoning surface ligands. This may be achieved by using the ionomer as a ligand to direct the synthesis of nanocrystal catalysts. The surface of the metal nanocatalysts are directly connected with ionically conductive ionomer. This avoids having to treat the catalyst surface to allow ionomer contact with the metal and improves the contact.

The metal catalyst may be disposed on a carbon support in some embodiments. For CO production, examples include Premetek 20 wt % Au supported on Vulcan XC-72R carbon with 4-6 nm Au particle size and 30% Au/C supported on Vulcan XC-72R with 5-7 nm Au particle size. For methane, examples include Premetek 20 wt % Cu supported on Vulcan XC-72R carbon with 20-30 nm Cu particle size. In some embodiments, the metal catalyst may be unsupported. For ethylene production, examples of unsupported metal catalysts include SigmaAldrich unsupported Cu 80 nm particle size and ebeam or sputter deposited thin Cu layer of 10 nm to 100 nm.

The support of the cathode catalyst layer has several functions. It stabilizes metal nanoparticles to prevent them from agglomerating and distributes the catalytic sites throughout the catalyst layer volume to spread out loss of reactants and formation of products. It also forms an electrically conductive pathway to metal nanoparticles. Carbon particles, for example, pack together such that contacting carbon particles provide the electrically conductive pathway. Void space between the particles forms a porous network that gas and liquids can travel through.

In some embodiments, carbon supports developed for fuel cells can be used. Many different types have been developed; these are typically 50 nm-500 nm in size, and can be obtained in different shapes (spheres, nanotubes, sheets (e.g., graphene)), porosities, surface area per volume, electrical conductivity, functional groups (N-doped, O-doped, etc.).

The support may be hydrophobic and have affinity to the metal nanoparticle.

Examples of carbon blacks that can be used include:
Vulcan XC-72R-Density of 256 mg/cm², 30-50 nm
Ketjen Black-Hollow structure, Density of 100-120 mg/cm², 30-50 nm.
Printex Carbon, 20-30 nm

### Anode Catalyst Layer

The anode of the MEA, which is also referred to as the anode layer or anode catalyst layer, facilitates oxidation reactions. It is a porous layer containing catalysts for oxidation reactions. In some embodiments, anode of the MEA may facilitate hydrogen oxidation reaction (HOR).

In some embodiments, with reference to FIG. 4, the anode 440 contains a blend of oxidation catalyst and an anode ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. In some embodiments, the oxidation catalyst is substantially free of Iridium (Ir). The oxidation catalyst can further contain conductive support particles selected from the group consisting of carbon, boron-doped diamond, and titanium. For example, oxidation catalysts may comprise 5-80% carbon-supported platinum catalyst or other metal catalysts and/or supported metal catalysts.

The oxidation catalyst can be in the form of a structured mesh or can be in the form of particles. If the oxidation catalyst is in the form of particles, the particles can be supported by electronically-conductive support particles. The conductive support particles can be nanoparticles. It is especially useful if the conductive support particles are compatible with the chemicals that are present in the anode 440 when the COₓ reduction reactor (CRR) is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In general, such conductive support particles are larger than the oxidation catalyst particles, and each conductive support particle can support many oxidation catalyst particles. An example of such an arrangement is shown in FIG. 5A and is discussed above with respect to the cathode catalyst layer. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

In some embodiments, the MEA has an anode layer comprising oxidation catalyst and a second ion-conducting polymer. The second ion-conducting polymer can comprise one or more polymers that contain covalently-bound, negatively-charged functional groups configured to transport mobile positively-charged ions. The second ion-conducting polymer can be selected from the group consisting of ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Examples of cation-conducting polymers include e.g., Nafion 115, Nafion 117, and/or Nafion 211.

There are tradeoffs in choosing the amount of ion-conducting polymer in the anode. It is important to include enough anode ion-conducting polymer to provide sufficient ionic conductivity. But it is also important for the anode to be porous so that reactants and products can move through it easily, and to maximize the amount of catalyst surface area that is available for reaction. In various arrangements, the ion-conducting polymer in the anode makes up approximately 50 wt % of the layer or between approximately 5 and 20 wt %, 10 and 90 wt %, between 20 and 80 wt %, between 25 and 70 wt %, or any suitable range. It is especially useful if the anode 240 can tolerate high voltages, such as voltages above about 1.2 V vs. a reversible hydrogen electrode. It is especially useful if the anode 240 is porous in order to maximize the amount of catalyst surface area available for reaction and to facilitate gas and liquid transport.

### Polymer Electrolyte Membrane

The MEAs include a polymer electrolyte membrane (PEM) disposed between and conductively coupled to the anode catalyst layer and the cathode catalyst layer. Referring to FIG. 4, the polymer electrolyte membrane 465 has high ionic conductivity (greater than about 1 mS/cm), and is mechanically stable. Mechanical stability can be evidenced in a variety of ways such as through high tensile strength, modulus of elasticity, elongation to break, and tear resistance. Many commercially-available membranes can be used for the polymer electrolyte membrane 465. Examples include, but are not limited to, various Nafion® formulations, GORE-SELECT, FumaPEM® (PFSA) (FuMA-Tech GmbH), and Aquivion® (PFSA) (Solvay).

In one arrangement, the PEM comprises at least one ion-conducting polymer that is a cation-conductor. The third ion-conducting polymer can comprise one or more covalently-bound, negatively-charged functional groups configured to transport mobile positively-charged ions. The third ion-conducting polymer can be selected from the group consisting of ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof.

### Cathode Buffer Layer

Referring to FIG. 4, it is important to note that when the polymer electrolyte membrane 465 is a cation conductor and is conducting protons, it contains a high concentration of protons during operation of the CRR, while the cathode 420 operates best when a low concentration of protons is present. It can be useful to include a cathode buffer layer 425 between the polymer electrolyte membrane 465 and the cathode 420 to provide a region of transition from a high concentration of protons to a low concentration of protons. In one arrangement, the cathode buffer layer 425 is an ion-conducting polymer with many of the same properties as the ion-conducting polymer in the cathode 420. The cathode buffer layer 425 provides a region for the proton concentration to transition from the polymer electrolyte membrane 465, which has a high concentration of protons to the cathode 420, which has a low proton concentration. Within the cathode buffer layer 425, protons from the polymer electrolyte membrane 465 encounter anions from the cathode 420, and they neutralize one another. The cathode buffer layer 425 helps ensure that a deleterious number of protons from the polymer electrolyte membrane 465 does not reach the cathode 420 and raise the proton concentration. If the proton concentration of the cathode 420 is too high, COₓ reduction does not occur. High proton concentration is considered to be in the range of approximately 10 to 0.1 molar and low concentration is considered to be less than approximately 0.01 molar.

The cathode buffer layer 425 can include a single polymer or multiple polymers. If the cathode buffer layer 425 includes multiple polymers, the multiple polymers can be mixed together or can be arranged in separate, adjacent layers. Examples of materials that can be used for the cathode buffer layer 425 include, but are not limited to, FumaSep FAA-3, Tokuyama anion exchange membrane material, and polyether-based polymers, such as polyethylene oxide (PEO), and blends thereof. Further examples are given above in the discussion of the cathode catalyst layer.

The thickness of the cathode buffer layer is chosen to be sufficient that COₓ reduction activity is high due to the proton concentration being low. This sufficiency can be different for different cathode buffer layer materials. In some embodiments, the thickness of the cathode buffer layer is between approximately 200 nm and 100 μm, between 300 nm and 75 μm, between 500 nm and 50 μm, or any suitable range.

In some embodiments, the cathode buffer layer is less than 50 μm, for example between 1-25 μm such between 1-5 μm, 5-15 μm, or 10-25 μm. By using a cathode buffer layer in this range of thicknesses, the proton concentration in the cathode can be reduced while maintaining the overall conductivity of the cell. In some embodiments, an ultra-thin layer (100 nm-1 μm and in some embodiments, sub-micron) may be used. And as discussed above, in some embodiments, the MEA does not have a cathode buffer layer. In some such embodiments, anion-conducting polymer in the cathode catalyst layer is sufficient. The thickness of the cathode buffer layer may be characterized relative to that of the PEM.

Water and CO₂ formed at the interface of a cathode buffer layer and a PEM can delaminate the MEA where the polymer layers connect. The delamination problem can be addressed by employing a cathode buffer layer having inert filler particles and associated pores. One possible explanation of its effectiveness is that the pores create paths for the gaseous carbon dioxide to escape back to the cathode where it can be reduced.

Materials that are suitable as inert filler particles include, but are not limited to, TiO₂, silica, PTFE, zirconia, and alumina. In various arrangements, the size of the inert filler particles is between 5 nm and 500 μm, between 10 nm and 100 μm, or any suitable size range. The particles may be generally spherical.

If PTFE (or other filler) volume is too high, it will dilute the polymer electrolyte to the point where ionic conductivity is low. Too much polymer electrolyte volume will dilute the PTFE to the point where it does not help with porosity. In many embodiments a mass ratio of polymer electrolyte/PTFE is 0.25 to 2, and more particularly, 0.5 to 1. A volume ratio polymer electrolyte/PTFE (or, more generally, polymer electrolyte/inert filler) may be 0.25 to 3, 0.5 to 2, 0.75 to 1.5, or 1.0 to 1.5.

In other arrangements, porosity is achieved by using particular processing methods when the layers are formed. One example of such a processing method is laser ablation, where nano to micro-sized channels are formed in the layers. Another example is mechanically puncturing a layer to form channels through it. Another example is appropriately tailoring conditions during ultrasonic spray deposition of a layer to make it porous.

In one arrangement, the cathode buffer layer has a porosity between 0.01% and 95% (e.g., approximately between, by weight, by volume, by mass, etc.). However, in other arrangements, the cathode buffer layer can have any suitable porosity (e.g., between 0.01-95%, 0.1-95%, 0.01-75%, 1-95%, 1-90%). In some embodiments, the porosity is 50% or less, e.g., 0.1-50%, 5-50%, 20-50%, 5-40%, 10-40%, 20-40%, or 25%-40%. In some embodiments, the porosity is 20% or below, e.g. 0.1-20%, 1-10%, or 5-10%.

Porosity of the cathode buffer layer or any layer in the MEA may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation. As described further below, the porosity may be determined using measured loading and thickness of the layer and known density of the material or materials of the layer.

Porosity in layers of the MEA, including the cathode buffer layer, is described further below.

### Anode Buffer Layer

In some CRR reactions, bicarbonate is produced at the cathode 420, as shown in FIG. 4. It can be useful if there is a polymer that blocks bicarbonate transport somewhere between the cathode 420 and the anode 440, to prevent migration of bicarbonate away from the cathode. It can be that bicarbonate takes some CO₂ with it as it migrates, which decreases the amount of CO₂ available for reaction at the cathode. In one arrangement, the polymer electrolyte membrane 465 includes a polymer that blocks bicarbonate transport. Examples of such polymers include, but are not limited to, Nafion® formulations, GORE-SELECT, FumaPEM® (PFSA) (FuMA-Tech GmbH), and Aquivion® (PFSA) (Solvay). In another arrangement, there is an anode buffer layer 445 between the polymer electrolyte membrane 465 and the anode 440, which blocks transport of bicarbonate. If the polymer electrolyte membrane is an anion-conductor, or does not block bicarbonate transport, then an additional anode buffer layer to prevent bicarbonate transport can be useful. Materials that can be used to block bicarbonate transport include, but are not limited to Nafion® formulations, GORE-SELECT, FumaPEM® (PFSA) (FuMA-Tech GmbH), and Aquivion® (PFSA) (Solvay). Of course, including a bicarbonate blocking feature in the ion-exchange layer 460 is not particularly desirable if there is no bicarbonate in the CRR.

In another embodiment, the anode buffer layer 445 provides a region for proton concentration to transition between the polymer electrolyte membrane 465 to the anode 440. The concentration of protons in the polymer electrolyte membrane 465 depends both on its composition and the ion it is conducting. For example, a Nafion polymer electrolyte membrane 465 conducting protons has a high proton concentration. A FumaSep FAA-3 polymer electrolyte membrane 465 conducting hydroxide has a low proton concentration. For example, if the desired proton concentration at the anode 440 is more than 3 orders of magnitude different from the polymer electrolyte membrane 465, then an anode buffer layer 445 can be useful to effect the transition from the proton concentration of the polymer electrolyte membrane 465 to the desired proton concentration of the anode. The anode buffer layer 445 can include a single polymer or multiple polymers. If the anode buffer layer 445 includes multiple polymers, the multiple polymers can be mixed together or can be arranged in separate, adjacent layers. Materials that can be useful in providing a region for the pH transition include, but are not limited to, Nafion, FumaSep FAA-3, Sustainion®, Tokuyama anion exchange polymer, and polyether-based polymers, such as polyethylene oxide (PEO), blends thereof, and/or any other suitable materials. High proton concentration is considered to be in the range of approximately 10 to 0.1 molar and low concentration is considered to be less than approximately 0.01 molar. Ion-conducting polymers can be placed in different classes based on the type(s) of ions they conduct. This has been discussed in more detail above. There are three classes of ion-conducting polymers described in the table above. In one embodiment of the invention, at least one of the ion-conducting polymers in the cathode 420, anode 440, polymer electrolyte membrane 465, cathode buffer layer 425, and anode buffer layer 445 is from a class that is different from at least one of the others.

### Layer Porosity

In some embodiments, one or more of the layers of the MEA include pores that allow gas and liquid transport. These pores are distinct from ion-conduction channels that allow ion conduction. In many polymer electrolytes (e.g. PFSA), ion conduction occurs through pores lined with stationary charges. The mobile cations hop between the oppositely charged stationary groups that line the ion conduction channel. Such channels may have variable width; for PFSA materials, the ion conduction channel diameter ranges from narrow areas of approximately 10 Å diameter to wider areas of approximately 40 Å diameter. In anion conducting polymer materials, the channel diameters may be larger, up to about a minimum width of 60 Å in the narrow areas of the channel.

For efficient ion conduction, the polymer-electrolyte is hydrated, so the ion conduction channels also contain water. It is common for some water molecules to move along with the mobile ions in a process termed electro-osmotic drag; typically 1-5 water molecules per mobile ion are moved via electro-osmotic drag. The ion-conducting channel structure and degree of electro-osmotic drag can vary with different polymer-electrolytes or ion-conducting materials. While these ion conducting channels allow ions to move along with some water molecules, they do not allow uncharged molecules to move through them efficiently. Nor do they allow bulk water that is not associated with ions to move through them. A solid (i.e., non-porous) membrane of a polymer electrolyte blocks the bulk of CO₂ and products of CO₂ electrolysis from passing through it. The typical permeability of CO₂, water, and H₂ through a wet Nafion 117 PFSA membrane at 30° C. are approximately 8.70×10⁶ mol cm cm−2 s−1·Pa−1, 4.2 (mol/cm-s-bar)×109, and 3.6 (mol/cm-s-bar)×1011. Permeability depends on temperature, hydration, and nature of the polymer-electrolyte material. In ion conduction channels that have variable diameters, uncharged molecules and bulk movement of liquid/gas may be blocked at least at the narrow parts of the channel.

Pores of larger diameter that the ion conduction channels described above allow the passage of bulk liquid and gas, not just ions. The polymer electrolyte membrane layer of the MEA typically does not contain this type of pore because the membrane needs to separate reactants and products at the cathode from reactants and products at the anode. However, other layers of the MEA may have this type of pore, for example, the cathode catalyst layer may be porous to allow for reactant COₓ to reach the catalyst and for products of COₓ reduction to move out of the catalyst layer, through the gas distribution layer, and out the flow field of the electrolyzer. As used herein, the term pore refers to pores other than the ion conduction channels in an ionomer. In some embodiments, the pores of anion conducting polymer layer in an MEA have a minimum cross-sectional dimension of at least 60 Å. In some embodiments, the pores of cation conducting polymer layer in an MEA have a minimum cross-sectional dimension of at least 20 Å. This is to distinguish pores that allow gas/liquid transport from the ion conduction channels described above.

It can be useful if some or all of the following layers are porous: the cathode 420, the cathode buffer layer 425, the anode 440 and the anode buffer layer 445. In some arrangements, porosity is achieved by combining inert filler particles with the polymers in these layers. Materials that are suitable as inert filler particles include, but are not limited to, TiO₂, silica, PTFE, zirconia, and alumina. In various arrangements, the size of the inert filler particles is between 5 nm and 500 microns, between 10 nm and 100 microns, or any suitable size range. In other arrangements, porosity is achieved by using particular processing methods when the layers are formed. One example of such a processing method is laser ablation, where nano to micro-sized channels are formed in the layers. Laser ablation can additionally or alternatively achieve porosity in a layer by subsurface ablation. Subsurface ablation can form voids within a layer, upon focusing the beam at a point within the layer, and thereby vaporizing the layer material in the vicinity of the point. This process can be repeated to form voids throughout the layer, and thereby achieving porosity in the layer. Sublayer by sublayer methods of forming an MEA layer such as ultrasonic spray deposition may be used to form an MEA layer having a controlled porosity. A dry deposit can lead to faster drying of layers and a more porous final deposit. One or more of high substrate temperature, slow deposition rate, high elevation of nozzle from the substrate, and high volatility of deposition ink can be used to make the layer more porous. A wet deposit can lead to slower drying of layers, densification and compaction of several layers for the final deposit. One or more of low substrate temperature, fast deposition rate, low elevation of spray nozzle from the substrate, and low volatility of the deposition ink can be used to make the layer less porous. For example, a room temperature ultrasonic spray deposition may result in a relatively dense layer and a 50° C. ultrasonic spray deposition may result in a relatively porous layer.

In some embodiments, the following conditions may be used to form layers having porosities of at least 1%, e.g., 1-90%, 1-50%, or 1-30% porosity: substrate temperature of at least 40° C.; deposition rate of no more than 0.8 mL/min, e.g., 0.2-0.8 mL/min; elevation of nozzle of at least 50 mm, e.g., 50-75 mm; and solvent volatility of at least 90-100% (e.g., ethanol).

In some embodiments, the following conditions may be used to form layers having non-porous layers or layers having porosities of less than 1%: substrate temperature of less than 40° C.; deposition rate of more than 0.8 mL/min and up to 10 mL/min; elevation of nozzle of less than 50 mm; and lower solvent volatility of at least 90-100% (e.g., 50-90% volatile solvent content such as ethanol or 50-100% intermediate volatility of solvent such as glycol ethers).

The volume of a void may be determined by the laser power (e.g., higher laser power corresponds to a greater void volume) but can additionally or alternatively be determined by the focal size of the beam, or any other suitable laser parameter. Another example is mechanically puncturing a layer to form channels through the layer. The porosity can have any suitable distribution in the layer (e.g., uniform, an increasing porosity gradient through the layer, a random porosity gradient, a decreasing porosity gradient through the layer, a periodic porosity, etc.).

The porosities (e.g., of the cathode buffer layer, of the anode buffer layer, of the membrane layer, of the cathode layer, of the anode layer, of other suitable layers, etc.) of the examples described above and other examples and variations preferably have a uniform distribution, but can additionally or alternatively have any suitable distribution (e.g., a randomized distribution, an increasing gradient of pore size through or across the layer, a decreasing gradient of pore size through or across the layer, etc.). The porosity can be formed by any suitable mechanism, such as inert filler particles (e.g., diamond particles, boron-doped diamond particles, polyvinylidene difluoride/PVDF particles, polytetrafluoroethylene/PTFE particles, etc.) and any other suitable mechanism for forming substantially non-reactive regions within a polymer layer. The inert filler particles can have any suitable size, such as a minimum of about 10 nanometers and a maximum of about 200 nanometers, and/or any other suitable dimension or distribution of dimensions.

As discussed above, the cathode buffer layer preferably has a porosity between about 1 and 90 percent by volume but can additionally or alternatively have any suitable porosity (including, e.g., no porosity). However, in other arrangements and examples, the cathode buffer layer can have any suitable porosity (e.g., between 0.01-95%, 0.1-95%, 0.01-75%, 1-95%, 1-90%, etc.). in some embodiments, the porosity is 20% or below, e.g. 0.1-20%, 1-10%, or 5-10%.

In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

Porosity of the cathode buffer layer or any layer in the MEA may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation. Porosity can be determined using the known density of the material, the actual weight of the layer per given area, and the estimated volume of the layer based on the area and thickness. The equation is as follows:

$$Porosity = 10 \; 0 \% - \frac{\frac{layer loading ( \frac{mg}{{cm}^{2}} )}{density of material ( \frac{mg}{{cm}^{3}} )}}{layer thickness ( cm )} \times 100 \%$$

As indicated above, the density of the material is known, and the layer loading and thickness are measured. For example, in a polymer electrolyte layer with a measured loading of 1.69 mg/cm² made of 42 wt % anion-exchange polymer electrolyte with a density of 1196 mg/cm³ and 58 wt % PTFE with a density of 2200 mg/cm³ and a total layer thickness of 11.44 microns, the porosity is:

$$Porosity = 100 \% - \frac{\frac{1.69 ( \frac{mg}{{cm}^{2}} ) \times 0.42}{11 \; 96 ( \frac{mg}{{cm}^{3}} )} + \frac{1.69 ( \frac{mg}{{cm}^{2}} ) \times 0.58}{2200 ( \frac{mg}{{cm}^{3}} )}}{0.001144 ( cm )} \times 100 \% = 9.1 \%$$

As indicated above, the polymer electrolyte layers may have ion conduction channels that do not easily permit the gas/liquid transport. In the calculation above, these ion conduction channels are considered non-porous; that is, the density of the non-porous material above (42 wt % anion-exchange polymer electrolyte) includes the ion conduction channels and is defined by the calculation to be non-porous.

In another example, an ion conductive layer without filler is porous. Porosity may be introduced by appropriate deposition conditions, for example. The measured loading of the porous polymer electrolyte layer is 2.1 g/cm² and the thickness is 19 micrometers. The known density of the polymer electrolyte with ion-conducting channels but without pores is 1196 g/cm³. The porosity is then calculated as:

$$Porosity = 100 \% - \frac{\frac{2.1 ( \frac{mg}{{cm}^{2}} )}{1196 ( \frac{mg}{{cm}^{3}} )}}{0.00 \; 19 ( cm )} \times 100 \% = 3.2 \%$$

### Carbon Oxide Reduction Reactor System

FIG. 6 depicts an example system for a carbon oxide (e.g., carbon dioxide, carbon monoxide) reduction reactor 603 (often referred to as an electrolyzer herein) that may include a cell comprising an MEA. The reactor may contain multiple cells or MEAs arranged in a stack. For example, in some embodiments, the reactor comprises a stack of at least about 20 cells, at least about 50 cells, at least about 80 cells, at least about 100 cells, or at least about 200 cells. In some embodiments, the reactor comprises a stack of about 10 to about 300 cells, about 20 to about 250 cells, about 50 to about 220 cells, or about 80 to about 120 cells. System 601 includes an anode subsystem that interfaces with an anode of reduction reactor 603 and a cathode subsystem that interfaces with a cathode of reduction reactor 603. System 601 is an example of a system that may be used with or to implement any of the methods or operating conditions described herein for COₓ (e.g., carbon dioxide) electrolysis, such as described with respect to FIGS. 1-5C.

As depicted, the cathode subsystem includes a carbon oxide (e.g., carbon dioxide) source 609 configured to provide a feed stream of carbon oxide (e.g., carbon dioxide) to the cathode of reduction reactor 603, which, during operation, may generate an output stream that includes product(s) of a reduction reaction at the cathode. For the systems described herein, the product is or includes one or more carbon-containing reduction product (e.g., carbon monoxide) as described above. The product stream may also include unreacted carbon dioxide, proton, water, and/or hydrogen. See 608.

The carbon oxide (e.g., carbon dioxide) source 609 is coupled to a carbon oxide flow controller 613 configured to control the volumetric or mass flow rate of carbon oxide (e.g., carbon dioxide) to reduction reactor 603. One or more other components may be disposed on a flow path from flow carbon oxide source 609 to the cathode of reduction reactor 603. For example, an optional humidifier or dehumidifier 604 may be provided on the path and configured to humidify (or dehumidify) the carbon oxide (e.g., carbon dioxide) feed stream.

In some embodiments, humidified carbon oxide (e.g., carbon dioxide) may moisten one or more polymer layers of an MEA and thereby avoid drying such layers. Another component that may be disposed on the flow path is a purge gas inlet coupled to a purge gas source 617. In certain embodiments, purge gas source 617 is configured to provide purge gas during periods when current is paused to the cell(s) of reduction reactor 603. In some implementations, flowing a purge gas over an MEA cathode facilitates recovery of catalyst activity and/or selectivity. Examples of purge gases may include carbon oxides (e.g., carbon dioxide, carbon monoxide, etc.), hydrogen, nitrogen, argon, helium, oxygen, and mixtures of any two or more of these.

In various embodiments, a COₓ (e.g., CO₂) purifier (not shown in FIG. 6) is provided upstream of source 609. Such COₓ purifier may be considered to be part of the cathode subsystem.

During operation, the output stream from the cathode flows via a conduit 607 that connects to a backpressure controller 615 configured to maintain pressure at the cathode side of the cell within a defined range (e.g., about 50 to 800 psig, depending on the system configuration). The output stream may provide the reaction products 608 to one or more components (not shown) for separation and/or concentration.

In certain embodiments, the cathode subsystem is configured to controllably recycle unreacted carbon oxide (e.g., carbon dioxide) from the outlet stream back to the cathode of reduction reactor 603. In some implementations, the output stream is processed to remove reduction product(s) and/or hydrogen before recycling the carbon oxide. As described elsewhere herein, depending upon the MEA configuration and operating parameters, the reduction product(s) may be carbon monoxide, hydrogen, hydrocarbon(s) such as methane and/or ethylene, oxygen-containing organic compounds such as formic acid, acetic acid, or water, and any combinations thereof. In certain embodiments, one or more components, not shown, for removing water (when present) from the product stream are disposed downstream from the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon dioxide from source 609 upstream of the cathode. Not shown in FIG. 6 are one or more optional separation components that may be provided on the path of the cathode outlet stream and configured to concentrate, separate, and/or store the reduction product from the reduction product stream. For example, the cathode output stream may comprise unreacted COₓ, a carbon-containing product (e.g., CO), and one or more byproducts (e.g., water). In some embodiments, a gas-liquid separator (e.g., a water knockout system) may be positioned downstream the cathode outlet of the reduction reactor 603 to remove liquid (e.g., water) from the gaseous species present in the cathode output stream. Alternatively or additionally, in some embodiments, a gas separation or purification unit may be present downstream the cathode outlet of the reduction reactor and/or the water separation unit to separate COₓ from the carbon-containing product (e.g., CO) in the cathode output stream. The separated COₓ may be recycled back to the cathode of the reduction reaction 603, along with the COₓ the feed from the COₓ source 609.

As depicted in FIG. 6, an anode subsystem is configured to provide an anode feed stream to an anode side of the carbon oxide reduction reactor 603. In certain embodiments, the anode subsystem includes an anode reactant source, not shown, configured to provide fresh anode reactant to a recirculation loop that includes an anode reactant reservoir 619 and an anode reactant flow controller 611. In some embodiments, anode reactant may include water. In various embodiments, anode reactant may include gaseous hydrogen. The anode reactant flow controller 611 is configured to control the flow rate of anode reactant to or from the anode of reduction reactor 603. In the depicted embodiment, the anode reactant recirculation loop is coupled to components for adjusting the composition of the anode reactant. These may include a reactant reservoir 621. Reactant reservoir 621 is configured to supply reactant having a composition that is different from that in anode reactant reservoir 619 (and circulating in the anode reactant recirculation loop).

During operation, the anode subsystem may provide water or other reactant (e.g., hydrogen gas) to the anode of reactor 603, where it at least partially reacts to produce an oxidation product such as oxygen or proton. The product along with unreacted anode feed material is provided in a reduction reactor outlet stream. Not shown in FIG. 6 are one or more optional separation components that may be provided on the path of the anode outlet stream and configured to concentrate, separate, and/or store the oxidation product from the anode product stream. For example, in one set of embodiments, an anode feed comprising hydrogen gas may be introduced to the anode to undergo oxidation reaction to produce oxidation products (e.g., protons), wherein at least a portion (or all) of the oxidation products may migrate towards the cathode and react with a cathode feed (e.g., a carbon oxide such as carbon dioxide) to form a carbon-containing reduction product, as described elsewhere herein. In some such embodiments, unreacted anode feed and/or oxidation product (when present) may flow out in the anode outlet stream and may be further concentrated, separated, and/or stored. For example, the anode feed comprising hydrogen gas may be separated from other components in the anode outlet stream for recycling into the anode.

Other control features may be included in system 601. For example, a temperature controller may be configured to heat and/or cool the carbon oxide reduction reactor 603 at appropriate points during its operation. In the depicted embodiment, a temperature controller 605 is configured to heat and/or cool anode reactant provided to the anode reactant recirculation loop. For example, the temperature controller 605 may include or be coupled to a heater and/or cooler that may heat or cool reactant in anode reactant reservoir 619 and/or reactant in reservoir 621. In some embodiments, system 601 includes a temperature controller configured to directly heat and/or cool a component other than an anode reactant component. Examples of such other components in the cell or stack and the carbon oxide flowing to the cathode.

In certain embodiments, system 601 is configured to adjust the flow rate of carbon oxide (e.g., carbon dioxide) to the cathode and/or the flow rate of anode feed material to the anode of reactor 603. Components that may be controlled for this purpose may include carbon oxide flow controller 613 and anode reactant flow controller 611.

Certain components of system 601 may operate to control the composition of the carbon oxide feed stream (e.g., carbon dioxide) and/or the anode feed stream.

In some embodiments, a temperature controller such controller 605 is configured to adjust the temperature of one or more components of system 601 based on a phase of operation. For example, the temperature of cell 603 may be increased or decreased during break-in, a current pause in normal operation, and/or storage.

In some embodiments, a carbon oxide (e.g., carbon dioxide) electrolytic reduction system is configured to facilitate removal of a reduction cell from other system components. This may be useful with the cell needs to be removed for storage, maintenance, refurbishment, etc. In the depicted embodiments, isolation valves 625a and 625b are configured to block fluidic communication of cell 603 to a source of carbon oxide to the cathode and backpressure controller 615, respectively. Additionally, isolation valves 625c and 625d are configured to block fluidic communication of the cell to anode inlet and outlet, respectively.

The carbon oxide (e.g., carbon dioxide) reduction reactor 603 may also operate under the control of one or more electrical power sources and associated controllers. See, block 633. Electrical power source and controller 633 may be programmed or otherwise configured to control current supplied to and/or to control voltage applied to the electrodes in reduction reactor 603. Any of the current profiles described herein may be programmed into power source and controller 633.

In certain embodiments, electric power source and controller 633 performs some but not all the operations necessary to implement control profiles of the carbon oxide reduction reactor 603. A system operator or other responsible individual may act in conjunction with electrical power source and controller 633 to fully define the schedules and/or profiles of current applied to reduction reactor 603.

In certain embodiments, electric power source and controller 633 controls operation of all or certain components of an upstream or downstream system. In certain embodiments, the electrical power source and controller acts in concert with one or more other controllers or control mechanisms associated with other components of system 601. For example, electrical power source and controller 633 may act in concert with controllers for controlling the purification of carbon oxide, the delivery of carbon oxide to the cathode, the delivery of anode feed (e.g., water, hydrogen gas, etc.) to the anode, the addition of additional anode feed (e.g., pure water or hydrogen gas) or additives to the anode feed, delivery of a carbon-containing reduction product (e.g., carbon monoxide) to a downstream system, and any combination of these features. In some implementations, one or more controllers are configured to control or operate in concert to control any combination of the following functions: applying current and/or voltage to reduction reactor 603, controlling backpressure (e.g., via backpressure controller 615), supplying purge gas (e.g., using purge gas component 617), delivering carbon oxide such as carbon dioxide (e.g., via carbon oxide flow controller 613), humidifying or dehumidifying carbon oxide (e.g., carbon dioxide) in a cathode feed stream (e.g., via humidifier 604), flow of anode reactant to and/or from the anode (e.g., via anode reactant flow controller 611), and anode reactant composition (e.g., via anode reactant source 619 (e.g., anode water or hydrogen gas source), additional anode reactant reservoir 621 (e.g., pure water or hydrogen gas reservoir), and/or anode additives component (not shown).

In the depicted embodiment, a voltage monitoring system 634 is employed to determine the voltage across an anode and cathode of an MEA cell or across any two electrodes of a cell stack, e.g., determining the voltage across all cells in a multi-cell stack. In certain embodiments, voltage monitoring system 634 is configured to work in concert with power supply 633 to cause reduction reactor 603 to remain within a specified voltage range. If, for example the cell's voltage deviates from a defined range (as determined by voltage monitoring system 634), power supply may be configured to apply current or voltage to the electrodes to maintain the cell voltage within the specified range.

An electrolytic carbon dioxide reduction system such as that depicted in FIG. 6 may employ a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode reactant, pure reactant, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide (e.g., carbon dioxide) to the cathode inlet, humidifying carbon dioxide in a cathode feed stream, flowing anode reactant (e.g., anode water or hydrogen gas) to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

A controller may include any number of processors and/or memory devices. The controller may contain control logic such software or firmware and/or may execute instructions provided from another source. In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g., a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware—for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### Upstream and Downstream Integrations

In various embodiments, the carbon oxide electrolyzer (e.g., CO₂ electrolyzer) may be connected to a downstream system. For example, a downstream process may include one or more of: bioreactor system; a liquid hydrocarbon system (e.g., a Fischer-Tropsch system); an anerobic fermentation system; an aerobic fermentation system; a syngas fermentation system; a ketone and/or polyketone production system; a formate production system; a formate ester production system; a formamide production system; a hydroformylation system; a methanol synthesis system; an ethylene polymerization system; a phosgene production system, an isocyanate production system, a polymer (e.g., a polycarbonate, polyethylene terephthalate, or polyurethane) production system, a monoethylene glycol production system, a polyethylene glycol production system, acetic acid production system, and oxalic acid production system, and/or any other system capable of transforming chemical outputs from a carbon oxide reduction reactor. A carbon oxide (e.g., carbon dioxide) reactor output of the disclosure may be directly connected (e.g., via the cathode flow field and/or gas diffusion layer) to a downstream system, and/or the carbon oxide reactor output may be connected to a purification system; a gas compression system; or both a purification system and a gas compression system, in either order; which then optionally connect to an input of a downstream system. Multiple purification systems and/or gas compression systems may be employed. In some cases, the carbon oxide electrolyzer (e.g., CO₂ electrolyzer) may be connected to any various upstream system(s), such as a carbon oxide (e.g., carbon dioxide) capture unit (e.g., a direct air capture unit for capturing CO₂ from air).

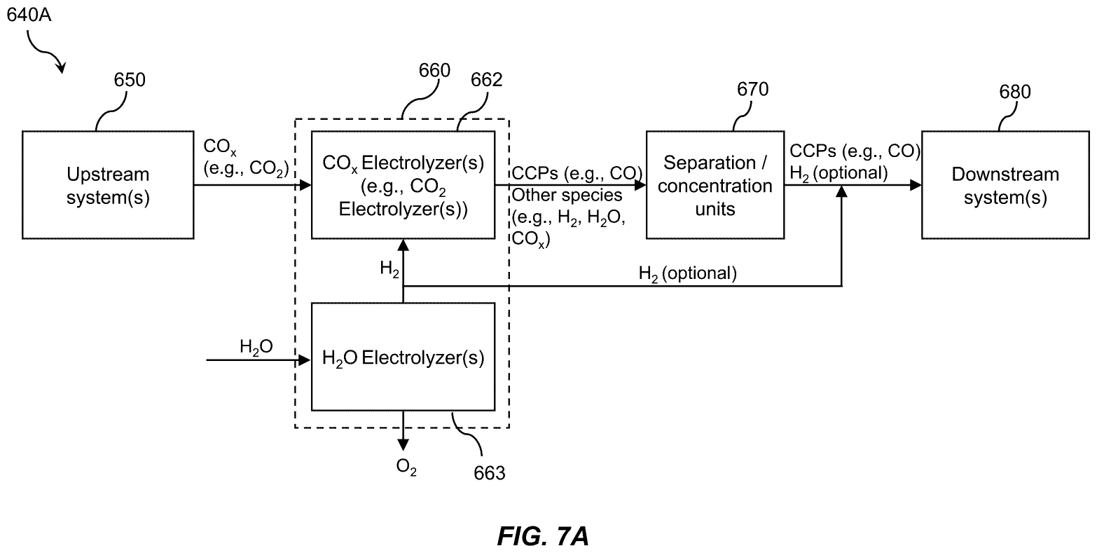

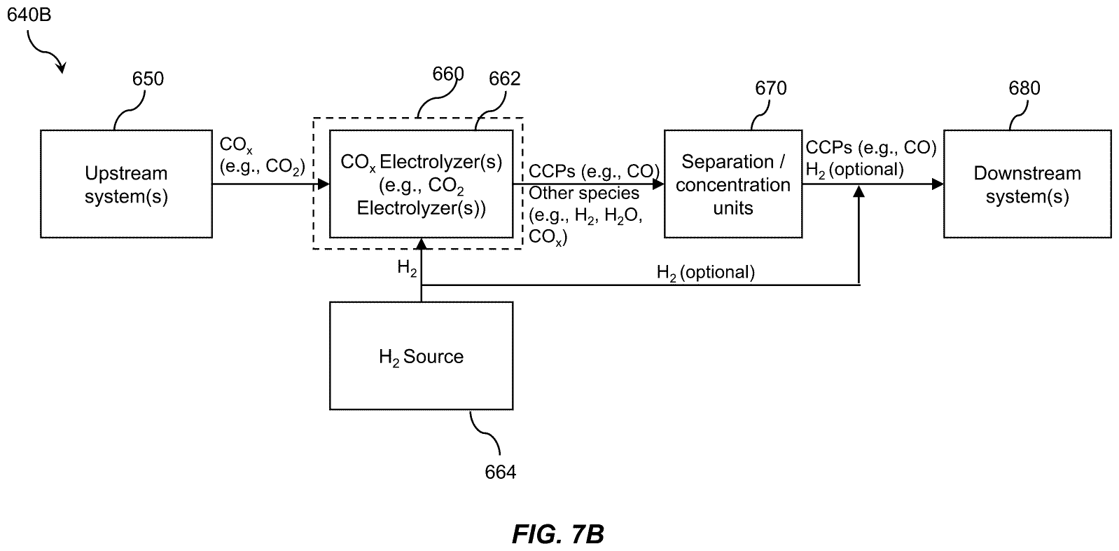

FIGS. 7A-7B can be used to illustrate one embodiment of an integrated system comprising a carbon oxide reduction electrolyzer fluidically connected to one or more downstream system(s) and/or upstream system(s). FIG. 7A illustrates system 640A comprising electrolysis system 660 fluidically connected to optional upstream system(s) 650 and downstream system(s) 680, as well one or more optional separation and/or concentration systems 670 disposed between electrolysis system 660 and downstream system 680. Electrolysis system 660 may comprise carbon oxide electrolyzer 662 coupled to water electrolyzer 663, where carbon oxide electrolyzer 662 is configured to receive hydrogen gas produced by water electrolyzer 663 at the anode and a carbon oxide feed at the cathode, in some embodiments. As shown in FIG. 7A, the output of carbon oxide electrolyzer 662 may include carbon-containing product(s) (CCPs), unreacted species (e.g., COₓ), as well as byproducts and/or electrolytes (e.g., H₂O, H₂), depending on the electrolyzer configuration. The output from electrolyzer 662 may be sent to separation/concentration units such that the carbon-containing products (CCPs) are separated from other species and sent to downstream system(s) 680 for further processing, such as being converted into additional chemical products, according to some embodiments. In embodiments in which H₂ is needed as an input for the downstream systems 680, the separated stream containing the carbon-containing products may be combined with at least a portion of the H₂ produced by water electrolyzer 663 prior to being sent to downstream system(s) 680. Downstream system(s) 680 and upstream system(s) 650 may include any of a variety of systems described elsewhere herein.

Referring again to FIG. 7A, the electrochemical reactions carried out within electrolyzers 662 and 663 may be similar (or identical) to the those described elsewhere herein, such as with respect to FIGS. 1A-1B. For example, as shown in FIG. 7A, within water electrolyzer 663, aqueous feed (e.g., H₂O) may undergo electrochemical reaction to produce hydrogen gas and oxygen gas. In some cases, at least a portion of the hydrogen gas produced by the water electrolyzer may be sent to the carbon oxide electrolyzer to undergo hydrogen oxidation reaction (HOR) at the anode of the carbon oxide electrolyzer to produce hydrogen ions. The protons may migrate across the membrane of the carbon oxide electrolyzer from the anode to the cathode to react with a cathode carbon oxide feed (e.g., CO₂), such that the carbon oxide (e.g., CO₂) undergoes an electrochemical reduction producing one or more carbon-containing reduction product(s) (CCPs) at the cathode, as described elsewhere herein. In one set of embodiments, the carbon oxide electrolyzer is a carbon dioxide electrolyzer configured to receive carbon dioxide at the cathode and output carbon monoxide as the carbon-containing reduction product (CCP), as illustrated in FIG. 1A. In some embodiments, water is produced as a byproduct at the cathode of the carbon oxide electrolyzer. In some cases, at least a portion of the water produced at the cathode of the carbon oxide electrolyzer may be recycled to the water electrolyzer as part of the feed.

While FIG. 7A illustrates an embodiment in which electrolysis system 660A comprises both a water electrolyzer and a COₓ electrolyzer, it should be understood that the disclosure is not limited and that in certain embodiments, electrolysis system 660A may comprise a COₓ electrolyzer but lack a water electrolyzer, as shown in FIG. 7B. As shown in electrolysis system 660B in FIG. 7B, COₓ electrolyzer 662 may be configured to receive H₂ from a hydrogen source described elsewhere herein instead of a water electrolyzer.

In various embodiments, CO produced in a carbon oxide electrolyzer (e.g., CO₂ electrolyzer) is used in an integrated process. In one example of an integration scheme, a system having a Fischer-Tropsch reactor may employ a carbon oxide electrolyzer (e.g., a carbon dioxide electrolyzer) configured to produce CO and/or syngas as an input to the Fischer-Tropsch reactor. Alternatively or additionally, the carbon oxide electrolyzer may be configured to produce oxygen as an input to reactor for gasification of biomass, which also produces syngas for input to the Fischer-Tropsch reactors.

### Naphthas and Fuels

In a Fischer-Tropsch (F-T) reaction, which may correspond with other embodiments, described herein, carbon monoxide and hydrogen from a carbon oxide electrolyzer (e.g., CO₂ electrolyzer) are reacted to form naphtha or other light hydrocarbon product.

Fischer-Tropsch reactions may be characterized by the following general expression:

(2n+1)H₂+nCO→CnH₂n+nH₂O

While the following discussion focuses on Fischer-Tropsch reactions, those of skill in the art appreciate that a class of related reactions may be employed to produce liquid hydrocarbons and mixtures thereof (often generally referred to as naphthas) from input streams that include hydrogen and carbon monoxide. The class of reactions produce various compositions of liquid hydrocarbon mixtures dependent on the composition of the input stream and the reaction conditions. While the term Fischer-Tropsch is used herein, it should be understood to cover any of a class of reactions that produce naphtha from a mixture including carbon monoxide and hydrogen. Generally, such reactions or exothermic.

In various embodiments, the input stream to a Fischer-Tropsch reactor is about 1:2 molar ratio of CO:H₂. To use CO₂ as starting point for producing CO/H₂ mixture (or other Fischer-Tropsch input), some conventional, non-electrolytic processes require two steps. For example, a conventional process employs a first process to produce CO₂+H₂ (step 1) and then a reverse water gas shift (RWSG) reaction (step 2) to react CO₂+H₂ and produce CO and water to result in a gas having a ratio close to the required 2:1 CO:H₂. Thus, in a conventional process, only after obtaining the CO and hydrogen in the correct ratio can a Fischer-Tropsch reaction be employed to produce liquid hydrocarbons. Water shift (WSG) reaction and reverse water shift reaction catalysts can produce metal dust that is detrimental to downstream processes. Further, the water shift reactions require a feed of carbon monoxide and/or hydrogen.

Note that a conventional syngas process is sometimes used to directly produce CO+H₂ mixture (rather than using a WSG and/or RWSG reaction or a carbon dioxide electrolyzer which my emphasize production of CO). However, syngas production often uses coal.

A Fischer-Tropsch system that employs a carbon dioxide electrolyzer as a source of carbon monoxide has various advantages over the WSG or syngas routes. For example, unlike a RWSG reaction, a carbon dioxide electrolyzer does not produce metal dust. Additionally, in comparison to the RWGS reaction, a carbon dioxide electrolyzer provides a higher conversion of CO₂ to CO.

However, a carbon dioxide electrolyzer may not produce gas having the required approximately 1:2 molar ratio of CO:H₂ for a Fischer-Tropsch feed. In some cases, a carbon dioxide electrolyzer produces a CO-rich stream. Therefore, in some embodiments, a Fischer-Tropsch system, or any other system that requires a carbon monoxide and hydrogen mixture, may employ a water electrolyzer or other source of hydrogen that optionally works in conjunction with carbon dioxide electrolyzer. The water electrolyzer is configured to make gaseous hydrogen to supplement the CO-rich output of the carbon dioxide electrolyzer. In some embodiments, syngas that is relatively rich in hydrogen can be produced as part of co-electrolysis of carbon dioxide and water. To achieve an approximately 1:2 CO:H₂ feed concentration for a F-T reaction, the system may include sensors configured to determine the concentration of CO and H₂ coming through the gas separation unit from the CO₂ electrolyzer. Using the sensed information as feedback, the operating conditions of a water electrolyzer may be adjusted to deliver a hydrogen stream with the quantity of H₂ needed to bring the total stream to approximately 1:2 CO:H₂ concentration.

Alternatively, a single CO₂ electrolyzer can be used to produce a suitable Fischer-Tropsch CO and H₂ feed blend. This can be accomplished by operating the electrolyzer in a way that biases the output toward hydrogen production and/or by processing the electrolyzer output to adjust its composition prior to delivery to the Fischer-Tropsch reactor. In certain embodiments, a carbon dioxide electrolyzer includes an MEA that allows a relatively high proportion of H+ to reach the cathode. One way to promote a relatively high flux of H+ at the cathode is for a bipolar MEA to employ a relatively thin cathode buffer layer and/or to employ cathode and cathode buffer layers having polymers with a relatively high H+ transference number. In another approach, the carbon dioxide electrolyzer is constructed or operated in a way that starves it of carbon dioxide. In certain embodiments, the electrolyzer is operated at a relatively high current density, which tends to produce a higher ratio of hydrogen to carbon monoxide ratio. In some implementations, the electrolyzer employs both a relatively high current density and relatively low carbon dioxide feed to the electrolyzer. Operating at a relatively high current density has the advantage of producing a suitable CO and H₂ feed blend while employing a relatively inexpensive electrolyzer.

The output of a CO₂ electrolyzer contains product CO, byproduct H₂, unreacted CO₂, and water vapor, in some embodiments. The system may be configured to remove the water vapor and separate the unreacted carbon dioxide. A gas separation unit may be used to separate the CO₂ from the CO and H₂ and/or otherwise concentrate the CO and H₂. The system may include a recycle loop to recycle water to a water inlet of a CO₂ or water electrolyzer. The unreacted and separated CO₂ is then compressed and returned to the inlet of the CO₂ electrolyzer via a CO₂ recycle loop.

A F-T reactor may operate above about 300 psi and between about 150-300° C. If the output of a carbon dioxide electrolyzer and optional water electrolyzer is not at the required pressure, the system may employ a compressor to bring up the feed gas pressure before entering the F-T reactor. In the F-T reactor, the CO—H₂ mixture is converted into raw F-T liquid and waxes. A system may include a separator following the F-T reactor to separate water, high melting point F-T liquid, medium melting point F-T liquid, and tail gas, a mixture of volatile hydrocarbons, CO₂, CO, and H₂. The F-T liquid may be further upgraded via hydrocracking. Distillation and separation of different fractions of the F-T liquid may result in jet fuel, diesel, and gasoline. Water from the F-T reactor can be filtered to remove impurities and fed to a water input of the CO₂ and/or optional water electrolyzers.

A F-T system may be designed so that tail gas and/or volatile hydrocarbons (e.g. including methane) are recycled back to the CO₂ electrolyzer. The system may be configured to separate the tail gas into CO₂, which may be compressed and fed directly to the electrolyzer inlet and volatile hydrocarbons and unreacted CO and H₂. The system may be designed or configured such that these products are fed to a combustion reactor to generate heat, energy, and CO₂. The CO₂ is then fed to the CO₂ electrolyzer inlet. The O₂ from the electrolyzer may be used as the oxygen source for combustion, resulting in a pure CO₂ output stream. The combustion reactor may be run in “rich burn” mode utilizing an excess of fuel to oxygen to minimize the concentration of oxygen in the outlet stream. Water from the combustion reaction may be separated from the gas output and can be fed to the water input of the CO₂ electrolyzer or water electrolyzer.

Because a Fischer-Tropsch reaction is exothermic, it produces heat that may be used for other purposes in a system. Examples of such other uses include separations (e.g., distillation of light hydrocarbons) and reactions. In conventional systems, such reactions are endothermic reactions for production of syngas such as reforming of fossil fuels, gasification of biomass, or production from carbon dioxide and hydrogen via reverse water gas shift. Hence, in conventional processing, all or a significant portion of the excess heat from a Fischer-Tropsch reaction is typically directed to the syngas production. In the present case, however, which produces syngas at a low temperature (e.g. less than about 100° C.) by processes such as carbon dioxide electrolysis optionally along with low temperature water electrolysis, there is more excess heat from the Fischer-Tropsch reaction available for other processes such as carbon dioxide capture, thereby reducing the overall external heat requirement of the system and improving carbon and energy efficiency of the carbon dioxide to fuel synthesis pathway.

In some embodiments, tail gas is fed to a reformer where methane or other gaseous hydrocarbon react with water to produce a mixture of hydrogen and carbon monoxide, a form of syngas. This may increase the yield of carbon from carbon dioxide in liquid hydrocarbon product. Depending on the composition of tail gas, the ratio of hydrogen to carbon monoxide may vary. In some embodiments, some amount of carbon dioxide and/or oxygen is present in reformer. In many cases, the reforming reaction is endothermic. In some embodiments, heat to drive the endothermic reaction is provided, at least in part, from excess heat generated during the Fischer-Tropsch reaction. In some cases, some heat may be provided by combustion or direct electrical heat. For combustion-derived heat, oxygen (optionally from an electrolyzer) may be fed to the furnace to improve efficiency, and carbon dioxide emissions could be captured and fed to the electrolyzer.

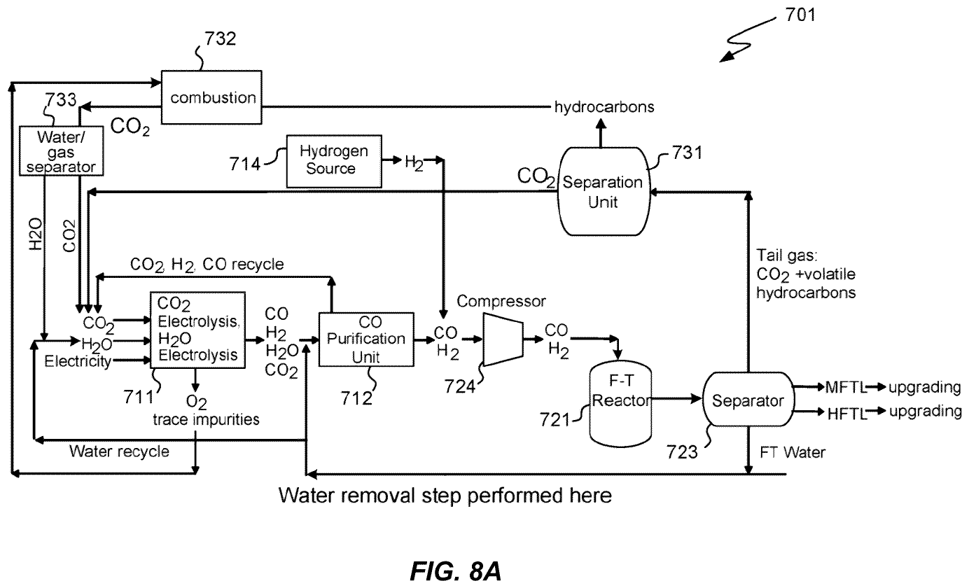

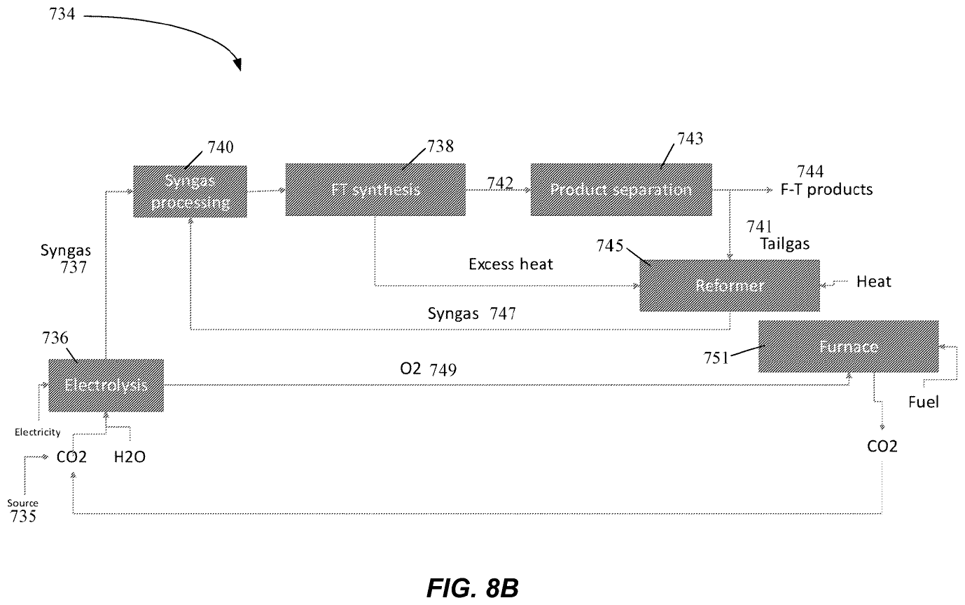

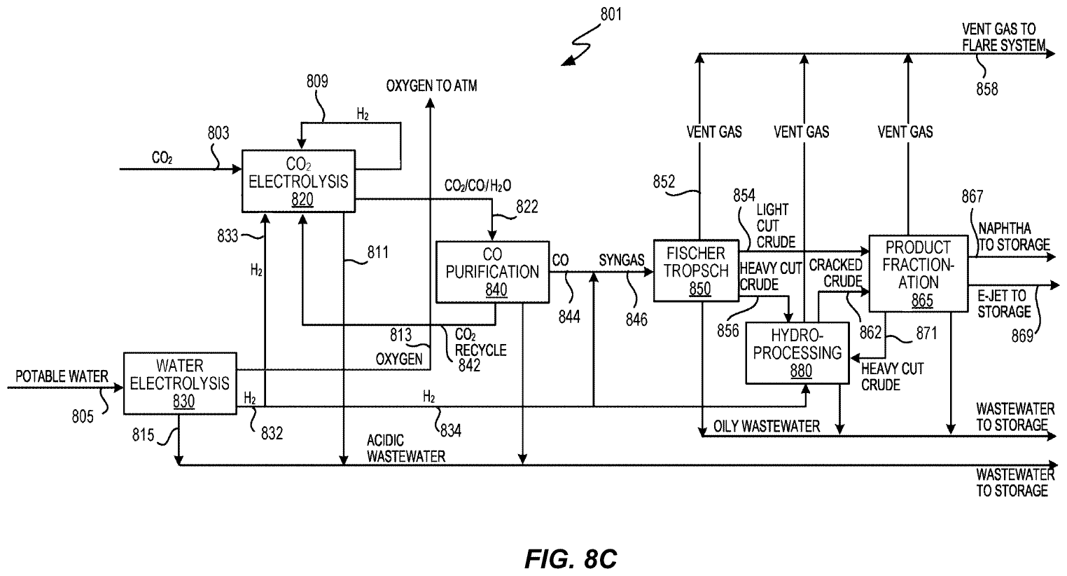

FIGS. 8A-8C can be used to illustrate a method for producing liquid hydrocarbons from carbon dioxide (CO₂) using an integrated system described herein. For example, FIG. 8A depicts a system 701 configured to produce liquid hydrocarbons in which a primary or exclusive source of carbon is a carbon oxide feedstock such as one containing carbon dioxide and/or carbon monoxide. The system includes two primary reactors/systems: an electrolysis system 711 and a Fischer-Tropsch reactor 721. Electrolysis system 711 may include a water electrolyzer coupled to a carbon dioxide electrolyzer. Examples of electrolysis 711 include electrolysis system 660 shown in FIG. 7A and the systems shown in FIGS. 1A-1B.

The electrolysis system 711 is connected to a source of electricity and has one or more inlets for receiving reactants such as carbon dioxide and water. Specifically, the water electrolyzer within electrolyzer system 711 may have an inlet for receiving water and outputs for releasing products such as H₂ (not shown) and O₂, as shown in FIG. 7A. The H₂ produced by the water electrolyzer may be passed to the anode of the carbon dioxide electrolyzer within electrolysis system 711 for HOR reaction to produce hydrogen ions, as described earlier with respect to FIG. 7A. The protons may react with the carbon dioxide fed into the cathode of the carbon dioxide electrolyzer to form carbon monoxide (CO). As shown, the electrolysis system 711 has one or more water electrolyzer outlets for removing oxygen and possibly trace impurities and one or more carbon dioxide electrolyzer outlets for removing reduction products including at least carbon monoxide. Other compounds leaving the carbon dioxide electrolyzer may include hydrogen, water, and carbon dioxide.

The cathode side outlet of carbon dioxide electrolyzer within electrolysis system 711 is connected to a purification unit such as a carbon monoxide purification unit 712 which is designed to separate or purify carbon monoxide from other components, in some embodiments. In the depicted embodiment, purification unit 712 has one outlet for providing carbon monoxide and another outlet for providing carbon dioxide, hydrogen, and possibly some carbon monoxide. In certain embodiments, the carbon monoxide purification unit 712 may be a sorbent-based unit.

In the system 701, carbon dioxide, possibly along with some hydrogen and carbon monoxide, are recycled from outlet of the CO purification unit 712 back to the inlet streams of the electrolysis system 711. For example, the recycled carbon dioxide may be sent to the cathode side of the carbon dioxide electrolyzer within electrolysis system 711, while the recycled hydrogen gas may be sent to the cathode side of the water electrolyzer within electrolysis system 711.

The Fischer-Tropsch reactor 721 is configured to receive carbon monoxide and hydrogen in a pressurized feed stream and at a specified composition. In system 701, a compressor 724 compresses the carbon monoxide from the electrolysis system 711 along with hydrogen to an appropriate pressure for the Fischer-Tropsch reaction. A Fischer-Tropsch reaction may take place at a temperature of about 150-300° C. and at a pressure of about one to several tens of atmospheres. The reaction is exothermic, so little or no heat is provided to the reactor 721.

As mentioned, the input to a Fischer-Tropsch reactor may have a CO:H ratio of about n:(2n+1), where n is the length in carbon atoms of the desired alkane product of the reaction. Thus, in various embodiments, the molar ratio of hydrogen to carbon monoxide provided to reactor 721 is about (2n+1) to n. To provide the desired inlet composition ratio of hydrogen to carbon monoxide for the Fischer-Tropsch reaction, a hydrogen source 714 may be coupled to the outlet of CO purification unit 712 or to the inlet of compressor 724. Alternatively, or in addition, the electrolysis system 711 may be designed or operated in a manner that produces a relatively high ratio of hydrogen to carbon dioxide. Reactor designs and operating conditions for accomplishing this ratio are described elsewhere herein. For example, at least a portion of the hydrogen produced by the water electrolyzer (e.g., water electrolyzer 663 as shown in FIG. 7A) within electrolysis system 714 may be employed as hydrogen source 711, according to some embodiments. In some cases, a gas having a relatively high ratio of hydrogen to carbon monoxide is produced from reforming reaction, such as reaction using FT tail gas as an input.

As depicted, system 701 is configured to provide the output of Fischer-Tropsch reactor 721 to a separator 723 configured to separate MFTL and HFTL Fischer-Tropsch liquids from water and tail gas. As depicted the Fischer-Tropsch water may be recycled back to the input of the CO purification unit 712 and/or the input of electrolysis system 711.

System 701 comprises a main recycle loop having a separation unit 731, a combustion chamber 732, and a water/gas separator 733. Separation unit 731 is configured to receive tail gas from separator 723 and remove carbon dioxide from volatile hydrocarbons. System 701 is configured to recycle carbon dioxide from unit 731 to a carbon dioxide feed stream to electrolysis system 711.

System 701 is configured to transport the volatile hydrocarbons from separation unit 731 to combustion unit 732, which is configured to burn the hydrocarbons using a source of oxygen produced from the water electrolyzer within electrolysis system 711. System 701 is configured to transport the combustion products from combustion unit 732 to gas/water separator unit 733, which is configured to separate carbon dioxide and water combustion products. System 701 is configured to transport the water to an inlet of the water electrolyzer within electrolysis system 711 and transport the carbon dioxide to a cathode inlet of the carbon dioxide electrolyzer within electrolysis system 711.

In certain embodiments, a carbon dioxide electrolyzer located upstream from a Fischer-Tropsch reactor is configured to operate in (a) a hydrogen rich product stream operating parameter regime as described herein, and/or (b) a high reduction product to CO₂ ratio operating parameter regime as described herein.

In certain embodiments, system 701 comprises one or more carbon dioxide capture units containing a sorbent for capturing carbon dioxide during a first phase and releasing carbon dioxide during a second phase. Separation unit 731 and/or gas/water separator unit 733 may be configured to include or work in conjunction with such carbon dioxide capture unit. Some principles of operation are provided in the description of direct air capture units described herein. In some embodiments, a Fischer-Tropsch system is configured to provide waste heat produced from an exothermic Fischer-Tropsch reaction to a carbon dioxide capture unit.

FIG. 8B presents an example system 734 for producing a liquid hydrocarbon mixture from a carbon dioxide input stream 735 by using (a) an electrolysis system 736 including a carbon dioxide electrolyzer coupled to a water electrolyzer, where the system is configured to produce carbon monoxide and hydrogen 737 and (b) a Fischer-Tropsch reactor 738 configured to receive carbon monoxide (e.g., carbon monoxide from the carbon dioxide electrolyzer) and hydrogen (e.g., hydrogen from the water electrolyzer) and produce liquid hydrocarbons. Electrolysis system 736 may be identical to one or more electrolysis systems described herein, such as the electrolysis system shown in FIG. 1A, electrolysis system 660 in FIG. 7A, or electrolysis system 711 in FIG. 8A. Referring back to FIG. 8B, carbon monoxide and hydrogen, at least some of which produced by electrolysis system 736, are preprocessed in syngas processing element 740 configured to purify or otherwise modify the syngas (e.g., removal of unreacted CO₂ from the electrolyzer as well as compression and/or heating or cooling of the syngas stream) prior to delivery to the Fischer-Tropsch reactor. System 734 is further configured to provide processed gas from element 740 to Fischer-Tropsch reactor 738, which can produce a mixture light hydrocarbons and other components 742, which the system makes available to a product separation subsystem 743, which may include a feature for separating tail gas 741 from one or more liquid hydrocarbon streams 744. In the depicted embodiment, system 734 includes a reformer 745 and is configured to provide tail gas 741 to the reformer. The tail gas contains methane that can react with water (optionally also included in tail gas 741) by a methane reforming reaction to produce a hydrogen-rich mixture 747 of carbon monoxide and hydrogen. System 734 is also configured to deliver mixture 747 to syngas processing element 740, which prepares the gas for introduction to the Fischer-Tropsch reactor 738. The methane reforming reaction is endothermic. In some embodiments, excess heat from the reaction in Fischer-Tropsch reactor 738 is provided reformer 745.

In the embodiment depicted in FIG. 8B, system 734 is optionally configured to provide oxygen 749 from electrolyzer 736 to a furnace 751, which is configured to burn fuel and produce additional heat for use with system 734 or elsewhere.

FIG. 8C depicts an integrated system 801 comprising, inter alia, a carbon dioxide electrolyzer unit 820, a water electrolyzer unit 830, and a Fischer-Tropsch reactor 850. The carbon dioxide electrolyzer unit may comprise one or more carbon dioxide electrolyzer cells and/or stacks and various optional components, as described in more detail below. Similarly, the water electrolyzer unit may comprise one or more water electrolyzer cells and/or stacks in addition to various optional components, in some embodiments. Carbon dioxide electrolyzer unit 820 is configured to produce carbon monoxide by electrochemically reducing carbon dioxide from a feed stream delivered via a conduit 803, while water electrolyzer unit 830 is configured to produce molecular hydrogen (H₂) by reducing water from a feed stream delivered via a conduit 805. The carbon monoxide produced by carbon dioxide electrolyzer unit 820 is provided in an output stream via a conduit 822, while the hydrogen produced by water electrolyzer unit 830 is provided in an output stream via a conduit 832. As described elsewhere herein, at least a portion of the hydrogen 832 produced by water electrolyzer unit 830 may be fed to the anode(s) of carbon dioxide electrolyzer unit 820 via conduit 833, such that the hydrogen undergoes hydrogen oxidation reaction (HOR) at the anode(s) of the electrolyzer unit 820 to produce hydrogen ions or protons (H⁺). The hydrogen ions may migrate through the membrane to the cathode(s) of the carbon dioxide electrolyzer unit 820 and react with the carbon dioxide feed at the cathode(s) such that the carbon dioxide becomes electrochemically reduced to the carbon monoxide at the cathode(s).

The carbon monoxide output stream may contain some unreacted carbon dioxide along with water. In some cases, some hydrogen (not shown) may also be present in the output stream. As depicted, integrated system 801 includes a carbon monoxide purification unit 840 configured to receive the output stream via conduit 822 and separate carbon monoxide from the other components. For example, purification unit 840 may comprise a first unit configured to separate and remove water from the carbon monoxide output stream and a second unit configured to separate carbon dioxide from carbon monoxide. After the purification, the components are separated into a first output stream 844 comprising purified carbon monoxide (and some hydrogen), a second output stream 842 comprising purified carbon dioxide, and a water stream that is removed from the system. The first unit of purification unit 840 may include a water knockout, a gas-liquid separator, etc. The second unit of carbon monoxide purification unit 840 may have any conventional or custom design. For example, such purification units may employ separation technologies based on sorbent, membranes, or cryogenics. In certain embodiments, the second unit of the carbon monoxide purification unit 840 is a sorbent-based unit of the type. In one embodiment, the second unit of carbon monoxide purification unit 840 is a sorbent-based pressure swing separator comprising a solid sorbent that (a) at high pressure, absorbs carbon dioxide from the gas stream in conduit 822 while passing carbon monoxide as the first output stream, and (b) at lower pressure, releases the purified carbon dioxide as the second output stream. In certain embodiments, the solid sorbent in the second unit of carbon monoxide purification unit 840 is a zeolite.

Integrated system 801 is configured to utilize the second output stream of purified carbon dioxide by recycling it to an input of carbon dioxide electrolyzer unit 820 via a recycle conduit 842. Integrated system 801 is further configured to transport the first output stream of purified carbon monoxide via a conduit 844. At least a portion of the hydrogen in output stream 832 from water electrolyzer unit 830 is combined with the carbon monoxide in conduit 844 (and optionally with the unreacted hydrogen output from the anode of the carbon dioxide electrolyzer unit 820) to form syngas and transport the syngas to an input of Fischer-Tropsch reactor 850 via a conduit 846. In certain embodiments, integrated system 801 is configured to feed carbon monoxide and hydrogen in a defined ratio to Fischer-Tropsch reactor 850. As examples, the hydrogen to carbon monoxide ratio may be about 1.5:1 to 2.5:1, or about 1.8:1 to 2.1:1, or about 2:1 to 2.3:1, or about 2:1 to 2.1:1, or about 2.05:1 to 2.1:1. Specifically, at least a portion of the carbon monoxide produced by the carbon dioxide electrolyzer unit may be reacted with at least a portion of the hydrogen produced by the water electrolyzer unit 830 within the Fischer-Tropsch reactor 850 to produce a liquid hydrocarbon mixture.

Fischer-Tropsch reactor 850 is configured to convert syngas provided via conduit 846 to liquid hydrocarbons and tail gas. More specifically, Fischer-Tropsch reactor 850 is configured to produce a mix of hydrocarbons, and it is outfitted with outlet lines to provide different fractions of these hydrocarbons. In the depicted embodiment, Fischer-Tropsch reactor 850 has four outlines that comprise a tail gas or “vent” gas outlet conduit 852, a light cut crude outlet conduit 854, a heavy cut crude outlet conduit 856, and oily wastewater outlet conduit.

Heavy and light cut crude fractions are understood to those of skill in the art to define physical and chemical properties such as density, boiling point, and chemical composition. The light cut crude is sometimes referred to as “light Fischer-Tropsch liquid” or LFTL. The heavy cut crude is sometimes referred to as heavy Fischer-Tropsch liquid (HFTL) or Fischer-Tropsch wax, which may comprise a saturated paraffin.

Vent gas outlet conduit 852 connects to vent gas or flare system outlet 858. A flare system may simply combust the tail gas or one or more components thereof. Optionally, as described elsewhere in this disclosure, combusted tail gas may be employed to provide carbon dioxide for recycle to a carbon dioxide electrolyzer, such as carbon dioxide electrolyzer unit 820 and/or provide heat for one or more subsystems in the integrated system 801.

In some implementations, Fischer-Tropsch reactor 850 comprises a main reactor and a cooling region. In some embodiments, the main reactor of Fischer-Tropsch reactor 850 is comprised of multiple tubes filled with catalyst inside a larger shell. The main reactor may comprise an iron-based and/or a cobalt-based metal catalyst. The exothermic Fischer-Tropsch reaction produces products substantially in the gas phase. The cooling region produces the liquid heavy cut crude and light cut crude fractions. The tail gas remains a gas phase product. In some embodiments, boiler feed water is fed to the reactor to control its temperature. In some embodiments, Fischer-Tropsch reactor 850 includes a recycle loop with a compressor.

Light cut crude outlet conduit 854 is configured to transport the light cut crude to a product fractionation unit 865. Integrated system 801 also includes a conduit 862 for delivering cracked crude (described below) to product fractionation unit 865. Product fractionation unit 865 is configured to separate input hydrocarbons into a naphtha component, which may be transported in an outlet conduit 867, a fuel component such as jet fuel, which may be transported in an outlet conduit 869, and a heavy cut crude component, which may be transported in an outlet conduit 871. In some configurations, integrated system 801 may provide storage for naphtha provided via conduit 867 and/or provide storage for fuel provided via conduit 869.

In certain embodiments, product fractionation unit 865 may be implemented as a distillation apparatus, whose temperature and/or pressure are controlled to output naphtha and jet fuel as separate streams. Regardless of how product fractionation unit 865 is implemented, it may be operated in manner that produces a fuel of appropriate physical and chemical characteristics such as carbon chain size, degree of isomerization/branching, boiling point, freezing point, viscosity, vapor pressure, or any combination thereof. In certain embodiments, the fuel output has properties falling with the ranges conventionally used for aviation turbine fuel. For example, see the standards defined by ASTM D7566 Annex 1 (2022), which is incorporated herein by reference in its entirety. In some embodiments, the hydrocarbons in the jet fuel fraction have a size of about C8 to C15 and the hydrocarbons in the naphtha fraction have a size of about C5 to C9.

As illustrated, heavy cut crude transported via conduits 856 and 871 is provided to a hydro-processing unit 880 (e.g., a hydro-cracking unit and/or hydrotreating unit) configured to chemically modify the heavy cut crude. As illustrated, some hydrogen from water electrolyzer unit 830 is provided to hydro-processing unit 880 via conduit 834. The hydrogen is fed to hydro-processing unit 880 reactor both to serve as a reactant and for temperature management as unit 880 produces exothermic reactions. In some implementations, integrated system 801 also includes a hydrogen recycle loop with a compressor.

In certain embodiments, hydro-processing unit 880 is configured to crack heavy cut crude to produce short chain hydrocarbons in the range of naphtha and jet fuel cuts. The cracking reaction may be a catalytic reaction between hydrogen and hydrocarbons of the heavy cut crude. In some implementations, hydro-processing unit 880 comprises a catalytic cracking sub-unit and an isomerization sub-unit (not shown). The isomerization sub-unit isomerizes hydrocarbons such as the short chain hydrocarbons produced by cracking. In some implementations, the isomerization sub-unit increases the branching of short chain hydrocarbons. Thus, in some embodiments, hydro-processing unit 880 contains two types of catalyst, one for cracking (breaking long chains into smaller chains) and one for isomerization. The cracked crude produced by hydro-processing unit 880 is transported via outlet conduit 862 to product fractionation unit 865.

Returning to carbon dioxide electrolyzer unit 820, it has as feedstock inlets carbon dioxide conduit 803 and a hydrogen (H₂) inlet 833, as well as an inlet for carbon dioxide recycle conduit 842, and an optional hydrogen gas recycle 809. Carbon dioxide electrolyzer unit 820 has three primary outlets, carbon monoxide outlet conduit 822, a hydrogen gas outlet, and an acidic wastewater outlet 811. In some embodiments, although not shown in FIG. 8C, the hydrogen gas outlet may be fluidically connected to an inlet of the Fischer-Tropsch reactor 850 such that at least a portion of the unreacted H₂ output from the anode of the carbon dioxide electrolyzer unit 820 may be introduced into the Fischer-Tropsch reactor 850.

Returning to water electrolyzer unit 830, as mentioned, it has water inlet conduit 805 as a source of water feedstock. Water electrolyzer unit 830 has three primary outlets, hydrogen outlet conduit 832, an oxygen outlet conduit 813, and a wastewater outlet 815. Oxygen outlet conduit 813 transport oxygen out of integrated system 801 to storage, a reactor, or, as illustrated, the atmosphere.

As illustrated, wastewater conduits 815 and 811 transport wastewater out of integrated system 801 to storage. Additionally, carbon monoxide purification unit 840 comprises an acid wastewater outlet connected to a conduit 815 configured to transport the acidic wastewater to the wastewater storage mentioned here. Still further, Fischer-Tropsch reactor 850, hydro-processing unit 880, and product fractionation unit 865 all may produce wastewater that is ultimately provided to storage outside integrated system 801.

Each of the Fischer-Tropsch reactor 850, the hydro-processing unit 880, and the product fractionation unit 865 may produce vent gas, as illustrated, and the vent gas from these different units may be combined and delivered to the vent gas flare system 858.

Various optional ancillary or support units or systems are not depicted in FIG. 8C. These may include feedstock storage such as storage of carbon dioxide and water. In certain embodiments, liquid carbon dioxide is stored as a feedstock. The liquid carbon dioxide storage is accompanied by a vaporizer to supply to the carbon dioxide as a gas to the carbon dioxide electrolyzer unit 820. Alternatively, in some embodiments, the feed carbon dioxide can be directly stored and supplied in gaseous form.

Also not shown are product storage units, such as product storage for fuel provided via conduit 869 and naphtha provided via conduit 867. Similarly, storage or disposal systems for wastewater such as oily wastewater and acidic wastewater are not shown. Also not shown in FIG. 8C are utilities such as sources of electrical power and water. Also not shown are venting and/or flaring systems. A flaring system may be used to process waste gas streams and be available to burn the gases in emergency relief scenarios to allow safe shutdown of the plant. In some embodiments, integrated system 801 employs an enclosed flare (so no open flame).

In some implementations, integrated system 801 employs compressors for providing differing pressures to the components, optionally at different times. In one example, the integrated system 801 includes a compressor to boost the carbon dioxide electrolyzer's operating pressure and improve the performance carbon monoxide purification unit 840, a compressor to boost the syngas up to pressure for the Fischer-Tropsch reactor, and a compressor to recycle carbon dioxide to the to the carbon dioxide electrolyzer.

Examples of utilities that may be available to integrated system 801 include cooling water, nitrogen, instrument air, deionized water, and electrical power.

What is claimed is:

1. A method for producing a carbon-containing product, the method comprising:
providing a carbon oxide (COₓ) electrolyzer, the COₓ electrolyzer comprising an anode, a cathode, and a membrane disposed between and conductively connecting the anode and the cathode;
feeding water to a water electrolyzer to produce hydrogen (H₂);
feeding at least a portion of the H₂ produced by the water electrolyzer to the anode of the COₓ electrolyzer to undergo hydrogen oxidation reaction at the anode;
feeding a carbon oxide to the cathode of the COₓ electrolyzer to undergo a reduction reaction, thereby producing the carbon-containing product; and
outletting the carbon-containing product from the COₓ electrolyzer.

2. The method of claim 1, wherein the hydrogen oxidation reaction produces hydrogen ions that migrate through the membrane to the cathode.

3. The method of claim 1, wherein the carbon oxide comprises CO₂ and the COₓ electrolyzer is a CO₂ electrolyzer.

4. The method of claim 1, further comprising producing water along with the carbon-containing product at the cathode of the CO₂ electrolyzer.

5. The method of claim 1, wherein the carbon-containing product comprises one or more of carbon monoxide, a hydrocarbon, an alcohol, an aldehyde, a ketone, and/or a carboxylic acid.

6. A method for producing liquid hydrocarbons from carbon dioxide (CO₂), the method comprising:
providing a CO₂ electrolyzer, the CO₂ electrolyzer comprising an anode, a cathode, and a membrane disposed between and conductively connecting the anode and the cathode;
feeding hydrogen (H₂) to the anode of the CO₂ electrolyzer to undergo hydrogen oxidation reaction at the anode;
feeding CO₂ to the cathode of the CO₂ electrolyzer to undergo a reduction reaction, thereby producing carbon monoxide (CO) at the cathode; and
reacting at least a portion of the CO produced by the CO₂ electrolyzer in one or more downstream systems to produce a chemical product.

7. The method of claim 6, wherein the reacting comprises reacting at least a portion of the CO produced by the CO₂ electrolyzer and H₂ in a liquid hydrocarbon synthesis reactor, thereby producing a liquid hydrocarbon mixture.

8. The method of claim 6, wherein at least a portion of the H₂ fed to the anode of the CO₂ electrolyzer is produced by one or more water electrolyzers.

9. The method of claim 7, wherein at least a portion of the H₂ reacted in the liquid hydrocarbon synthesis reactor is produced by one or more water electrolyzers.

10. The method of claim 7, further comprising transporting at least a portion of the liquid hydrocarbon mixture from the liquid hydrocarbon synthesis reactor to a hydrocarbon cracking reactor.

11. The method of claim 7, wherein the liquid hydrocarbon synthesis reactor is configured to perform a Fischer-Tropsch process.

12. The method of claim 6, wherein the CO₂ fed to the cathode of the CO₂ electrolyzer is gaseous CO₂.

13. The method of claim 6, wherein the CO₂ and/or the H₂ fed to the CO₂ electrolyzer is humidified CO₂ and/or humidified H₂.

14. A system for producing liquid hydrocarbons from carbon dioxide, the system comprising:
one or more carbon dioxide (CO₂) electrolyzers, at least one of the one or more CO₂ electrolyzers comprising an anode, a cathode, and a membrane disposed between and conductively connecting the anode and the cathode, the at least one of the CO₂ electrolyzers being configured to (i) feed H₂ to the anode to undergo a hydrogen oxidation reaction at the anode, and (ii) feed CO₂ to the cathode to undergo a CO₂ reduction reaction at the cathode to produce carbon monoxide (CO); and
one or more downstream systems being configured to receive at least a portion of the CO produced by the at least one of the CO₂ electrolyzers and to produce a chemical product by reacting the CO.

15. The system of claim 14, wherein the one or more downstream systems comprises a liquid hydrocarbon synthesis reactor being configured to receive H₂ and at least a portion of the CO produced by the at least one of the CO₂ electrolyzers and to produce a liquid hydrocarbon mixture.

16. The system of claim 14, further comprising one or more water electrolyzers fluidically coupled to the one or more CO₂ electrolyzers.

17. The system of claim 16, wherein the one or more CO₂ electrolyzers comprise at least one inlet for feeding at least a portion of the H₂ produced by the one or more water electrolyzers to one or more anodes of the CO₂ electrolyzers.

18. The system of claim 16, wherein the liquid hydrocarbon synthesis reactor is configured to receive at least a portion of the H₂ produced by the one or more water electrolyzers.

19. The system of claim 14, further comprising a gas separation device downstream the one or more CO₂ electrolyzers, the gas separation device configured to separate unreacted CO₂ from the CO in the cathode output stream of the CO₂ electrolyzer and to recycle at least a portion of the unreacted CO₂ to the cathode of the one or more CO₂ electrolyzer.

20. A system for producing a carbon-containing product, the system comprising:
one or more water electrolyzers configured to produce H₂ from water; and
one or more carbon oxide (COₓ) electrolyzers fluidically coupled to the one or more water electrolyzers, at least one of the one or more COₓ electrolyzers comprising an anode, a cathode, and a membrane disposed between and conductively connecting the anode and the cathode, the at least one of the one or more COₓ electrolyzers being configured to (i) feed at least a portion of the H₂ produced by the one or more water electrolyzers to the anode to undergo a hydrogen oxidation reaction at the anode, and (ii) feed a carbon oxide to the cathode to undergo a COₓ reduction reaction producing the carbon-containing product.
